(19) United States
(12) Patent Application Publication
(10) Pub. No.: US 2026/0249243 A1
(43) Pub. Date: Aug. 27, 2026

(54) METHOD FOR CAPTURING CO2 AND USE OF A METAL-BASED SURFACE FOR CAPTURING CO2

(71) Applicants: Tanay SAHU, Thornhill (CA); Paul G. O’BRIEN, Schomberg (CA); INSTITUT NATIONAL DE LA RECHERCHE SCIENTIFIQUE, Québec (CA)

(72) Inventors: Kulbir Kaur GHUMAN, Montreal (CA); Paul G. O’BRIEN, Schomberg (CA); Tanay SAHU, Thornhill (CA); Lakshmi ANIL, Quebec (CA)

(21) Appl. No.: 19/465,643

(22) Filed: Jan. 30, 2026

Related U.S. Application Data
(60) Provisional application No. 63/752,116, filed on Jan. 31, 2025.

(30) Foreign Application Priority Data
Jan. 31, 2025 (CA) 3263796

(51) Int. Cl. B01D 53/86; B01D 53/96; B01J 21/02; B01J 23/06; B01J 23/22; B01J 23/42; B01J 23/72; B01J 23/745; B01J 23/75; B01J 23/755; B01J 35/39

(52) U.S. Cl. CPC B01D 53/8671; B01D 53/96; B01J 21/02; B01J 23/06; B01J 23/22; B01J 23/42; B01J 23/72; B01J 23/745; B01J 23/75; B01J 23/755; B01J 35/39; B01D 2255/1021; B01D 2255/20723; B01D 2255/20738; B01D 2255/20746; B01D 2255/20753; B01D 2255/20761; B01D 2255/20792; B01D 2255/2092; B01D 2257/504; B01D 2259/802; B01D 2259/804

(57) ABSTRACT

A method for capturing CO₂ from a fluid is provided. The method comprises the steps of providing a metal-based surface, adjusting the surface charge of the metal-based surface to a first state that allows adsorption of CO₂ on the metal-based surface, and contacting the metal-based surface with the surface charge in the first state to a fluid containing CO₂ to be captured, and allowing said CO₂ to become adsorbed on the metal-based surface. The adjusting of the surface charge at step b) is carried out by (A) exposing or refraining from exposing the metal-based surface to radiation or (B) applying or refraining from applying a potential difference on the metal-based surface. The first state is one of the following (i) to (iii): (i) a positive surface charge, (ii) a negative surface charge, and (iii) a neutral surface charge.

### CROSS REFERENCE TO RELATED APPLICATIONS

This application claims benefit, under 35 U.S.C. § 119(e), of U.S. provisional application Ser. No. 63/752,116, filed on Jan. 31, 2025. All documents above are incorporated herein in their entirety by reference.

### FIELD OF THE INVENTION

The present invention relates to a method of capturing CO₂. More specifically, the present invention is concerned with the use of a metal-based surface for capturing CO₂ using surface charges induced by various stimuli, such as sunlight, applied voltage and resulting electric fields.

### BACKGROUND OF THE INVENTION

Carbon Capture and Storage (CCS) involves capturing and separating CO₂ emissions from flue gases or the atmosphere and storing them underground. CCS plays a vital role in achieving the Intergovernmental Panel on Climate Change's goal of lowering CO₂ emissions by 50-85% compared to 2000 levels by 2050 [1]. The significance of CCS lies in its diverse contributions to transitioning towards a net-zero carbon economy: addressing existing energy source emissions, providing solutions for sectors with challenging emissions, enabling clean hydrogen production from methane, and offsetting difficult-to-mitigate direct emissions. Currently, several CCS techniques are available, including post-combustion capture, pre-combustion capture, and oxyfuel combustion, to facilitate CO₂ capture, each with its unique advantages and challenges. Alternative storage approaches, such as ocean storage, mineralization, direct air capture (DAC), and green bio-engineered approaches, have also been considered.

Currently, CO₂ capture technologies are expensive and energy-intensive. Specifically, the lack of an “ideal” material that preferentially adsorbs CO₂ from air or flue streams and efficiently desorbs it with minimal energy input poses a significant challenge for CCS technologies. Most commercial CO₂ capture uses amine-based solvent materials like monoethanolamine (MEA), which can selectively react with CO₂ to form stable carbamate. However, amine-based solvents are highly toxic and consume a lot of energy when they are regenerated during each capture cycle, increasing overall operation costs. In addition, the solvents can be degraded over time due to oxidation, reducing their efficiency. In this framework, CO₂ capture using adsorption on porous solids has piqued the interest of researchers due to its advantages over all other alternatives. For instance, the adsorbent can be regenerated by either applying pressure (pressure swing) or temperature (temperature swing); also, it delivers significant energy savings over the amine-based absorption approach. To date, research efforts directed toward capturing CO₂ with solid adsorbents have focused on increasing the CO₂ adsorption capacity and decreasing the regeneration energy by minimizing the heat of adsorption/desorption.

Several works on using physisorbents or chemisorbents, such as carbon-based nanomaterials, activated carbons, zeolites, and metal-organic frameworks (MOFs) to capture CO₂, have been published recently. However, these materials suffer from low tolerance to humidity and impurities, low adsorption capacity, high capture costs, slow kinetic rates, and the major drawback of requiring external energy (typically heat generated from fossil fuel combustion) to desorb the strongly adsorbed CO₂ and regenerate the material. The quest for an “ideal” CO₂ capture material, characterized by preferential adsorption, fast kinetics, energy-efficient regeneration, and environmental suitability, remains a primary focus of research in this domain.

### SUMMARY OF THE INVENTION

In accordance with the present invention, there is provided:
1. A method for capturing CO₂ from a fluid, the method comprising the steps of:
   a) providing a metal-based surface,
   b) adjusting the surface charge of the metal-based surface to a first state, wherein said first state allows adsorption of CO₂ on the metal-based surface, and
   c) contacting the metal-based surface with the surface charge in said first state to a fluid containing CO₂ to be captured, and allowing said CO₂ to become adsorbed on the metal-based surface,
wherein the adjusting of the surface charge at step b) is carried out by (A) exposing or refraining from exposing the metal-based surface to radiation or (B) applying or refraining from applying a potential difference on the metal-based surface, and
wherein said first state is one of the following (i) to (iii):
   (i) a positive surface charge,
   (ii) a negative surface charge, and
   (iii) a neutral surface charge.
2. The method of embodiment 1, further comprising the step of:
   d) adjusting the surface charge of the metal-based surface to a second state, wherein said second state allows desorption of CO₂ from the metal-based surface, and
   e) allowing the CO₂ to desorb from the metal-based surface with the surface charge in said second state,
wherein the adjusting of the surface charge at step d) is carried out by (A) exposing or refraining from exposing the metal-based surface to radiation or (B) applying or refraining from applying a potential difference on the metal-based surface, and
wherein said second state is another of said (i) to (iii).
3. The method of 1 or 2, wherein the radiation is UV, visible, or IR radiation.
4. The method of any one of embodiments 1 to 3, wherein the radiation is sunlight.
5. The method of any one of embodiments 1 to 3, wherein a laser or a LED is used as a radiation source.
6. The method of any one of embodiments 1 to 5, wherein the radiation creates a charge on the metal-based surface via the photovoltaic effect, by photogeneration, and/or via the photogalvanic effect 7. The method of any one of embodiments 1 to 6, wherein the potential difference is applied using a battery or a power supply, by inductive coupling, or via the thermoelectric effect.
8. The method of any one of embodiments 1 to 7, wherein said adjusting of the surface charge at step b) or step d) or both steps b) and d) is carried out by (A) exposing or refraining from exposing the metal-based surface to radiation.
9. The method of any one of embodiments 1 to 7, wherein the adjusting of the surface charge at step b) or step d) or both steps b) and d) is carried out (B) applying or refraining from applying a potential difference on the metal-based surface.
10. The method of any one of embodiments 1 to 9, wherein, when at step b), the adjusting of the surface charge is carried out by (A) exposing the metal-based surface to radiation or (B) applying a potential difference on the metal-based surface, said exposing or said applying is continued throughout step c).
11. The method of any one of embodiments 1 to 9, wherein, when at step b), the adjusting of the surface charge is carried out by (A) refraining from exposing the metal-based surface to radiation or (B) refraining from applying a potential difference on the metal-based surface, said refraining is continued throughout step c).
12. The method of any one of embodiments 1 to 9, wherein, when at step d), the adjusting of the surface charge is carried out by (A) exposing the metal-based surface to radiation or (B) applying a potential difference on the metal-based surface, said exposing or said applying is continued throughout step e).
13. The method of any one of embodiments 1 to 9, wherein, when at step b), the adjusting of the surface charge is carried out by (A) refraining from exposing the metal-based surface to radiation or (B) refraining from applying a potential difference on the metal-based surface, said refraining is continued throughout step e).
14. The method of any one of embodiments 1 to 13, wherein the fluid containing CO₂ to be captured is a liquid or a gas mixture.
15. The method of embodiment 14, wherein, at step c), the metal-based surface is immersed in said liquid or exposed to said gas mixture.
16. The method of embodiment 14 or 15, wherein the gas mixtures is the atmosphere or a flue gas, preferably a combustion flue gas, an industrial process flue cases, a waste incineration flue gases, a flue gas from biomass combustion, and a flue gas from natural gas combustion.
17. The method of any one of embodiments 14 to 16, wherein said liquid is seawater, industrial wastewater, natural water bodies, chemical solutions, agricultural runoff, and power plant effluents.
18. The method of any one of embodiments 1 to 17, wherein step e), and preferably step d), are carried out so the CO₂ is released and contained.
19. The method of any one of embodiments 1 to 18, wherein the CO₂ is desorbed into a container or pipe so the CO₂ can be transported or stored until is used, disposed of, or stored permanently.
20. The method of any one of embodiments 1 to 19, wherein, the metal-based surface is a surface of a metal or a metal alloy.
21. The method of any one of embodiments 1 to 20, wherein the metal-based surface is the surface of the metal, preferably a Zn (0001) metal surface, Pt (111) metal surface, Fe-gamma (110) metal surface, Al-alpha (110) metal surface, Al-beta (0001) metal surface, Co-alpha (111) metal surface, Co-epsilon (0001) metal surface, or Cu (111) metal surface.
22. The method of any one of embodiments 1 to 21, wherein the metal-based surface is a Cu (111), Zn (0001), Co-alpha (111), or Al-beta (0001) surface.
23. The method of any one of embodiments 1 to 22, wherein the metal-based surface is a Cu (111) metal surface.
24. The method of embodiment 23, wherein the first state is a negative surface charge, and the second state is a positive surface charge.
25. The method of any one of embodiments 1 to 22, wherein the metal-based surface is a Zn (0001) metal surface.
26. The method of embodiment 25, wherein the first state is neutral, and the second state is a positive surface charge.
27. The method of any one of embodiments 1 to 22, wherein the metal-based surface is a Co-alpha (111) metal surface.
28. The method of embodiment 27, wherein the first state is a neutral surface charge, and the second state is negative surface charge.
29. The method of any one of embodiments 1 to 22, wherein the metal-based surface is an Al-beta (0001) metal surface.
30. The method of embodiment 29, wherein the first state is neutral, and the second state is negative surface charge.
31. The method of any one of embodiments 1 to 20, wherein the metal-based surface is the surface of the metal alloy.
32. The method of embodiment 31, wherein metal alloy comprises two or more of the following metals: Al, Ni, Cu, Pt, V, Fe, Co, and Zn.
33. The method of embodiment 31 or 32, wherein the metal-based surface is a Fe₃Co, FeCo, FeNi₃, or V₃Ni surface.
34. The method of any one of embodiments 1 to 33, wherein the metal-based surface is a planar surface, an irregular surface, or a surface of a particles, preferably a surface of a nanoparticle.
35. The method of embodiment 34, wherein, when using nanoparticles, the adjusting at steps b) and d) is carried by (A) exposing or refraining from exposing the metal-based surface to radiation.
36. The method of any one of embodiments 1 to 35, wherein the metal-based surface has a specific surface area of ≥100 m²/g.
37. Use of radiation exposure of a metal-based surface or application of a potential difference to a metal-based surface to capture CO₂. 38. The use of embodiment 37, further comprising the release of captured CO₂.

### BRIEF DESCRIPTION OF THE DRAWINGS

In the appended drawings:

FIG. 1 show a visual representation of adsorption sites of CO₂ on various metals (dark color balls represent the surface atoms, and light color balls represent the subsurface atoms). Adsorption sites are represented by T (top), B (bridge), fcc (hollow), hcp, SB (short bridge), LB (long bridge), and H (hollow).

FIG. 2 show the Bader charge distribution of adsorbed CO₂ on different metals under charged and uncharged conditions. The black, green, and red stars represent the adsorption energies for neutral, positively, and negatively charged surfaces, respectively. The dotted black, green, and red lines in each metal section represent the average adsorption energy values for neutral, positively, and negatively charged surfaces, respectively.

FIG. 3 shows the D-band center value with respect to Fermi energy of different metals in charged and uncharged conditions.

FIG. 4A is a heatmap representing mutual information values between different factors in the neutral states. AE=adsorption energy of CO₂, BC=Bader charge.

FIG. 4B is a heatmap representing mutual information values between different factors in the presence of a positive charge. AE=adsorption energy of CO₂, BC=Bader charge.

FIG. 4C is a heatmap representing mutual information values between different factors in the presence of a negative charge. AE=adsorption energy of CO₂, BC=Bader charge.

FIG. 5A shows adsorption energies of CO₂ on neutral and charged metal surfaces at different adsorption sites for Zn (0001).

FIG. 5B shows adsorption energies of CO₂ on neutral and charged metal surfaces at different adsorption sites for V (110).

FIG. 5C shows adsorption energies of CO₂ on neutral and charged metal surfaces at different adsorption sites for Pt (111).

FIG. 5D shows adsorption energies of CO₂ on neutral and charged metal surfaces at different adsorption sites for Ni(111).

FIG. 5E shows adsorption energies of CO₂ on neutral and charged metal surfaces at different adsorption sites for Fe alpha (110).

FIG. 5F shows adsorption energies of CO₂ on neutral and charged metal surfaces at different adsorption sites for Fe gamma (110).

FIG. 5G shows adsorption energies of CO₂ on neutral and charged metal surfaces at different adsorption sites for Cu (111).

FIG. 5H shows adsorption energies of CO₂ on neutral and charged metal surfaces at different adsorption sites for Co alpha (111).

FIG. 5I shows adsorption energies of CO₂ on neutral and charged metal surfaces at different adsorption sites for Al alpha (110).

FIG. 5J shows adsorption energies of CO₂ on neutral and charged metal surfaces at different adsorption sites for Al beta (0001).

FIG. 5K shows adsorption energies of CO₂ on neutral and charged metal surfaces at different adsorption sites for Co epsilon (0001).

FIG. 6 shows the process followed in Example 2.

FIG. 7A shows the choice of alloys tested in Example 2 Al, V, Fe, and Co combinations.

FIG. 7B shows the choice of alloys tested in Example 2 Ni, Cu, Zn, and Pt combinations.

FIG. 8 shows the CO₂ adsorption energies of the alloys across various adsorption sites.

FIG. 9 shows the adsorption energy of CO₂ on the Cu(111) surface as a function of the applied voltage (V) between dipole sheets.

FIG. 10 shows the adsorption energy of CO₂ on the surface of Cu(111) implementing the combined effects of applied voltage and excess electrons.

FIG. 11 show the desorption energy plot of CO₂ under reverse potential ranging from −1V to −10V.

FIG. 12A shows the dipole sheet method used for applying EF and surface charges left) activation right) desorption of CO₂.

FIG. 13A shows the aggregated surface partial charge versus applied potential on the top and bottom layers (above) and Electrostatic potential (below) around a Cu (111) surface.

FIG. 13B shows the aggregated surface partial charge versus applied potential on the top and bottom layers (above) and Electrostatic potential (below) around a Fe (110) surface.

FIG. 13C shows the aggregated surface partial charge versus applied potential on the top and bottom layers (above) and Electrostatic potential (below) around a Zn (0001) surface.

FIG. 14 shows the charge density difference (CDD) between bare surfaces and surfaces with 1 electron, 1 electron+5 V and 1 electron+25 V. Top panel shows CDD for Cu (111) surface, the middle panel shows CDD for Fe (110) surface, and the bottom panel shows CDD between Zn (0001) surface.

FIG. 15A shows the potential distribution for a Cu (111) surface, at various voltages and excess electrons.

FIG. 15B shows the potential distribution for a Fe (110) surface, at various voltages and excess electrons.

FIG. 15C shows the potential distribution for a Zn (0001) surface, at various voltages and excess electrons.

FIG. 16A shows the final configurations for adsorbed CO₂ on Cu (111) surface at different EF strengths.

FIG. 16B shows the dependence of CO₂ adsorption energy on the applied potential.

FIG. 17A shows the adsorption energy of CO₂ on Cu surface as a function of both EF and excess electrons.

FIG. 17B shows the comparative study of the Charge Density Difference for the field-only effects and the synergistic effect of both field and surplus electrons.

FIG. 18A shows the chemisorbed CO₂ configurations on the bridge site at an applied potential of 25V.

FIG. 18B shows the chemisorbed CO₂ configurations on the bridge site at an applied potential of 30V.

FIG. 18C shows the CO₂ adsorption energy trend over different adsorption sites of Cu (111) at 30V.

FIG. 19A shows the desorption energy of CO₂ under reverse potential ranging from −1V to −10.

FIG. 19B shows the aggregated surface partial charges on the top and bottom layers of the Cu under reverse potentials.

FIG. 20A shows the initial structure used for desorption (30V chemisorbed structure).

FIG. 20B shows the most stable structure after applying 3V of reverse polarity.

FIG. 20C shows the most stable structure after applying 5V of reverse polarity FIG. 21A shows the dependence of CO₂ adsorption energy on the applied potential.

FIG. 21B shows the final configurations for adsorbed CO₂ on Fe (110) surface.

FIG. 22 shows the final configurations for adsorbed CO₂ on Fe (110) surface at a) top, b) short bridge (SB), c) long bridge (LB) and d) hollow sites, respectively.

FIG. 23A shows the final configurations for adsorbed CO₂ on Fe (110) surface under reverse polarity.

FIG. 23B shows the desorption energy of CO₂ under reverse potential ranging from −1V to −15V.

FIG. 24A shows the final configurations for adsorbed CO₂ on Zn (0001) surface.

FIG. 24B shows the dependence of CO₂ adsorption energy on the applied potential.

FIG. 25 shows the final optimized configurations of adsorbed CO₂ on Zn (0001) surface at a) 20V, (b) 25V, (c) 20V+1e, and (d) 25V+1e.

FIG. 26 shows the final stable configuration for adsorbed CO₂ on Zn (0001) surface at different adsorption site in the presence of applied potential of 30V.

FIG. 27A shows the heatmap representing the Pearson correlation values between different descriptors in the presence of EF on Cu (111), where E_ads=Adsorption energy and the Bond distance represent the distance between the adsorbent and adsorbate.

FIG. 27B shows the heatmap representing the Pearson correlation values between different descriptors in the presence of EF on Fe (110), where E_ads=Adsorption energy and the Bond distance represent the distance between the adsorbent and adsorbate.

FIG. 27C shows the heatmap representing the Pearson correlation values between different descriptors in the presence of EF on Zn (0001), where E_ads=Adsorption energy and the Bond distance represent the distance between the adsorbent and adsorbate.

FIG. 28A shows the projected density of states (PDOS) for Cu (111) (first row) and adsorbed CO₂ (C and O atoms) on Cu (111) (second and third rows) under different external electric fields, showing field-induced electronic structure changes.

FIG. 28B shows the projected density of states (PDOS) for Fe (110) (first row) and adsorbed CO₂ (C and O atoms) on Fe (110) (second and third rows) under different external electric fields, showing field-induced electronic structure changes.

FIG. 28C shows the projected density of states (PDOS) for Zn (0001) (first row) and adsorbed CO₂ (C and O atoms) on Zn (0001) (second and third rows) under different external electric fields, showing field-induced electronic structure changes.

FIG. 29A to FIG. 29I shows the temperature (T1-T4) and outlet CO₂ concentration versus time for metal foams:

FIG. 29A shows conventional thermal runs for the Cu foam, with adsorption at ≈25° C. and desorption driven by 25→110° C. dark heating.

FIG. 29B shows the Cu foam light-assisted runs with illumination through the glass lid.

FIG. 29C shows conventional thermal runs for the Al foam, with adsorption at ≈25° C. and desorption driven by 25→110° C. dark heating.

FIG. 29D shows the Al foam light-assisted runs with illumination through the glass lid.

FIG. 29E show conventional thermal runs for the Ni foam, with adsorption at ≈25° C. and desorption driven by 25→110° C. dark heating.

FIG. 29F shows the Ni foam light-assisted runs with illumination through the glass lid.

FIG. 29G presents Cu runs operated at 25° C./25° C. for the voltage experiment 0 V.

FIG. 29H presents Cu runs operated at 25° C./25° C. for the voltage experiment +V.

FIG. 29I presents Cu runs operated at 25° C./25° C. for the voltage experiment −V.

Shaded regions indicate the cleaning phase (high-T N2 purge), adsorption phase (CO₂/N2 feed at ≈25° C.), and desorption phase (N2 purge under thermal, light-assisted, or voltage-assisted conditions).

FIG. 30A shows the blank-subtracted CO₂ amounts (means±1σ) obtained from breakthrough-curve integrals: glass-lid (photo-assisted) 25° C./1110° C. cycles for Cu, Al, and Ni foams.

FIG. 30B shows the blank-subtracted CO₂ amounts (means±1σ) obtained from breakthrough-curve integrals: corresponding dark thermal 25° C./110° C. cycles.

FIG. 30C shows the blank-subtracted CO₂ amounts (means±1σ) obtained from breakthrough-curve integrals: isothermal 25° C./125° C. voltage runs on Cu foam at 0 V, positive bias (“+V”), and negative bias (“−V”).

Adsorption and desorption amounts are shown separately for each condition.

FIG. 31A to FIG. 31F show the CO₂ uptake on Cu, Al, and Ni foams, normalized and blank-subtracted (means±1σ):

FIG. 31A shows area-normalized adsorption and desorption capacities (mmol m⁻²) for glass-lid (photoassisted) 25° C./110° C. runs.

FIG. 31B shows area-normalized adsorption and desorption capacities (mmol m⁻²) for dark thermal 25° C./110° C. runs.

FIG. 31C shows area-normalized adsorption and desorption capacities (mmol m⁻²) for isothermal 25° C./125° C. voltage runs on Cu foam (0 V, +V, −V).

FIG. 31D presents the mass-normalized capacities (mmol g⁻¹) using the measured foam masses corresponding to FIG. 31A.

FIG. 31E presents the mass-normalized capacities (mmol g⁻¹) using the measured foam masses corresponding to FIG. 31B.

FIG. 31F presents the mass-normalized capacities (mmol g⁻¹) using the measured foam masses corresponding to FIG. 31C.

FIG. 32A to FIG. 32D shows the comparison of CO₂ capacities for literature sorbents and metal foams on surface-area- and mass-normalized bases:

FIG. 32A shows equilibrium uptake at ≈25° C. and approximate CO₂ desorbed per cycle, normalized by BET area for porous materials.

FIG. 32B shows equilibrium uptake at ≈25° C. and approximate CO₂ desorbed per cycle, normalized by micro-CT geometric area for foams (μmolm⁻²).

FIG. 32C presents the same quantities as FIG. 31A per unit mass (mmolg⁻¹).

FIG. 32D presents the same quantities as FIG. 31B per unit mass (mmolg⁻¹).

Bars labelled “Cu (glass)”, “Cu (therm)”, and “Cu (0 V)/Cu (+V)/Cu (−V)” correspond to glass-lid photo-assisted, dark thermal, and 25° C./125° C. voltage runs on Cu foam, respectively. Ni foam under thermal operation has a slightly negative blank-subtracted capacity and is therefore omitted from the logarithmic plots.

### DETAILED DESCRIPTION OF THE INVENTION

Turning now to the invention in more details, there is provided a method for capturing CO₂ from a fluid, the method comprising the steps of:
a) providing a metal-based surface,
b) adjusting the surface charge of the metal-based surface to a first state, wherein said first state allows adsorption of CO₂ on the metal-based surface, and
c) contacting the metal-based surface with the surface charge in said first state to a fluid containing CO₂ to be captured, and allowing said CO₂ to become adsorbed on the metal-based surface, wherein the adjusting of the surface charge at step b) is carried out by (A) exposing or refraining from exposing the metal-based surface to radiation or (B) applying or refraining from applying a potential difference on the metal-based surface, and
   wherein said first state is one of the following (i) to (iii):
(i) a positive surface charge,
(ii) a negative surface charge, and
(iii) a neutral surface charge.

In embodiments, the method further comprises the step of:
d) adjusting the surface charge of the metal-based surface to a second state, wherein said second state allows desorption of CO₂ from the metal-based surface, and
e) allowing the CO₂ to desorb from the metal-based surface with the surface charge in said second state,
wherein the adjusting of the surface charge at step d) is carried out by (A) exposing or refraining from exposing the metal-based surface to radiation or (B) applying or refraining from applying a potential difference on the metal-based surface, and
wherein said second state is another of the above (i) to (iii).

There is also provided the use of radiation exposure of a metal-based surface or application of a potential difference to a metal-based surface to capture CO₂. In embodiments, this use further comprises the capture and subsequent release of the captured CO₂.

The method and use of the invention are based on the use of radiation or of a potential difference to induce a change in the surface charge on the metal-based surface. This change modifies the metal-based surface ability to allow CO₂ to adsorb on and to desorb from the surface. Depending on the exact nature of the metal-based surface, a positive (or negative) surface charge may favor adsorption while a neutral surface charge may favor desorption or inversely. The reverse may also be true. In fact, all combinations are possible.

The method/use of the invention allows to efficiently adsorb CO₂ from fluids such as air and flue streams and to efficiently desorb it with minimal energy input. No toxic solvents are required. There is no costly regeneration of sorbent material as desorption is very efficient and cheap. The method/use of the invention is robust and should not be overly affected by environmental conditions such as humidity, or by impurities. Overall, the method/use of the invention are expected to provide cheap, fast, energy-efficient CO₂ capture in an environmentally suitable and sustainable manner.

In embodiments, the adjusting of the surface charge at step b) or step d) or both steps b) and d) is carried out by (A) exposing or refraining from exposing the metal-based surface to radiation. In embodiments, the radiation is UV, visible, or IR radiation. In preferred embodiments, the radiation is sunlight. In alternative embodiments, the radiation source is a laser or a LED.

In embodiments, the radiation creates a charge on the metal-based surface:
via the photovoltaic effect (the metal-based surface is affixed to a semiconductor material, and the radiation generates a potential difference across the interface between the semiconductor material and the metal, and thus alters the charge on the metal-based surface),
by photogeneration (radiation being absorbed, and increasing the number of excited charge carriers (electrons and holes) in the material), and/or
via the photogalvanic effect (radiation causing a potential difference in a material due to the movement of charge carriers).

In alternative embodiments, the adjusting of the surface charge at step b) or step d) or both steps b) and d) is carried out (B) applying or refraining from applying a potential difference on the metal-based surface. The exactly potential difference applied to the metal-based surface will depend on the exact nature of the surface. For example, for a copper surface, the potential difference can be about 30 V for adsorption and 2V in the reverse direction to desorb CO₂.

In embodiments, the potential difference is applied:
using a battery or a power supply (connecting the positive and negative terminals of the battery or power supply to the metal-based surface using conductive wires;
by inductive coupling (passing an alternating current through a coil of wire, thus generating a magnetic field, which induces a potential difference in the metal-based surface); or
via the thermoelectric effect (creating a temperature difference across the metal-based surface, thus generating a potential difference).

Generally, when at step b), the adjusting of the surface charge is carried out by (A) exposing the metal-based surface to radiation or (B) applying a potential difference on the metal-based surface, said exposing or said applying is continued throughout step c). Similarly, when at step b), the adjusting of the surface charge is carried out by (A) refraining from exposing the metal-based surface to radiation or (B) refraining from applying a potential difference on the metal-based surface, said refraining is continued throughout step c). In embodiments, this ensures that the surface charge remains in the first state.

Generally, when at step d), the adjusting of the surface charge is carried out by (A) exposing the metal-based surface to radiation or (B) applying a potential difference on the metal-based surface, said exposing or said applying is continued throughout step e). Similarly, when at step b), the adjusting of the surface charge is carried out by (A) refraining from exposing the metal-based surface to radiation or (B) refraining from applying a potential difference on the metal-based surface, said refraining is continued throughout step e). In embodiments, this ensures that the surface charge remains in the second state.

As noted above, at step c), the metal-based surface is contacted with a fluid containing CO₂ to be captured. In embodiments, the fluid containing CO₂ to be captured is a liquid or a gas mixture. Thus, in embodiments, at step c) the metal-based surface is immersed in said liquid or exposed to said gas mixture.

Non-limiting examples of such gas mixtures include the atmosphere and flue gases such as combustion flue gases (produced from the burning of fossil fuels such as coal, oil, natural gas, and biomass), industrial process flue cases (generated from various industrial processes, such as cement production, steel manufacturing, and chemical processing), waste incineration flue gases (produced from the incineration of waste materials), flue gases from biomass combustion (produced when biomass like wood, or agricultural residues is burned), and flue gases from natural gas combustion. Non-limiting examples of liquids include seawater (for alkalinity enhancement or to promoting the growth of useful phytoplankton), industrial wastewater (to reduce emission and possibly allow reusing the CO2), natural water bodies (to enhance the natural co₂ sequestration capabilities of wetlands by capturing co₂ from water and sediments), chemical solutions (e.g., those produced by other CO₂ capture technologies), agricultural runoff, and power plant effluents (such as flue gas desulfurization liquids).

In step e), the CO₂ is allowed to desorb from the metal-based surface. The skilled person will understand that desorption may in fact, in some cases, start during step d). Thus, step e), and preferably step d) as well, should be carried out in a way to release the CO₂ so it can be contained. Thus, in embodiments, the CO₂ is desorbed into a container or pipe so the CO₂ can be transported or stored until is used, disposed of, or stored permanently.

In embodiments, the metal-based surface is a surface of a metal or a metal alloy.

In embodiments, the metal-based surface is a surface of one of the following metals: Cu, Ag, Au, Fe, Al, Co, Pd, Zn, and Pt, preferably Cu, Ag, Au, Pd, and Pt, and most preferably Cu.

In embodiments, the metal-based surface is a metal surface such as:
Zn (0001) metal surface, i.e., a surface oriented along the (0001) plane in the hexagonal close-packed (hcp) crystal structure of zinc;
Pt (111) metal surface i.e., a surface oriented along the (111) plane in the face-centered cubic (fcc) crystal structure of platinum;
Fe-gamma (110) metal surface i.e., a surface oriented along the (110) plane in the face-centered cubic (fcc) crystal structure of gamma iron (austenite);
Al-alpha (110) metal surface i.e., a surface oriented along the (110) plane in the face-centered cubic (fcc) crystal structure of alpha aluminum;
Al-beta (0001) metal surface i.e., a surface oriented along the (0001) plane in the hexagonal close-packed (hcp) crystal structure of beta aluminum,
Co-alpha (111) metal surface i.e., a surface oriented along the (111) plane in the face-centered cubic (fcc) crystal structure of alpha cobalt;
Co-epsilon (0001) metal surface i.e., a surface oriented along the (0001) plane in the hexagonal close-packed (hcp) crystal structure of epsilon cobalt, or
Cu (111) metal surface i.e., a surface oriented along the (111) plane in the face-centered cubic (fcc) crystal structure of copper.

In preferred embodiments, the metal-based surface is a Cu (111), Zn (0001), Co-alpha (111), or Al-beta (0001) metal surface.

In embodiments, the metal-based surface is a metal alloy surface. The alloy may comprise two or more of the following metals: Al, Ni, Cu, Pt, V, Fe, Co, and Zn. In preferred embodiments, the metal-based surface is a Fe₃Co, FeCo, FeNi₃, or VNi surface.

In preferred embodiments, the metal-based surface is a Cu (111), metal surface. Preferably, in such embodiments, the first state (for CO₂ adsorption) is a negative surface charge, and the second state (for CO₂ desorption) is positive surface charge.

In preferred embodiments, the metal-based surface is a Zn (0001) metal surface. Preferably, in such embodiments, the first state (for CO₂ adsorption) is neutral, and the second state (for CO₂ desorption) is a positive surface charge.

In preferred embodiments, the metal-based surface is a Co-alpha (111) metal surface. Preferably, in such embodiments, the first state (for CO₂ adsorption) is a neutral surface charge, and the second state (for CO₂ desorption) is negative surface charge.

In preferred embodiments, the metal-based surface is an Al-beta (0001) metal surface. Preferably, in such embodiments, the first state (for CO₂ adsorption) is neutral, and the second state (for CO₂ desorption) is negative surface charge.

The shape of the metal-based surface is not crucial to the functioning of the invention. In embodiments, the metal-based surface is a planar surface, an irregular surface, or a surface of a particles, such as a nanoparticle. Nanoparticles are particularly interesting for use in capturing CO₂ in liquids as they can be suspended in said liquids. Preferably, when using nanoparticles, the adjusting at steps b) and d) is carried out using radiation. In embodiments, the metal-based surface has a high specific surface area, for example ≥100 m²/g. Indeed, surfaces with a high specific surface area are preferred in some instances as they allow for greater contact between the surface and CO₂.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

Similarly, herein a general chemical structure, such as Formulas * to *, with various substituents (R₁, R₂, etc.) and various radicals (alkyl, halogen atom, etc.) enumerated for these substituents is intended to serve as a shorthand method of referring individually to each and every molecule obtained by the combination of any of the radicals for any of the substituents. Each individual molecule is incorporated into the specification as if it were individually recited herein. Further, all subsets of molecules within the general chemical structures are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1—Harvesting Surface Charges on Metals for Energy-Efficient CO2 Capture: a First-Principles Investigation

### Abstract of Example 1

The potential of surface charges induced by various stimuli (e.g., sunlight and voltage) on metal surfaces as an energy-efficient alternative for CO₂ capture was investigated. This study employs density-functional theory calculations to examine the interaction between CO₂ molecules and a diverse set of metal surfaces under varying charge conditions, encompassing both plasmonic and non-plasmonic transition metals, including Cu, Zn, Co, Fe, V, Pt, Ni, and Al.

The objective is to comprehensively understand how surface charges impact CO₂ adsorption and desorption processes. Key factors under investigation include CO₂ adsorption energy, the d-band center of pristine metal surfaces, surface charge distributions, and structural changes in CO₂ upon adsorption.

The findings reported herein emphasize that the d-band center of metal surfaces is an insufficient descriptor for CO₂ adsorption and desorption. Different metals exhibit distinct behaviors in response to surface conditions when it comes to CO₂ adsorption and desorption. Specifically, this study concludes that the metals that display optimum CO₂ adsorption and desorption efficiency include Cu, Zn, Co(alpha), and Al(beta). CO₂ adsorption on these metal surfaces occurs under neutral conditions, while desorption takes place in electron-rich or electron-deficient conditions.

These findings have implications for future experimental studies aiming to manipulate CO₂ interactions with neutral or charged metal surfaces, potentially driving innovative advancements in CO₂ capture technologies.

### Introduction of Example 1

Transition-metal-based catalysts with varied benefits have been widely researched in heterogeneous catalysis and are also routinely utilized in chemical processes involving CO₂ adsorption, activation, and conversion. Specifically, shape-controlled techniques are used to synthesize a wide range of transition metal nanoparticles that are mostly bordered by low-index facets such as the {111}, {100}, and {110} facets, among others. In a study by Wang et al. (The Journal of Physical Chemistry C, 2017), the chemisorption of CO₂ on various transition metal surfaces was investigated. The researchers, considering only the {111} planes, observed that the adsorption strength of CO₂ was influenced by both the d-band center of the metal surface and charge transfer processes determining C═O bond activation. Similarly, Liu et al. (The Journal of Physical Chemistry C, 2018) conducted research to understand how CO₂ dissociates on transition metal surfaces. It was found that both adsorption energy and activation barriers play significant roles in this process. Lower adsorption energies and lower activation barriers were associated with more favorable dissociation of CO₂ on these surfaces. Moreover, dissociation occurred predominantly at specific sites such as top, bottom, or hollow sites. These findings enhance our understanding of how CO₂ interacts with transition metal catalysts and are valuable for developing efficient catalyst materials for CO₂ conversion reactions. In a study conducted by Ko et al. (The Journal of Physical Chemistry C, 2016), the authors focused on the activation of CO₂ on pure transition metals and their bimetallic counterparts. They observed that the interaction between CO₂ and the metal surface plays a significant role in its activation process. Physisorption of CO₂ is primarily governed by dispersion forces, while chemisorption occurs with a bent structure. The researchers also noted that the adsorption energies of more complex adsorbates can be related to those of simpler ones, particularly atoms or fragments bonded to the surface. Based on these findings, it was suggested that designing bimetallic catalysts with tailored properties could effectively lower activation energies and reduce reaction barriers for CO₂. Dietz et al.'s (The Journal of Physical Chemistry C, 2015) study investigated the activation energies and reaction pathways involved in CO₂ conversion on various metal surfaces. It analyzed the CO₂ dissociation and hydrogenation mechanisms on Pt, Rh, Ni, Cu, Ag, and Pd metals. The study examined how CO₂ coverage affected activation energies and explored the role of metal-oxygen interaction. Results showed that different metals had varying dominant reaction paths due to their affinity to oxygen. The activation energy for CO₂ dissociation followed a Brønsted-Evans-Polanyi relation with a linear relationship between activation energy and reaction energy. Notably, significant variations in the activation energy for CO₂ dissociation were observed among different metals.

Recent research has indicated that the utilization of light in surface processes presents promising opportunities and potential energy savings. Incident light can affect the adsorption and desorption of CO₂ on the surface of a solid substrate in different ways. Photon absorption by the adsorbent material generates excited charge carriers, which then undergo different pathways as they return to thermal equilibrium. One pathway is where the excited electrons might directly transfer energy to vibrational modes within adsorbed CO₂ molecules, thereby facilitating desorption [25]. However, another pathway is that the excited carriers rapidly thermalize and transfer energy to the solid substrate via electron-phonon coupling. This interaction leads to a photo-thermal effect, where the energy transferred from excited charge carriers generates a high-energy distribution of phonons, which can then lead to the transfer of vibrational energy to the adsorbed CO₂, inducing desorption. Moreover, the excited electrons in the catalyst may also engage with physisorbed CO₂, generating chemisorbed CO₂^{δ-}, with elongated C—O bonds and a bent O—C—O bond angle [26]. In this case, the binding energy of CO₂ may increase in the presence of light. Thus, it can be noted that a sort of “photo-switch” mechanism could be in play for adsorbing and desorbing CO₂ from a solid surface. This mechanism hinges on the composition of the solid substrate, potentially encouraging either the adsorption or the desorption of CO₂ when the light is turned “on.”

The probability of inducing a photo-adsorption or desorption effect with incident light may be increased by extending the lifetime of excited charge carriers such that they have more time to interact with the CO₂ molecules prior to thermalizing to an equilibrium state. The lifetime of excited charge carriers may be extended if they transfer into electronic surface states. Alternatively, a surface photovoltage can be generated, for example, by employing a metal-semiconductor contact at the solid substrate surface [27]. This photovoltage may be used to induce a “photoswitch” mechanism that alters the surface charge density and the binding energy of chemisorbed CO₂^{δ-}. Thus, using light to control the surface photovoltage on a metal surface can provide a mechanism for tuning the availability of charge and a means of controlling whether CO₂ adsorption or desorption is favored.

While there has been considerable investigation on CO₂ interaction and activation on metal surfaces, the studies analyzing CO₂ interaction, specifically on charged metal surfaces, are limited despite the generation of photo-induced charges by interactions between metal surfaces and light. Thus, our study aims to explore the potential use of surface charges that could be induced on metal surfaces by various stimuli, such as sunlight and applied voltage, to control CO₂ adsorption and desorption, thereby facilitating CO₂ capture.

Specifically, in this study, we investigated the interaction of CO₂ with various metal surfaces under neutral, electron-rich, and electron-poor conditions via in-depth Density Functional Theory (DFT) calculations. Our investigation focused on both plasmonic and non-plasmonic transition metals like Cu, Zn, Co, Fe, V, Pt, Ni, and Al to discern their behavior in CO₂ adsorption scenarios. These specific metals were selected for their extensive exploration of chemical reactions involving CO₂ activation and conversion [15,28]. In line with our hypothesis that the interaction of light with metal surfaces can induce surface charges, we analyzed charged metal surfaces featuring an additional hole and electron (+1e and −1e) in the context of CO₂ adsorption.

### Computational Methodology

First-principles calculations were performed to investigate the behavior of various low-index metal surfaces under the influence of photo-induced charges. Spin-polarized calculations were carried out using the DFT-based open-source Quantum Espresso (QE) package [29]. The core electrons were treated using the projector augmented wave method [30], and the valence electrons were expanded in plane wave basis sets. Perdew-Becke-Ernzerhof functionals are used for the electronic exchange-correlation energies (generalized gradient approximation) [31]. Twelve valence electrons of Zn (3d, 4s), eleven valence electrons of Cu (3d, 4s), ten valence electrons of Pt (5d, 6s), ten valence electrons of Ni (3d, 4s), nine valence electrons of Co (3d, 4s), eight valence electron of Fe (3d, 4s), six valence electron of 0 (2s, 2p), five valence electron of V (3d, 4s), four valence electron of C (2s, 2p), and three valence electrons of Al (3s, 3p), were considered in the calculations. The basis for the expansion of electronic wavefunction is made finite by limiting the kinetic energy of the basis function up to 61 Ry (≈830 eV). Due to the metallic nature of the systems, the Methfessel-Paxton method was used to deal with partial occupation near the Fermi level [32]. Structure optimization using a conjugate-gradient method was carried out by allowing the electrons and atoms to fully relax until the total energies converged below 10⁻² eV and the force on the atoms was reduced below 0.1 eV/Å. All calculations were performed using 2×2×1 Monkhorst-Pack grids [33] and four-layer slabs. In all cases, a vacuum layer of 10 Å [34] was used above the top layer of the slab.

To validate and test our simulation parameters, the first lattice constants for two metals (Zn and Pt) have been determined. In this test, we used a supercell of 3×3×3 as our starting structure with a F-centered k-point mesh of 2×2×2 and kept the remaining parameters as it is. The lattice parameter obtained from our simulations for Zn (a=2.66 Å, c=4.94 Å) and Pt (a=2.77 Å) were in a good match with the previously reported literature, i.e., for Zn (a=2.665 Å, c=4.952 Å) [35-37] and Pt (a=2.775 Å) [38].

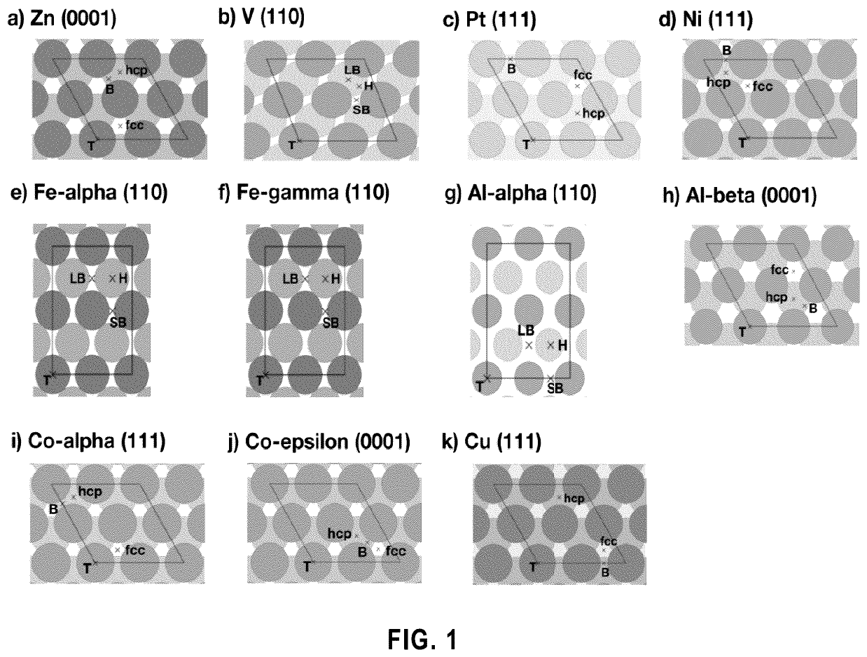

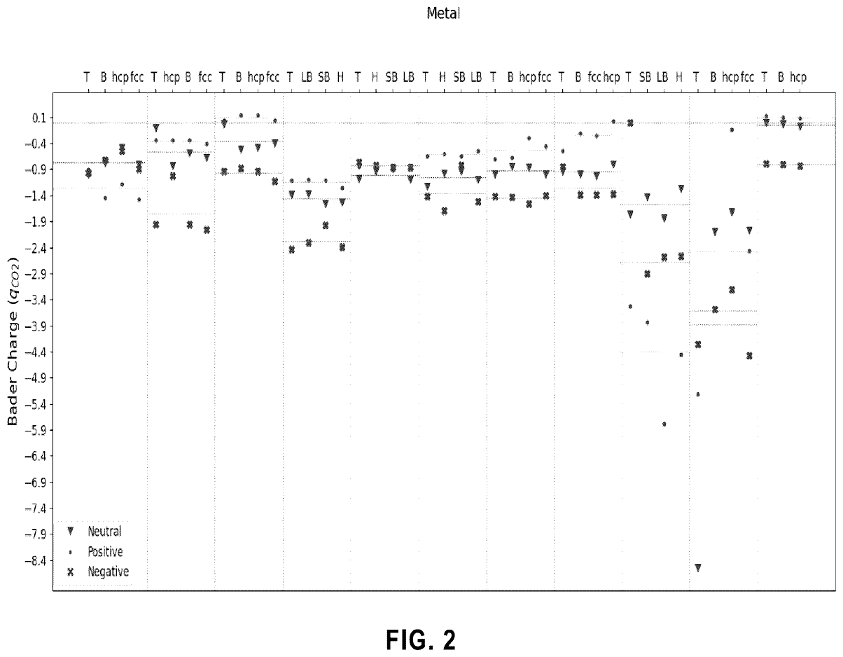

Further, various possible adsorption sites on the metal surfaces were considered for CO₂ adsorption. The calculation of potential adsorption sites was performed using the “pymatgen adsorption module,” [39] which employs geometric factors to generate various adsorption possibilities. FIG. 1 presents a visual depiction of different materials and their corresponding adsorption sites. We calculated the adsorption energy according to the following equation:

$${E}_{ads} = {E}_{adsorbate / slab} - ( {E}_{adsorbate} + {E}_{slab} ) \qquad ( 1 )$$

wherein E_{adsorbate/slab} is the total energy of the neutral or charged surface adsorbed with CO₂, E_{slab} is the total energy of the neutral or charged surface, and E_{adsorbate} is the total energy of the free CO₂ molecule. All the visualization of the structure is done using either the Xcrysden package [40] or virtual nano lab (VNL) [41]. The calculations involving Ni failed to converge using the pseudopotential mentioned previously; therefore, the calculations for Ni were conducted using an “ultra-soft pseudo-potential.”

To investigate the CO₂ interaction with metals having photo-induced surface charges, we performed DFT calculations on the low-index metal slab models with an extra electron and a hole. More precisely, we considered neutral, positively charged, and negatively charged Zn(0001), V(110), Pt(111), Ni (111), Fe-alpha (110), Fe-gamma (110), Al-alpha (110), Al-beta(0001), Co-alpha (111), Co-epsilon (0001), and Cu(111) surfaces for our analysis (FIG. 1). It should be noted that Cu, Ni, Pt, Al-alpha, Fe-gamma, and Co-alpha have FCC structure, V and Fe-alpha have BCC structure, and Co-epsilon, Zn, and Al-beta have HCP structure. The slab is periodic along directions parallel to the surface and is sandwiched by a semi-infinite effective screening medium (ESM) [42], representing a vacuum in both directions normal to the surface.

### Results

This section presents the detailed results obtained through DFT calculations conducted for the adsorption of CO₂ on individual metal surfaces having no surface charge (denoted as S), positive surface charge (PS), and negative surface charge (NS).

### CO₂ Adsorption on the Cu (111) Surface

The following four unique sites were considered to investigate CO₂ adsorption on neutral and charged Cu (111) surfaces: site T represents the top of the Cu atom, site B represents the bridge between two Cu atoms, site hcp represents threefold site with an atom at the bottom, site fcc representing threefold site without an atom at the bottom (refer FIG. 1(k)). As shown in Table 1, at Site T, CO₂ undergoes dissociation into CO and O when the surface is not charged. In contrast, when the surface is positively or negatively charged, the CO₂ molecule does not undergo dissociation; instead, it chemisorbs molecularly onto the surface. As an interesting observation, CO₂ deforms the most when adsorbed on a negatively charged surface (bond angle is 51.77, which is the least when compared with any other metals). At site B, CO₂ is chemisorbed when the surface is neutral or negatively charged and dissociates into CO and O when the surface is positively charged. At site hcp, CO₂ only chemisorbs for all the surfaces. At site fcc, CO₂ dissociates when the surface is positively charged and is chemisorbed molecularly when the surface is negatively charged or neutral. The adsorbed and dissociated CO₂ bond lengths (d_{c=O1} and d_{c=O2}) and the bond angle (∠OCO) can be noted in Table 1, and the adsorption energies and Bader charge can be noted in Table 12.

TABLE 1
Structural properties of adsorbed CO₂ on neutral, positive, and negative Cu surface.

| Cu | Top View | | | d_{C═O1} (Å) | | | d_{C═O2} (Å) | | | ∠OCO ° | | |
|---|---|---|---|---|---|---|---|---|---|---|---|---|
| Site | S | PS | NS | S | PS | NS | S | PS | NS | S | PS | NS |
| T | CO₂ is | CO₂ is | CO₂ is | 1.17 | 1.23 | 1.40 | — | 1.36 | 1.56 | — | 121.09 | 51.77 |
| | dissociating | molecularly | molecularly | | | | | | | | | |
| | | adsorbed | adsorbed | | | | | | | | | |
| B | CO₂ is | CO₂ is | CO₂ is | 1.21 | 1.18 | 1.22 | 1.41 | — | 1.30 | 127.22 | — | 128.72 |
| | molecularly | dissociating | molecularly | | | | | | | | | |
| | adsorbed | | adsorbed | | | | | | | | | |
| hcp | CO₂ is | CO₂ is | CO₂ is | 1.20 | 1.30 | 1.27 | 1.30 | 1.34 | 1.31 | 139.68 | 117.26 | 125.71 |
| | molecularly | molecularly | molecularly | | | | | | | | | |
| | adsorbed | adsorbed | adsorbed | | | | | | | | | |
| fcc | CO₂ is | CO₂ is | CO₂ is | 1.21 | 1.28 | 1.27 | 1.40 | — | 1.27 | 129.45 | — | 124.76 |
| | molecularly | dissociating | molecularly | | | | | | | | | |
| | adsorbed | | adsorbed | | | | | | | | | |

### CO₂ Adsorption on Zn (0001) Surface

The following four unique sites were considered to investigate CO₂ adsorption on neutral and charged Zn (0001) surfaces: site T represents the top of the Zn atom, site hcp represents threefold site without an atom at the bottom, site B representing bridge between two Zn atoms, site fcc representing threefold site without an atom at the bottom (refer FIG. 1(a)). At Site T, CO₂ undergoes dissociation into CO and O when the surface is negatively charged. When the surface is neutral or subjected to a positive charge, the CO₂ molecule does not dissociate and chemisorbs onto the surface. Site-hcp on any of the surfaces remains inactive for CO₂ adsorption or dissociation. However, on-site hcp, CO₂ bends the most when the surface is positively charged and bends the least when the surface is negatively charged. The LOCO bond angle of 70 degrees for the positively charged surface indicates CO₂ is chemisorbed rather than physisorbed on site hcp. At site B, CO₂ is chemisorbed when the surface is neutral or positive and dissociates into CO and O if the surface is negatively charged. At site fcc, CO₂ dissociates when the surface is negatively charged and is physisorbed otherwise. The adsorbed and dissociated CO₂ bond lengths and bond angle (LOCO) are provided in Table 2, and the adsorption energies and Bader charge are given in Table 12.

TABLE 2
Structural properties of adsorbed CO₂ on neutral, positive, and negative Zn surface.

| Zn | Top View | | | d_{C═O1} (Å) | | | d_{C═O2} (Å) | | | ∠OCO ° | | |
|---|---|---|---|---|---|---|---|---|---|---|---|---|
| Site | S | PS | NS | S | PS | NS | S | PS | NS | S | PS | NS |
| T | CO₂ is not | CO₂ is | CO₂ is | 1.18 | 1.26 | 1.19 | 1.20 | 1.57 | — | 162.26 | 70.16 | — |
| | interacting | molecularly | dissociating | | | | | | | | | |
| | | adsorbed | | | | | | | | | | |
| hcp | CO₂ is | CO₂ is | CO₂ is not | 1.20 | 1.25 | 1.18 | 1.43 | 1.56 | 1.21 | 126.49 | 69.92 | 176.59 |
| | molecularly | molecularly | interacting | | | | | | | | | |
| | adsorbed | adsorbed | | | | | | | | | | |
| B | CO₂ is | CO₂ is | CO₂ is | 1.20 | 1.26 | 1.15 | 1.32 | 1.57 | — | 134.26 | 70.10 | — |
| | molecularly | molecularly | dissociating | | | | | | | | | |
| | adsorbed | adsorbed | | | | | | | | | | |
| fcc | CO₂ is | CO₂ is | CO₂ is | 1.19 | 1.18 | 1.13 | 1.26 | 1.46 | — | 132.31 | 139.08 | — |
| | molecularly | molecularly | dissociating | | | | | | | | | |
| | adsorbed | adsorbed | | | | | | | | | | |

### CO₂ Adsorption on Pt (111) Surface

The following four unique sites were considered to investigate CO₂ adsorption on neutral and charged Pt (111) surfaces: site T represents the top of Pt atom, site B represents the bridge between two Pt atoms, site hcp represents the threefold site with an atom at the bottom, site fcc representing threefold site without an atom at the bottom (refer FIG. 1(c)). At Site T, when the surface is neutral or positively charged, CO₂ undergoes dissociation into CO and O. On the other hand, CO₂ is chemisorbed at site T when it is negatively charged. On-site B CO₂ is molecularly adsorbed for all cases (neutral, positive, negative) and bends the most when it is in contact with a neutral surface, followed by a negative surface and then a positive surface. On any of the surfaces—neutral, positive, and negative—there is no evidence of the dissociation of CO₂ at site hcp. The dissociation of CO₂ on-site fcc occurs when the surface is positively charged and is chemisorbed otherwise. Table 3 shows the adsorbed and dissociated CO₂ bond lengths and bond angle (LOCO), while Table 12 lists the adsorption energies and Bader charge.

TABLE 3
Structural properties of adsorbed CO₂ on neutral, positive, and negative Pt surface.

| Pt | Top View | | | d_{C═O1} (Å) | | | d_{C═O2} (Å) | | | ∠OCO ° | | |
|---|---|---|---|---|---|---|---|---|---|---|---|---|
| Site | S | PS | NS | S | PS | NS | S | PS | NS | S | PS | NS |
| T | CO₂ is | CO₂ is | CO₂ is not | 1.14 | — | 1.22 | — | 1.41 | 1.28 | — | — | 137.35 |
| | dissociating | dissociating | interacting | | | | | | | | | |
| B | CO₂ is | CO₂ is not | CO₂ is not | 1.22 | 1.16 | 1.20 | 1.44 | 1.21 | 1.24 | 125.75 | 171.31 | 145.53 |
| | molecularly | interacting | interacting | | | | | | | | | |
| | adsorbed | | | | | | | | | | | |
| hcp | CO₂ is | CO₂ is not | CO₂ is not | 1.21 | 1.16 | 1.23 | 1.41 | 1.20 | 1.24 | 127.59 | 168.28 | 143.63 |
| | molecularly | interacting | interacting | | | | | | | | | |
| | adsorbed | | | | | | | | | | | |
| fcc | CO₂ is | CO₂ is | CO₂ is | 1.21 | — | 1.22 | 1.34 | — | 1.35 | 131.11 | — | 125.03 |
| | molecularly | dissociating | molecularly | | | | | | | | | |
| | adsorbed | | adsorbed | | | | | | | | | |

### CO₂ Adsorption on V (110) Surface

The following four unique sites were considered to investigate CO₂ adsorption on neutral and charged V (110) surfaces: site T represents the top of V atom, site LB represents between two V atoms, site SB represents the bridge between two V atoms without an atom at the bottom, site H representing hollow site (refer FIG. 1(b)). For all four sites, CO₂ dissociates into CO and O when the surface is neutral or negatively charged. However, when the surface is positively charged, CO₂ is chemisorbed at all the sites except on site H, where CO₂ dissociates whether the surface is charged or not. Table 4 presents the observed bond lengths of the adsorbed and dissociated C₂, as well as the bond angle (∠OCO). Meanwhile, Table 12 provides the recorded adsorption energies and Bader charge.

TABLE 4
Structural properties of adsorbed CO₂ on neutral, positive, and negative V surface.

| V | Top View | | | d_{C═O1} (Å) | | | d_{C═O2} (Å) | | | ∠OCO ° | | |
|---|---|---|---|---|---|---|---|---|---|---|---|---|
| Site | S | PS | NS | S | PS | NS | S | PS | NS | S | PS | NS |
| T | CO₂ is | CO₂ is | CO₂ is | 1.17 | 1.34 | 1.18 | — | 1.32 | — | — | 121.89 | — |
| | dissociating | molecularly | dissociating | | | | | | | | | |
| | | adsorbed | | | | | | | | | | |
| LB | CO₂ is | CO₂ is | CO₂ is | 1.18 | 1.33 | 1.17 | — | 1.31 | — | — | 122.81 | — |
| | dissociating | molecularly | dissociating | | | | | | | | | |
| | | adsorbed | | | | | | | | | | |
| SB | CO₂ is | CO₂ is | CO₂ is | 1.16 | 1.34 | 1.14 | — | 1.32 | — | — | 121.42 | — |
| | dissociating | molecularly | dissociating | | | | | | | | | |
| | | adsorbed | | | | | | | | | | |
| H | CO₂ is | CO₂ is | CO₂ is | 1.18 | 1.32 | 1.17 | — | — | — | — | — | — |
| | dissociating | dissociating | dissociating | | | | | | | | | |

### CO₂ Adsorption on Fe-Alpha (110) Surface

The following four unique sites were considered to investigate CO₂ adsorption on neutral and charged Fe (110) surfaces: site T represents the top of the Fe atom, site H represents the hollow site, site SB represents the short bridge between two Fe atoms, site LB represents the long bridge between two Fe atoms (refer FIG. 1(e)). For all sites investigated, CO₂ undergoes dissociation into CO and O when the surface is either neutral or positively charged. Conversely, when the surface carries a negative charge, CO₂ is adsorbed in a molecular manner. Table 5 shows the adsorbed and dissociated CO₂ bond lengths and bond angle (LOCO), while Table 12 lists the adsorption energies and Bader charge.

TABLE 5
Structural properties of adsorbed CO₂ on neutral, positive, and negative Fe(alpha) surface.

| Fe | | | | | | | | | | | | |
|---|---|---|---|---|---|---|---|---|---|---|---|---|
| (alpha) | Top View | | | d_{C═O1} (Å) | | | d_{C═O2} (Å) | | | ∠OCO ° | | |
| site | S | PS | NS | S | PS | NS | S | PS | NS | S | PS | NS |
| T | CO₂ is | CO₂ is | CO₂ is not | 1.17 | 1.12 | 1.17 | — | — | 1.19 | — | — | 162.12 |
| | dissociating | dissociating | interacting | | | | | | | | | |
| H | CO₂ is | CO₂ is | CO₂ is not | 1.17 | 1.16 | 1.16 | — | — | 1.15 | — | — | 171.42 |
| | dissociating | dissociating | interacting | | | | | | | | | |
| SB | CO₂ is | CO₂ is | CO₂ is | 1.12 | 1.12 | 1.17 | — | — | 1.16 | — | — | 170.00 |
| | dissociating | dissociating | molecularly | | | | | | | | | |
| | | | adsorbed | | | | | | | | | |
| LB | CO₂ is | CO₂ is | CO₂ is | 1.15 | 1.17 | 1.07 | — | — | 1.25 | — | — | 174.51 |
| | dissociating | dissociating | molecularly | | | | | | | | | |
| | | | adsorbed | | | | | | | | | |

### CO₂ Adsorption on Fe-Gamma (110) Surface

The following four unique sites were considered to investigate CO₂ adsorption on neutral and charged Fe (110) surfaces: site T represents the top of the Fe atom, site H represents the hollow site, site SB represents the short bridge between two Fe atoms, site LB represents the long bridge between two Fe atoms (refer FIG. 1(f)). At sites T, H, and LB, CO₂ is chemisorbed if the surface is charged positively and dissociates otherwise. At site SB CO₂ is molecularly adsorbed when the surfaces are positively or negatively charged. Nevertheless, when the surface is neutral, CO₂ dissociates on all the sites, resulting in CO and O. Table 6 presents the bond lengths of adsorbed and dissociated CO₂, as well as the bond angle (LOCO), and Table 12 provides information on the adsorption energies and Bader charges.

TABLE 6
Structural properties of adsorbed CO₂ on neutral, positive, and negative Fe(gamma) surface.

| Fe | | | | | | | | | | | | |
|---|---|---|---|---|---|---|---|---|---|---|---|---|
| (gamma) | Top View | | | d_{C═O1} (Å) | | | d_{C═O2} (Å) | | | ∠OCO ° | | |
| Site | S | PS | NS | S | PS | NS | S | PS | NS | S | PS | NS |
| T | CO₂ is | CO₂ is | CO₂ is | 1.15 | 1.22 | 1.19 | — | 1.33 | — | — | 126.77 | — |
| | dissociating | molecularly | dissociating | | | | | | | | | |
| | | adsorbed | | | | | | | | | | |
| H | CO₂ is | CO₂ is | CO₂ is | 1.12 | 1.21 | 1.15 | — | 1.36 | — | — | 130.27 | — |
| | dissociating | molecularly | dissociating | | | | | | | | | |
| | | adsorbed | | | | | | | | | | |
| SB | CO₂ is | CO₂ is | CO₂ is | 1.14 | 2.28 | 1.16 | — | 1.36 | 1.17 | — | 130.66 | 172.82 |
| | dissociating | molecularly | molecularly | | | | | | | | | |
| | | adsorbed | adsorbed | | | | | | | | | |
| LB | CO₂ is | CO₂ is | CO₂ is | 1.14 | 1.18 | 1.20 | — | 1.47 | — | — | 122.92 | — |
| | dissociating | molecularly | dissociating | | | | | | | | | |
| | | adsorbed | | | | | | | | | | |

### CO₂ Adsorption on Co-Alpha (111) Surface

The following four unique sites were considered to investigate CO₂ adsorption on neutral and charged Co-alpha (111) surfaces: site T represents the top of Co atom, site B represents the bridge between two Cu atoms, site hcp representing threefold site with an atom at the bottom, site fcc representing threefold site without an atom at the bottom (refer FIG. 1(i)). At site T, CO₂ experiences dissociation, resulting in the formation of CO and O when the surface is either neutral or positively charged. However, in the event of a surface with a negative charge, it undergoes chemisorption at site T The dissociation of CO₂ on site B occurs when the surface is charged (positively or negatively), whereas CO₂ is chemisorbed when the surface is neutral. At site hcp, CO₂ is chemisorbed if the surface is positively charged and dissociates into CO and O otherwise. At site fcc, CO₂ is chemisorbed for all cases, and the greatest degree of bending occurs when the surface is negatively charged. Table 7 presents the bond lengths of adsorbed and dissociated CO₂, as well as the bond angle (∠OCO). On the other hand, Table 12 provides information on the adsorption energies and Bader charge.

TABLE 7
Structural properties of adsorbed CO₂ on neutral, positive, and negative Co(alpha) surface.

| Co | | | | | | | | | | | | |
|---|---|---|---|---|---|---|---|---|---|---|---|---|
| (alpha) | Top View | | | d_{C═O1} (Å) | | | d_{C═O2} (Å) | | | ∠OCO ° | | |
| Site | S | PS | NS | S | PS | NS | S | PS | NS | S | PS | NS |
| T | CO₂ is | CO₂ is | CO₂ is | 1.17 | 1.15 | 1.24 | — | — | 1.27 | — | — | 142.18 |
| | dissociating | dissociating | molecularly | | | | | | | | | |
| | | | adsorbed | | | | | | | | | |
| B | CO₂ is | CO₂ is | CO₂ is | 1.22 | 1.16 | 2.19 | 1.49 | — | — | 119.02 | — | — |
| | molecularly | dissociating | dissociating | | | | | | | | | |
| | adsorbed | | | | | | | | | | | |
| hcp | CO₂ is | CO₂ is | CO₂ is | 1.17 | 1.19 | 2.13 | — | 1.32 | — | — | 127.42 | — |
| | dissociating | molecularly | dissociating | | | | | | | | | |
| | | adsorbed | | | | | | | | | | |
| fcc | CO₂ is | CO₂ is | CO₂ is | 1.20 | 1.18 | 1.20 | 1.48 | 1.49 | 1.52 | 124.40 | 132.26 | 121.63 |
| | molecularly | molecularly | molecularly | | | | | | | | | |
| | adsorbed | adsorbed | adsorbed | | | | | | | | | |

### CO₂ Adsorption on Co-Epsilon (0001) Surface

The following four unique sites were considered to investigate CO₂ adsorption on neutral and charged Co-epsilon (0001) surfaces: site T representing the top of Co atom, site B representing the bridge between two Cu atoms, site fcc representing threefold site with an atom at the bottom, site hcp representing threefold site without an atom at the bottom (refer FIG. 1(j)). At the site T, CO₂ experiences dissociation, resulting in the formation of CO and O when the surface is either neutral or positively charged. However, in the event of a surface with a negative charge, chemisorption occurs on that surface. At sites B, hcp, and fcc, CO₂ is chemisorbed when the surface is charged (positively or negatively) and is dissociated into CO and O when the surface is neutral. Table 8 presents the bond lengths of adsorbed and dissociated CO₂, as well as the bond angle (LOCO). Meanwhile, Table 12 provides information on the adsorption energies and Bader charge.

TABLE 8
Structural properties of adsorbed CO₂ on neutral, positive, and negative Co(epsilon) surface.

| Co | | | | | | | | | | | | |
|---|---|---|---|---|---|---|---|---|---|---|---|---|
| (epsilon) | Top View | | | d_{C═O1} (Å) | | | d_{C═O2} (Å) | | | ∠OCO ° | | |
| Site | S | PS | NS | S | PS | NS | S | PS | NS | S | PS | NS |
| T | CO₂ is | CO₂ is | CO₂ is not | 1.14 | 1.13 | 1.18 | — | — | 1.15 | — | — | 174.99 |
| | dissociating | dissociating | interacting | | | | | | | | | |
| B | CO₂ is | CO₂ is | CO₂ is | 1.16 | 1.17 | 1.22 | — | 1.44 | 1.37 | — | 119.49 | 122.17 |
| | dissociating | molecularly | molecularly | | | | | | | | | |
| | | adsorbed | adsorbed | | | | | | | | | |
| fcc | CO₂ is | CO₂ is | CO₂ is not | 1.17 | 1.17 | 1.21 | — | 1.30 | 1.30 | — | 130.18 | 130.70 |
| | dissociating | molecularly | interacting | | | | | | | | | |
| | | adsorbed | | | | | | | | | | |
| hcp | CO₂ is | CO₂ is | CO₂ is | 1.16 | 1.15 | 1.22 | — | 1.24 | 1.34 | — | 166.20 | 127.12 |
| | dissociating | molecularly | molecularly | | | | | | | | | |
| | | adsorbed | adsorbed | | | | | | | | | |

### CO₂ Adsorption on Al-Alpha (110) Surface

The following four unique sites were considered to investigate CO₂ adsorption on neutral and charged Al-alpha (110) surfaces: site T represents the top of Al atom, site SB represents the short bridge between two Al atoms, site LB represents the long bridge between two Al atoms, site H represents the hollow site (refer FIG. 1(g)). At site T, CO₂ experiences dissociation, resulting in the formation of CO and O when the surface is either neutral or positively charged. The simulation failed to converge when applied to a surface with a negative charge. At site SB, CO₂ undergoes dissociation into CO and O when the surface is either positively or negatively charged and is chemisorbed when the surface is neutral. The dissociation of CO₂ at site LB on either neutral or positively charged surfaces is not seen. Nevertheless, when in contact with surfaces with a negative charge, CO₂ undergoes dissociation, forming CO and O species. At site H, CO₂ undergoes molecular adsorption on either neutral or negatively charged surfaces. In the presence of a positively charged surface, CO₂ undergoes dissociation, resulting in the formation of CO and O. Table 9 presents the bond lengths of adsorbed and dissociated CO₂, as well as the bond angle (LOCO). Meanwhile, Table 12 provides information on the adsorption energies and Bader charges.

TABLE 9
Structural properties of adsorbed CO₂ on neutral, positive, and negative Al(alpha) surface.

| Ah | | | | | | | | | | | | |
|---|---|---|---|---|---|---|---|---|---|---|---|---|
| (alpha) | Top View | | | d_{C═O1} (Å) | | | d_{C═O2} (Å) | | | ∠OCO ° | | |
| Site | S | PS | NS | S | PS | NS | S | PS | NS | S | PS | NS |
| T | CO₂ is | CO₂ is | | 1.07 | 1.18 | | — | — | | — | — | |
| | dissociating | dissociating | | | | | | | | | | |
| SB | CO₂ is | CO₂ is | CO₂ is | 1.21 | 1.21 | 1.16 | 1.57 | — | — | 140.73 | — | — |
| | molecularly | dissociating | dissociating | | | | | | | | | |
| | adsorbed | | | | | | | | | | | |
| LB | CO₂ is | CO₂ is | CO₂ is | 1.17 | 1.25 | 1.24 | 1.53 | — | 1.37 | 134.24 | — | 117.67 |
| | molecularly | dissociating | molecularly | | | | | | | | | |
| | adsorbed | | adsorbed | | | | | | | | | |
| H | CO₂ is | CO₂ is | CO₂ is | 1.27 | 1.22 | 1.23 | 1.49 | — | 1.36 | 151.16 | — | 118.58 |
| | molecularly | dissociating | molecularly | | | | | | | | | |
| | adsorbed | | adsorbed | | | | | | | | | |

### CO₂ Adsorption on Al-Beta (0001) Surface

The following four unique sites were considered to investigate CO₂ adsorption on neutral and charged Al-beta (0001) surfaces: site T represents the top of an Al atom, site B represents the bridge between two Al atoms, site hcp representing threefold site with an atom at the bottom, site fcc representing threefold site without an atom at the bottom (refer FIG. 1(h)). At Site T, CO₂ undergoes dissociation, resulting in the formation of CO and O, regardless of the surface's charge state, whether it is neutral, positively charged, or negatively charged. The dissociation of CO₂ at site B is not detected in the presence of a neutral or negatively charged surface. However, when the surface is positively charged, CO₂ dissociates into CO and O. At site hcp, CO₂ is chemisorbed for all surface charge states, and CO₂ bends the greatest when the surface is neutral. On-site fcc CO₂ dissociates on neutral and positively charged surfaces, whereas it adsorbs molecularly on negatively charged surfaces. Table 10 presents the bond lengths of adsorbed and dissociated CO₂, as well as the bond angle (LOCO). Meanwhile, Table 12 provides information on the adsorption energies and Bader charges.

TABLE 10
Structural properties of adsorbed CO₂ on neutral, positive, and negative Al(beta) surface.

| Al | | | | | | | | | | | | |
|---|---|---|---|---|---|---|---|---|---|---|---|---|
| (beta) | Top View | | | d_{C═O1} (Å) | | | d_{C═O2} (Å) | | | ∠OCO ° | | |
| Site | S | PS | NS | S | PS | NS | S | PS | NS | S | PS | NS |
| T | CO₂ is | CO₂ is | CO₂ is | — | 1.25 | 1.44 | — | — | — | — | — | — |
| | dissociating | dissociating | dissociating | | | | | | | | | |
| B | CO₂ is | CO₂ is | CO₂ is | 1.21 | 1.20 | 1.25 | 1.49 | — | 1.52 | 129.27 | — | 136.56 |
| | molecularly | dissociating | molecularly | | | | | | | | | |
| | adsorbed | | adsorbed | | | | | | | | | |
| hcp | CO₂ is | CO₂ is | CO₂ is | 1.21 | 1.15 | 1.25 | 1.31 | 1.23 | 1.32 | 130.81 | 176.08 | 132.24 |
| | molecularly | molecularly | molecularly | | | | | | | | | |
| | adsorbed | adsorbed | adsorbed | | | | | | | | | |
| fcc | CO₂ is | CO₂ is | CO₂ is | 1.18 | 1.17 | 1.30 | — | — | 1.53 | — | — | 139.82 |
| | dissociating | dissociating | molecularly | | | | | | | | | |
| | | | adsorbed | | | | | | | | | |

### CO₂ Adsorption on Ni (111) Surface

The following four unique sites were considered to investigate CO₂ adsorption on neutral and charged Ni (111) surfaces: site T represents the top of Ni atom, site B represents the bridge between two Ni atoms, site hcp representing threefold site with an atom at the bottom, site fcc representing threefold site without an atom at the bottom (refer FIG. 1(d)). At site T, CO₂ exhibits no interaction with the nickel (Ni) surface under neutral conditions. However, when the surface has a positive charge, CO₂ undergoes monodentate adsorption, forming a single bond with the surface. Conversely, when the surface is negatively charged, CO₂ does not interact with the surface at all. At site B, CO₂ does not exhibit any interactions with the Ni surface in any of the scenarios, namely neutral, positive, and negative. For site hcp, CO₂ undergoes physisorption, forming a single bond with the neutral surface. However, it does not exhibit any interaction with negatively or positively charged surfaces. For site fcc simulation failed to converge. Table 11 presents the bond lengths of adsorbed and dissociated CO₂, as well as the bond angle (LOCO). Meanwhile, Table 12 provides information on the adsorption energies and Bader charges.

TABLE 11
Structural properties of adsorbed CO₂ on neutral, positive, and negative Ni surface.

| Ni | Top View | | | d_{C═O1} (Å) | | | d_{C═O2} (Å) | | | ∠OCO ° | | |
|---|---|---|---|---|---|---|---|---|---|---|---|---|
| Site | S | PS | NS | S | PS | NS | S | PS | NS | S | PS | NS |
| T | CO₂ is not | CO₂ is | CO₂ is not | 1.16 | 1.14 | 1.24 | 1.18 | 1.21 | 1.19 | 179.46 | 179.53 | 179.68 |
| | interacting | molecularly | interacting | | | | | | | | | |
| | | adsorbed | | | | | | | | | | |
| B | CO₂ is not | CO₂ is not | CO₂ is not | 1.18 | 1.16 | 1.16 | 1.18 | 1.25 | 1.16 | 179.78 | 179.80 | 179.55 |
| | interacting | interacting | interacting | | | | | | | | | |
| hcp | CO₂ is | CO₂ is not | CO₂ is not | 1.17 | 1.13 | 1.20 | 1.17 | 1.19 | 1.16 | 179.35 | 179.78 | 179.91 |
| | molecularly | interacting | interacting | | | | | | | | | |
| | adsorbed | | | | | | | | | | | |

### Discussion

The comprehensive DFT calculations reported in the preceding section shed light on the following key observations:

### Structure of Adsorbed CO₂ Molecule

The results from the DFT simulations reveal the state of the adsorbed CO₂, which can be categorized into three cases: Case 1) CO₂ attaches to the surface molecularly, maintaining its original chemical structure, but the C—O bond length and O—C—O bond angle are changed. In this case, there is some degree of charge transfer between the metal surface and the adsorbed CO₂ molecule, resulting in CO₂^{δ-}. Case 2) CO₂ dissociates into CO and O when it is adsorbed on the surface of the metal, indicating that the metal sites are highly active and would result in CO₂ reduction rather than molecular adsorption. Case 3) CO₂ does not attach to the surface of the metal, indicating poor performance of metal sites for CO₂ capture or CO₂ reduction reaction. The cases of molecularly adsorbed CO₂ are indicated by the symbol * in Table 12. Likewise, the cases of dissociated and non-interacting CO₂ are indicated by the symbols ^{#} and ^{§} in Table 12, respectively. For some metal surfaces, the state of the adsorbed CO₂ depends on the surface charge. For example, CO₂ dissociates on V when it is neutral or negatively charged but is molecularly adsorbed on most sites when the surface of V metal is electron deficient (positively charged). Similarly, for the Fe(gamma) surface, CO₂ is molecularly adsorbed when the surface is positively charged but dissociates on almost all of the sites when the surface is neutral or negatively charged. Notably, when considering all metal surfaces investigated, there is no strong correlation between the state of the CO₂ molecule and surface charge. For example, CO₂ tends to dissociate on Zn when it is negatively charged, whereas the opposite trend is observed for Al(alpha), where CO₂ preferentially dissociates when the surface is positively charged. For Case 1, it is worth mentioning that as the CO₂ geometry becomes more bent, the energy level of the in-plane contribution (specifically, the lowest unoccupied molecular orbital or 2πᵤ orbital) of CO₂ decreases. A significant consequence of this decrease in 2πᵤ orbital energy is that it renders the carbon atom electrophilic [43]. This can be observed from Table 13 in Example 2, which presents the Bader charge table indicating a reduction in charge on the carbon atom within adsorbed CO₂ as compared to that of the carbon atom of isolated CO₂.

### Adsorption of CO₂

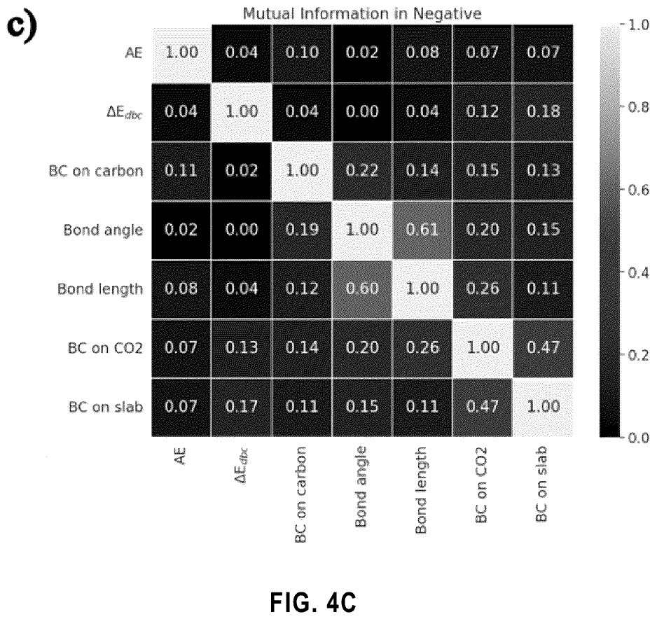

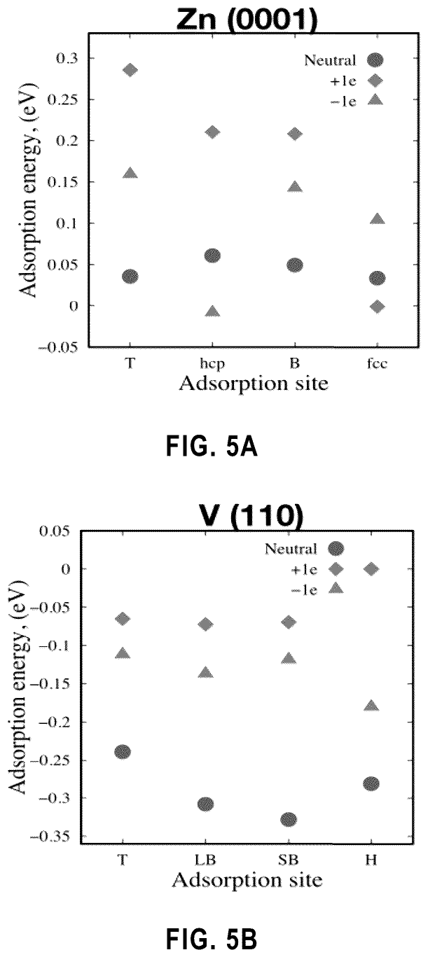

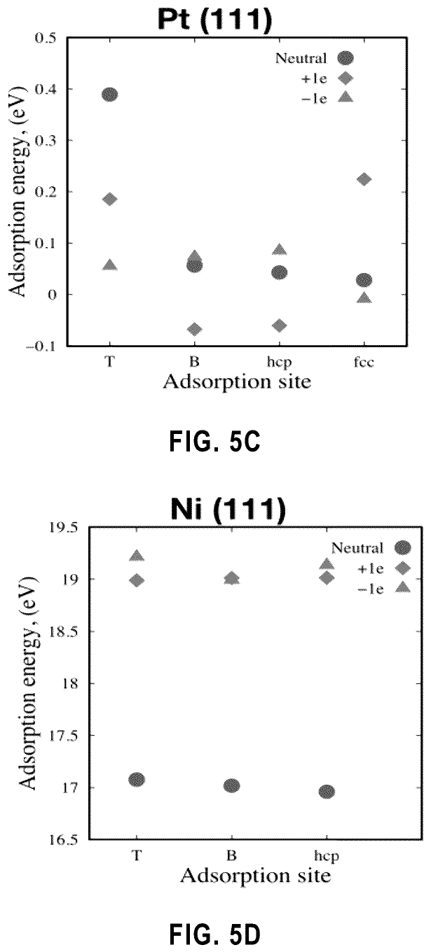

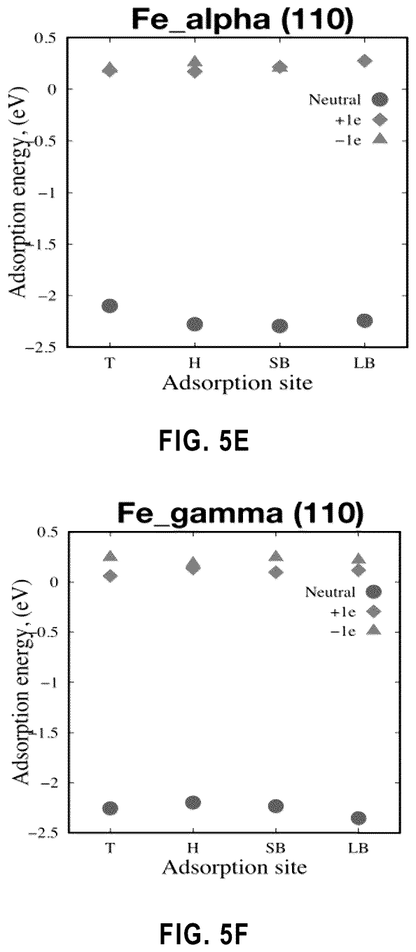

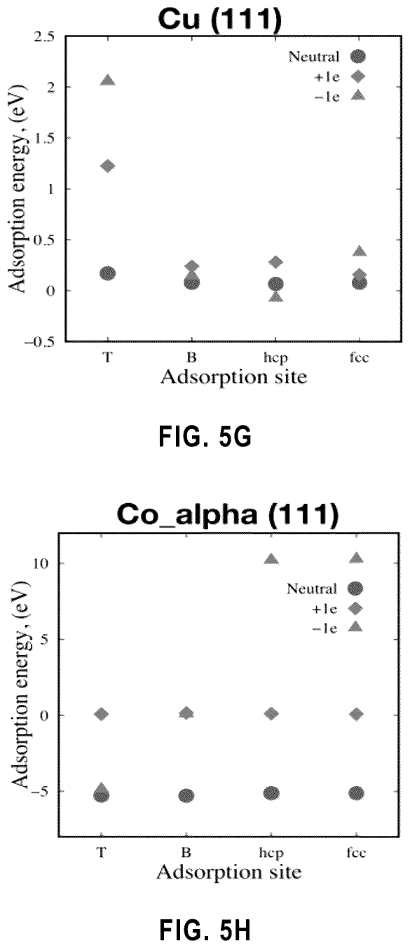

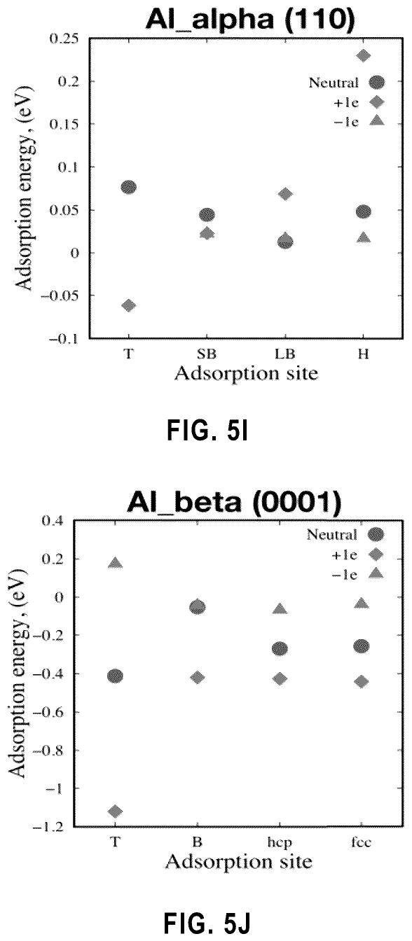

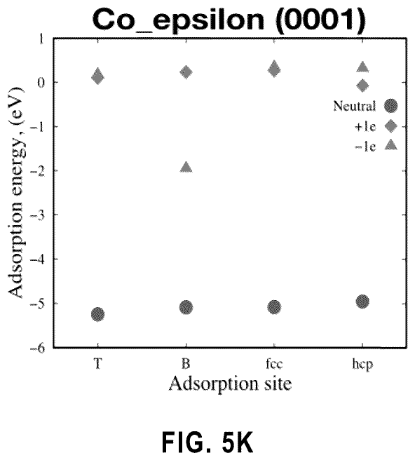

The results from the adsorption energy analysis corresponding to each metal surface are discussed in the previous section and also summarized in Example 2 (FIG. 5) and Table 12 below. These results indicate that, on most of the sites of the considered metals, the adsorption energy tends to be lower when the metal surface is neutral, whereas the adsorption energy typically increases when the surface is positively or negatively charged. This trend suggests a preference of CO₂ adsorption on neutral metal surfaces as opposed to charged ones. For example, the adsorption energies for the Fe surfaces investigated are all negative when the surface is neutral but have positive values when the Fe surface is charged either positively or negatively. However, a few metals, like Al (beta) and Al(alpha), do not follow this trend. The CO₂ adsorption is enhanced on aluminum in the presence of excess electrons, as also observed in an experimental study reported in the literature [44]. This might be due to the lack of d-electrons in Al (beta/alpha) metals. The transition metals, with broad sp-electronic states and localized d-states, exhibit differences in adsorbate-surface interaction primarily driven by variations in d-state interactions as well established in other literature [45].

Further, it was also observed that CO₂ adsorbs on some metals more favorably than on others. For example, the adsorption energies are negative for all sites on V and Al, indicating that CO₂ adsorbs on the surface of these metals, whether they are charged or neutral. On the other hand, the adsorption energies for all sites on both charged and neutral Ni surfaces have large positive values, indicating that Ni is not an active material for CO₂ adsorption.

Clearly, adsorption energy analysis shows that for some metals, the surface charge affects the CO₂ adsorption energy, whereas for others, the adsorption energy appears to be independent of the surface charge. For example, Co, Fe, V, and Zn have significantly lower binding strengths (relatively higher adsorption energy) for CO₂ in the presence of charge relative to that in the absence of charge for most of their adsorption sites. Whereas metals like Al, Pt, and Cu do not exhibit a distinct trend, that is, very few sites have lower binding strength (relatively higher adsorption energy) for CO₂ in the presence of charge relative to that in the absence of charge.

### Bader Charge of CO₂

The validity of the structural analysis outcome has also been confirmed by the Bader charge analysis. The Bader charge of an atom is the electron density localized on that atom, and it is used to understand the chemical bonding and electronic structure of a system. It can be related to the electron-donating or electron-accepting properties of the atom, thereby providing insights into how the electrons are distributed among the atoms in a system and how the chemical bonds are formed [46-48]. The net Bader charge of the CO₂ molecule and the metal slab was determined in our calculations by subtracting the Bader charge over atoms from the number of valence electrons considered in the pseudopotential. The prevailing charge transfer method on metal surfaces is thought to activate CO₂, resulting in the creation of CO₂^{δ-} and CO₂⁻ by partial and complete charge transfer, respectively. This finding is substantiated by our Bader charge analysis, which reveals that charge is transferred to CO₂, leading to the formation of CO₂^{δ-}. Based on the Bader charge on CO₂ (refer to Table 13, Example 2), it appears that negatively charged surfaces transfer the maximum amount of charge to CO₂, followed by neutral surfaces and positively charged surfaces.

### D-Band Analysis

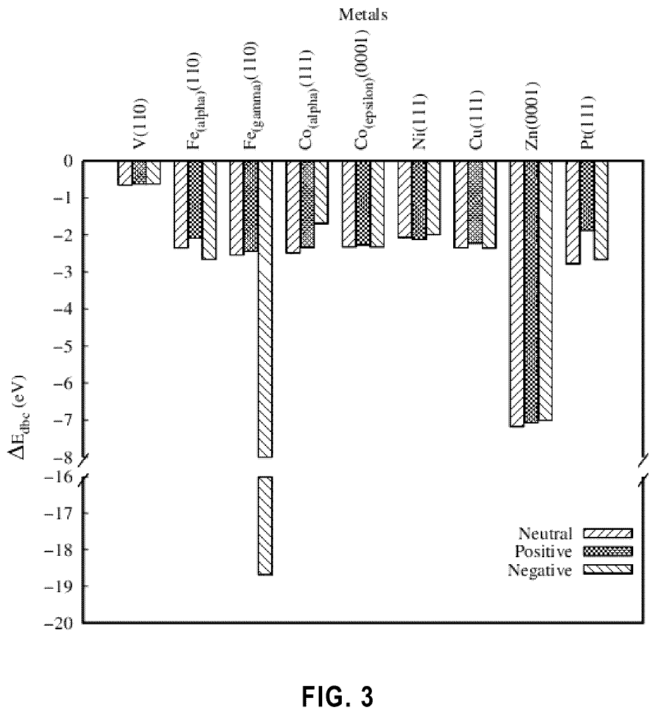

The interactions between the surface of a catalyst and CO₂ molecules play a crucial role in determining the efficiency and outcome of adsorption and desorption processes. Sabatier's principle states that an optimal balance must be struck in order to achieve the appropriate adsorption strength for CO₂ molecules on the catalyst's surface—not too strong, nor too weak [49]. As a result, several computational studies have been conducted to explore various metal catalysts and identify the ideal characteristics for highly effective CO₂ adsorption and subsequent desorption. To ensure efficient adsorption or desorption of reactants, intermediates, and products on catalysts, it is crucial to regulate the adsorption affinity of metal-based catalysts. One way to speculate this affinity is by calculating the d-band center value (d_{bc}). Specifically, a smaller absolute shift of d-band with respect to Fermi energy (ΔE_{dbc}=d_{bc}−Fₑ, ‘Fₑ’ being the Fermi energy), indicating an upward movement relative to the Fermi energy, suggests less stabilized d-band center energy, and an increased bond strength resulting in a lesser occupancy of antibonding orbitals of the reactants and the catalyst surface [50, 51]. Based on the data of ΔE_{dbc} in FIG. 3, it can be observed that V has the lowest ΔE_{dbc}, suggesting its high reactivity towards CO₂ molecules compared to other metals. The information presented in Table 12 further supports this observation, indicating that V (neutral and negative surface) effectively dissociates CO₂ in most scenarios. On the other hand, Ni, despite its low ΔE_{dbc}, does not interact with CO₂ at all, as also reported in a previous study [52]. However, this is not reflected by the d-band analysis. If we consider other metals like Fe(alpha) (neutral and positive surface), Fe(gamma) (neutral surface), Co(epsilon) (neutral surface), and Al(alpha) (positive surface), it can be seen that they dissociate CO₂ on all the sites which are not reflected by their respective d-band analysis.

### Mutual Information (MI)

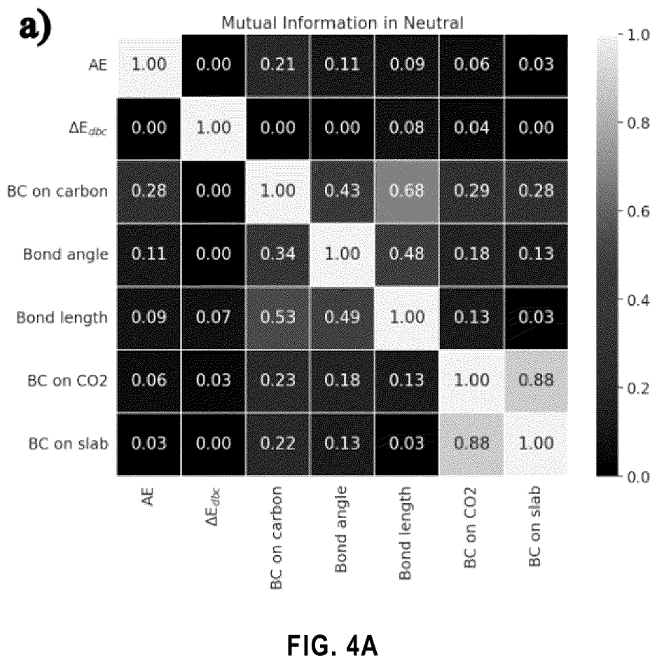

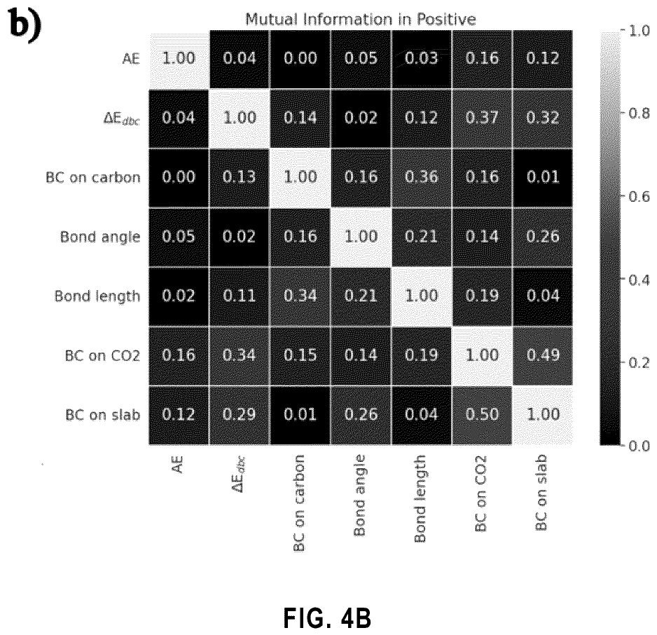

To assess the degree of dependence between different factors such as d-band center with respect to Fermi energy, Bader charge, the adsorption energy of CO₂, and others, we employed mutual information (MI) from probability and information theory. MI is zero when two random variables are independent, while higher values indicate a stronger dependency. MI relies on non-parametric methods based on entropy estimation from k-nearest neighbor distances [53,54] (refer to Example 2). FIGS. 4(a), 4(b), and 4(c) demonstrate the MI values for neutral, positive, and negatively charged surfaces, respectively.

Some of the notable dependencies are
(i) adsorption energy of CO₂ molecule is correlated with both the Bader charge of carbon and the bond angle of CO₂ (LOCO) when the surface is neutral;
(ii) dependency between the average bond length of CO₂ molecule and Bader charge on the carbon atom of CO₂ molecule is maximum for the neutral surface, followed by positively charged surface and minimum for the negatively charged surface;
(iii) dependency between the Bader charge on the carbon atom of CO₂ molecule and bond angle of CO₂ molecule is maximum for neutral surface and minimum for the positively charged surface;
(iv) the dependency between the d-band center and the Bader charge of the CO₂ molecule is maximum for the positively charges surface, followed by the negatively charged surface, and negligible for the neutral surface;
(v) the dependency between average CO₂ bond length and O—C—O bond angle is maximum for the negatively charged surface, followed by for neutral surface and minimum for the positively charged surface,
(vi) the dependency of the adsorption energy of CO₂ molecule, and the Bader charge of the complete CO₂ molecule is only seen for the positively charged surface.

### Perspective

We conducted adsorption energy analysis for CO₂, with a specific focus on molecular adsorption of CO₂ (indicated with the symbol * in Table 12). Sites where CO₂ dissociates (indicated by the symbol ^{#} in Table 12), were intentionally ignored as our main interest lies in examining the adsorption and desorption of molecular CO₂. It should be emphasized that an effective adsorbent should not only exhibit strong adsorption capabilities but must also facilitate easy desorption of CO₂. Consequently, metals with strong adsorption capabilities but weak desorption abilities are also not suitable for efficient CO₂ capture. In other words, a metal surface can be considered good for CO₂ capture if it shows “photoswitch” behavior i.e. adsorb as well as desorb CO₂, in response to varying conditions, leading to the generation of different surface charges. Therefore, an ideal metal surface for capturing CO₂ must exhibit lower adsorption energies (indicating good potential for CO₂ uptake/adsorption) as well as higher adsorption energies (suggesting better suitability for CO₂ release/desorption) when their surface charges are altered between neutral, positive, and negative. Consequently, we find that Fe(alpha), V, and Ni have low competence as Fe(alpha) and V predominantly cause CO₂ dissociation at most of their sites, whereas Ni does not interact with CO₂ at all.

Furthermore, CO₂ adsorption is possible on neutral (Pt, Co(alpha), and Al(beta)) surfaces, with Pt being the most active for CO₂ adsorption in the neutral state, as expected. On the other hand, metals like Cu and Al(alpha) display effective adsorption of CO₂ in an electron-rich state; in contrast, metals like Co(epsilon) and Fe(gamma) become active for CO₂ adsorption in an electron-deficient state. It should be noted that a negatively charged Cu surface is even more active than Pt for CO₂ adsorption. When it comes to CO₂ desorption, Cu, Zn, and Al(alpha) are more successful when they are in an electron-deficient state, whereas all other surfaces can desorb CO₂ in an electron-rich state. Conclusively, the metals that give us decent adsorption as well as desorption efficiency include Cu (100% adsorption in electron-rich conditions and 50% desorption in electron-deficient conditions), Zn (75% adsorption and desorption in neutral and electron-deficient conditions, respectively), Co(alpha) and Al(beta) (50% adsorption and desorption efficiency in neutral and electron-rich conditions, respectively).

One can anticipate that the effective manipulation of surface charge can further enhance the adsorption and desorption capabilities of these metals, leading to innovative advancements in CO₂ capture technologies. Additionally, exploring the use of different alloys formed from the combination of Cu—Zn—Co—Al could be a potential avenue to investigate for improved energy-efficient CO₂ capture.

The numerical simulations in this study investigate the adsorption of CO₂ at metal surfaces in the absence of other molecules. These conditions are representative of solid sorbents (when neglecting the presence of additional gaseous molecules). Notably, the concept of using light to alter the adsorption properties of a surface can also be extended to capturing carbon in liquid media. The proposed approach and results from this study could be extended to designing plasmonic and non-plasmonic nanofluids for carbon capture. Integrating nanoparticles into the nanofluid composition, where the properties of these nanoparticles can be altered in response to specific wavelengths of light, could lead to more energy-efficient CCS systems. The integration may enable the modulation of the charge at the nanoparticle-liquid/electrolyte interface, encompassing changes in surface charge, electronic states, or other photoinduced effects. The ability to tune the properties of nanoparticles through light exposure offers a dynamic control over nanofluid behavior. Further, the localized surface plasmon resonance (LSPR) effect can be induced by aligning the incident light frequency with the electron oscillation frequency in plasmonic materials [55, 56].

Nanofluids with a high transmittance may overcome the drawbacks of traditional solvent-based capture materials and represent a promising avenue for enhancing the efficiency of the CO₂ capture process. Nanofluids, which contain nanoparticles suspended in a liquid base, significantly boost the surface area when compared to bulk materials. This increased surface area enables greater contact with CO₂, resulting in enhanced absorption efficiency—an important factor for CCS. Beyond absorption, nanofluids can also provide improved heat transfer properties [57-59], making them valuable for managing temperature variations during various CCS steps. Additionally, the nanoparticles in nanofluids can be customized in terms of size, shape, and surface chemistry to enhance absorption and desorption rates. Consequently, the application of nanofluids in CCS offers the possibility of process intensification, which could result in more streamlined and effective systems, lower capital expenses, and enhanced operational efficiency. Current research is concentrating on overcoming obstacles like nanoparticle stability, cost efficiency, and scalability of nanofluid based CCS technology for feasible integration into large-scale CCS operations [60-62].

TABLE 12
Adsorption energies of CO₂ molecule on neutral,
positive, and negative surfaces.

| Metal | Adsorption Energy (eV) | | |
|---|---|---|---|
| Surface Charge | Neutral | Positive | Negative |

Cu

| | | | |
|---|---|---|---|
| Site T | 0.17 ^{#} | 1.23 * | 2.06 * |
| Site B | 0.08 * | 0.24 ^{#} | 0.14 * |
| Site hcp | 0.07 * | 0.28 * | −0.07 * |
| Site fcc | 0.08 * | 0.16 ^{#} | 0.38 * |

Zn

| | | | |
|---|---|---|---|
| Site T | 0.04 ^{§} | 0.29 * | 0.16 ^{#} |
| Site hcp | 0.06 * | 0.21 * | −0.01 ^{§} |
| Site B | 0.05 * | 0.21 * | 0.14 ^{#} |
| Site fcc | 0.03 * | 0.00 * | 0.10 ^{#} |

Pt

| | | | |
|---|---|---|---|
| Site T | 0.39 ^{#} | 0.19 ^{#} | 0.06 ^{§} |
| Site B | 0.06 * | −0.07 ^{§} | 0.07 ^{§} |
| Site hcp | 0.04 * | −0.06 ^{§} | 0.09 ^{§} |
| Site fcc | 0.03 * | 0.23 ^{#} | −0.01 * |

V

| | | | |
|---|---|---|---|
| Site T | −0.24 ^{#} | −0.07 * | −0.11 ^{#} |
| Site LB | −0.31 ^{#} | −0.07 * | −0.14 ^{#} |
| Site SB | −0.33 ^{#} | −0.07 * | −0.12 ^{#} |
| Site H | −0.28 ^{#} | ~0 ^{#} | −0.18 ^{#} |

Fe(alpha)

| | | | |
|---|---|---|---|
| Site T | −2.10 ^{#} | 0.18 ^{#} | 0.20 ^{§} |
| Site H | −2.28 ^{#} | 0.17 ^{#} | 0.26 ^{§} |
| Site SB | −2.30 ^{#} | 0.22 ^{#} | 0.21 * |
| Site LB | −2.24 ^{#} | 0.28 ^{#} | 0.24 * |

Fe(gamma)

| | | | |
|---|---|---|---|
| Site T | −2.26 ^{#} | 0.06 * | 0.24 ^{#} |
| Site H | −2.20 ^{#} | 0.14 * | 0.18 ^{#} |
| Site SB | −2.24 ^{#} | 0.10 * | 0.24 * |
| Site LB | −2.36 ^{#} | 0.12 * | 0.22 ^{#} |

Co(alpha)

| | | | |
|---|---|---|---|
| Site T | −5.29 ^{#} | 0.09 ^{#} | −4.86 * |
| Site B | −5.29 * | 0.16 ^{#} | 0.11 ^{#} |
| Site hcp | −5.13 ^{#} | 0.13 * | 10.20 ^{#} |
| Site fcc | −5.13 * | 0.09 * | 10.27 * |

Co(epsilon)

| | | | |
|---|---|---|---|
| Site T | −5.25 ^{#} | 0.10 ^{#} | 0.17 ^{§} |
| Site B | −5.09 ^{#} | 0.23 * | −1.95 * |
| Site fcc | −5.08 ^{#} | 0.27 * | 0.34 ^{§} |
| Site hcp | −4.96 ^{#} | −0.07 * | 0.32 * |

Al(alpha)

| | | | |
|---|---|---|---|
| Site T | 0.08 ^{#} | −0.06 ^{#} | |
| Site SB | 0.04 * | 0.02 ^{#} | 0.02 ^{#} |
| Site LB | 0.01 * | 0.07 ^{#} | 0.02 * |
| Site H | 0.05 * | 0.23 ^{#} | 0.02 * |

Al(beta)

| | | | |
|---|---|---|---|
| Site T | −0.41 ^{#} | −1.12 ^{#} | 0.17 ^{#} |
| Site B | −0.05 * | −0.42 ^{#} | −0.04 * |
| Site hcp | −0.27 * | −0.43 * | −0.07 * |
| Site fcc | −0.26 ^{#} | −0.44 ^{#} | −0.04 * |

Ni

| | | | |
|---|---|---|---|
| Site T | 17.08 ^{§} | 18.99 * | 19.21 ^{§} |
| Site B | 17.02 ^{§} | 19.01 ^{§} | 18.99 ^{§} |
| Site hcp | 16.96 * | 19.01 ^{§} | 19.13 ^{§} |

The symbol * indicates CO₂ is molecularly adsorbed, the symbol ^{§} indicates CO₂ is not interacting, and the symbol ^{#} indicates CO₂ is dissociating on the metal surfaces.

### Conclusion of Example 1

The adsorption and activation of CO₂ molecules on neutral, positively charged, and negatively charged metal surfaces were examined using DFT calculations. Without any additional charge on the metal surface (neutral conditions), metals such as Fe and V displayed high reactivity towards CO₂ due to their unique atomic orbital occupancy. Specifically, Fe tends to lose one electron to achieve a 3d⁵ electron configuration, while V prefers a 3d² configuration. The reactivity towards CO₂ in neutral conditions can be ranked as follows: Fe (alpha, gamma)>V>Co (epsilon, alpha)>Pt>Al (beta, alpha)>Zn>Cu>Ni. However, this order is altered when there is an excess electron or hole present on their surface.

To investigate CO₂ adsorption on neutral and charged metal surfaces, we analyzed various parameters such as the adsorption energy of CO₂, the d-band center of pristine metal surfaces, the Bader charge of carbon and CO₂ after adsorption, bond angle analysis for OCO in adsorbed CO₂, and C═O bond length of adsorbed CO₂. In order to identify a relationship between these variables, we utilized MI from probability and information theory. It was found that the d-band center is an insufficient descriptor for CO₂ adsorption or dissociation on the metal surfaces under consideration in this work. This is also supported by the MI heatmap, which demonstrated a lack of correlation/dependency between the d-band and adsorption energy (AE). However, it should be acknowledged that charged surfaces show slight dependencies between the d-band center and factors such as bond length and Bader charges of CO₂. Additionally, for neutral surfaces, only the charge of the C atom might have a significant impact on bond length, bond angle, and AE.

These findings have important implications for future experimental studies aiming to control CO₂ molecule interaction with the metal surfaces under various conditions, such as the presence of sunlight that results in surface charges.

### Example 2—Supporting Information for Example 1

### Mutual Information (MI)

Mathematically, MI is defined as:

$$I ( X ; Y ) = {D}_{KL} ( {P}_{( X , Y )} \vert \vert {P}_{X} ⊗ {P}_{Y} )$$

wherein (X, Y) be a pair of random variables with values over the space x×y. P_{(X,Y)} is their joint distribution, and P_{X} & P_{Y} are marginal distribution. D_{KL} is the Kullback-Leibler divergence, P_{X}⊗P_{Y} is the outer product distribution which assigns probability P_{X}(x). P_{Y}(y) to each (x,y).

TABLE 13
Bader charges on each atom of CO₂ in the charged
and uncharged condition of metal surfaces.

| | | | BC in | BC in | BC in |
|---|---|---|---|---|---|
| | | | neutral | positive | negative |
| Zn | Site T | C | 4 | 1.5336 | 1.7099 |
| | | O | −2.0744 | −0.4353 | −1.0667 |
| | | O | −2.0346 | −1.4378 | −2.5996 |
| | | CO₂ | −0.109 | −0.3395 | −1.9564 |
| | Site hcp | C | 2.5279 | 1.5461 | 3.114 |
| | | O | −1.4573 | −0.4489 | −2.0788 |
| | | O | −1.9121 | −1.441 | −2.0657 |
| | | CO₂ | −0.8415 | −0.3438 | −1.0305 |
| | Site B | C | 4 | 1.5318 | 1.7099 |
| | | O | −2.5481 | 0.4478 | −1.0667 |
| | | O | −2.0396 | −1.423 | −2.5996 |
| | | CO₂ | −0.5877 | −0.339 | −1.9564 |
| | Site fcc | C | 4 | 2.4104 | 1.7947 |
| | | O | −2.7042 | −1.0211 | −1.1367 |
| | | O | −1.9618 | −1.7979 | −2.7049 |
| | | CO₂ | −0.666 | −0.4086 | −2.0469 |
| V | Site T | C | 1.4079 | 2.0232 | 1.4621 |
| | | O | −0.9394 | −1.6142 | −1.2914 |
| | | O | −1.8617 | −1.5158 | −2.6065 |
| | | CO₂ | −1.3932 | −1.1068 | −2.4358 |
| | Site2 LB | C | 1.5388 | 2.058 | 1.5706 |
| | | O | −1.0735 | −1.6221 | −1.2573 |
| | | O | −1.8465 | −1.5406 | −2.6198 |
| | | CO₂ | −1.3812 | −1.1047 | −2.3065 |
| | Site SB | C | 1.4366 | 2.0184 | 1.7186 |
| | | O | −1.1213 | −1.5916 | −1.1066 |
| | | O | −1.8791 | −1.5354 | −2.5828 |
| | | CO₂ | −1.5638 | −1.1086 | −1.9708 |
| | Site H | C | 1.4526 | 1.1336 | 1.4744 |
| | | O | −1.1254 | −1.7861 | −1.2768 |
| | | O | −1.8629 | −0.5964 | −2.587 |
| | | CO₂ | −1.5357 | −1.2489 | −2.3894 |
| Pt | Site T | C | 1.8183 | 0.6671 | 4 |
| | | O | −1.7679 | −0.8571 | −2.4154 |
| | | O | −0.0896 | 0.2287 | −2.5229 |
| | | CO₂ | −0.0392 | 0.0387 | −0.9383 |
| | Site B | C | 2.1996 | 4 | 4 |
| | | O | −0.7545 | −1.9188 | −2.2787 |
| | | O | −1.9528 | −1.9384 | −2.6049 |
| | | CO₂ | −0.5077 | 0.1428 | −0.8836 |
| | Site hcp | C | 4 | 4 | 4 |
| | | O | −2.5088 | −1.9323 | −2.4154 |
| | | O | −1.9814 | −1.9275 | −2.5229 |
| | | CO₂ | −0.4902 | 0.1402 | −0.9383 |
| | Site fcc | C | 4 | −0.1224 | 2.9436 |
| | | O | −2.4988 | −0.0999 | −1.6733 |
| | | O | −1.9047 | 0.2594 | −2.3994 |
| | | CO₂ | −0.4035 | 0.0371 | −1.1291 |
| Cu | Site T | C | 1.7227 | 2.4149 | 1.7057 |
| | | O | −0.8415 | −1.5141 | −0.8627 |
| | | O | −1.8767 | −1.8123 | −1.8114 |
| | | CO₂ | −0.9955 | −0.9115 | −0.9684 |
| | Site B | C | 2.7607 | 1.4925 | 2.1481 |
| | | O | −1.5974 | −1.0129 | −0.9226 |
| | | O | −1.9416 | −1.9201 | −1.9474 |
| | | CO₂ | −0.7783 | −1.4405 | −0.7219 |
| | Site hcp | C | 4 | 2.1454 | 4 |
| | | O | −2.3821 | −1.6626 | −2.4587 |
| | | O | −2.1037 | −1.6727 | −2.0853 |
| | | CO₂ | −0.4858 | −1.1899 | −0.544 |
| | Site fcc | C | 2.7726 | 1.4679 | 1.8392 |
| | | O | −1.6183 | −1.0191 | −0.7884 |
| | | O | −1.9591 | −1.9269 | −1.945 |
| | | CO₂ | −0.8048 | −1.4781 | −0.8942 |
| Fe_alpha | Site T | C | 1.715 | 1.8435 | 4 |
| | | O | −0.976 | −0.9294 | −2.0571 |
| | | O | −1.8187 | −1.7678 | −2.7057 |
| | | CO₂ | −1.0797 | −0.8537 | −0.7628 |
| | Site H | C | 1.8747 | 1.8246 | 3.9999 |
| | | O | −0.9444 | −0.9126 | −2.0818 |
| | | O | −1.8679 | −1.7397 | −2.7354 |
| | | CO₂ | −0.9376 | −0.8277 | −0.8173 |
| | Site SB | C | 1.8005 | 1.8491 | 3.9999 |
| | | O | −0.8835 | −0.9208 | −2.0989 |
| | | O | −1.8172 | −1.7698 | −2.7559 |
| | | CO₂ | −0.9002 | −0.8415 | −0.8549 |
| | Site LB | C | 1.7187 | 1.8541 | 4 |
| | | O | −1.0182 | −0.9214 | −2.051 |
| | | O | −1.8008 | −1.7696 | −2.8116 |
| | | CO₂ | −1.1003 | −0.8369 | −0.8626 |
| Fe_gamma | Site T | C | 1.6802 | 2.9603 | 1.6831 |
| | | O | −1.0592 | −1.7392 | −0.82 |
| | | O | −1.8471 | −1.8652 | −2.2799 |
| | | CO₂ | −1.2261 | −0.6441 | −1.4168 |
| | Site H | C | 1.8689 | 2.9189 | 1.4514 |
| | | O | −0.9531 | −1.6355 | −0.9679 |
| | | O | −1.8914 | −1.8862 | −2.1849 |
| | | CO₂ | −0.9756 | −0.6028 | −1.7014 |
| | Site SB | C | 1.7733 | 2.9603 | 3.9986 |
| | | O | −0.8925 | −1.7392 | −2.0889 |
| | | O | −1.8087 | −1.8652 | −2.7289 |
| | | CO₂ | −0.9279 | −0.6441 | −0.8192 |
| | Site LB | C | 1.7244 | 2.1765 | 1.7291 |
| | | O | −1.0211 | −0.9454 | −0.8517 |
| | | O | −1.798 | −1.7835 | −2.4014 |
| | | CO₂ | −1.0947 | −0.5524 | −1.524 |
| Co_alpha | Site T | C | 1.6995 | 1.7358 | 4 |
| | | O | −0.8231 | −0.6798 | −2.348 |
| | | O | −1.8729 | −1.7546 | −3.068 |
| | | CO₂ | −0.9965 | −0.6986 | −1.416 |
| | Site B | C | 1.8406 | 1.727 | 1.6943 |
| | | O | −0.8245 | −0.6571 | −0.8821 |
| | | O | −1.8613 | −1.7523 | −2.2399 |
| | | CO₂ | −0.8452 | 0.6824 | −1.4277 |
| | Site hcp | C | 1.6879 | 4 | 1.6551 |
| | | O | −0.6423 | −2.5178 | −0.953 |
| | | O | −1.9084 | −1.7725 | −2.2588 |
| | | CO₂ | −0.8628 | −0.2903 | −1.5567 |
| | Site fcc | C | 1.6995 | 2.1355 | 1.9672 |
| | | O | −0.8231 | −0.7945 | −0.8552 |
| | | O | −1.8729 | −1.7961 | −2.5144 |
| | | CO₂ | −0.9965 | −0.4551 | −1.4024 |
| Co_epsilon | Site T | C | 1.7865 | 1.9796 | 3.9982 |
| | | O | −0.827 | −0.782 | −2.08 |
| | | O | −1.888 | −1.7372 | −2.7676 |
| | | CO₂ | −0.9285 | −0.5396 | −0.8494 |
| | Site B | C | 1.7159 | 2.4885 | 2.7094 |
| | | O | −0.8398 | −1.0019 | −1.5632 |
| | | O | −1.8707 | −1.6929 | −2.5351 |
| | | CO₂ | −0.9946 | −0.2063 | −1.3889 |
| | Site fcc | C | 1.7005 | 4 | 3.4747 |
| | | O | −0.8552 | −2.4799 | −2.1482 |
| | | O | −1.8657 | −1.7742 | −2.7121 |
| | | CO₂ | −1.0204 | −0.2541 | −1.3856 |
| | Site hcp | C | 1.7672 | 4 | 2.9777 |
| | | O | −0.6319 | −2.0749 | −1.7108 |
| | | O | −1.9467 | −1.8936 | −2.6454 |
| | | CO₂ | −0.8114 | 0.0315 | −1.3785 |
| Al_alpha | Site T | C | 1.4229 | 0.5597 | |
| | | O | −1.3031 | −2.1963 | |
| | | O | −1.8919 | −1.8929 | |
| | | CO₂ | −1.7721 | −3.5295 | |
| | Site SB | C | 2.2689 | 0.6871 | 1.4049 |
| | | O | −1.831 | −2.1064 | −1.8881 |
| | | O | −1.8627 | −2.4076 | −2.4187 |
| | | CO₂ | −1.4248 | −3.8269 | −2.9019 |
| | Site LB | C | 2.0152 | −1.5244 | 1.7066 |
| | | O | −1.9613 | −2.1637 | −1.8962 |
| | | O | −1.8974 | −2.0919 | −2.3942 |
| | | CO₂ | −1.8435 | −5.78 | −2.5838 |
| | Site H | C | 4 | −0.2562 | 1.7504 |
| | | O | −3.317 | −2.1647 | −1.9196 |
| | | O | −1.9476 | −2.0383 | −2.3879 |
| | | CO₂ | −1.2646 | −4.4592 | −2.5571 |
| Al_beta | Site T | C | −3.8788 | −1.1817 | −1.8659 |
| | | O | −2.0788 | −1.9952 | −1.0973 |
| | | O | −2.5915 | −2.0411 | −1.2899 |
| | | CO₂ | −8.5491 | −5.218 | −4.2531 |
| | Site B | C | 1.1507 | 1.8631 | 0.461 |
| | | O | −1.3121 | −1.9994 | −1.3702 |
| | | O | −1.9342 | −1.9363 | −2.6809 |
| | | CO₂ | −2.0956 | −2.0726 | −3.5901 |
| | Site hcp | C | 2.4574 | 3.9999 | 1.3825 |
| | | O | −2.2258 | −2.2033 | −1.9784 |
| | | O | −1.9519 | −1.934 | −2.6111 |
| | | CO₂ | −1.7203 | −0.1374 | −3.207 |
| | Site fcc | C | 1.322 | 1.8766 | −0.239 |
| | | O | −1.4614 | −2.4762 | −1.5283 |
| | | O | −1.9277 | −1.8688 | −2.701 |
| | | CO₂ | −2.0671 | −2.4684 | −4.4683 |
| Ni | Site T | C | 4 | 4 | 4 |
| | | O | −2.0914 | −2.0379 | −2.058 |
| | | O | −2.0072 | −1.8454 | −2.7314 |
| | | CO₂ | −0.0986 | 0.1167 | −0.7894 |
| | Site B | C | 4 | 4 | 4 |
| | | O | −2.0641 | −1.9957 | −2.1019 |
| | | O | −1.9787 | −1.9067 | −2.6967 |
| | | CO₂ | −0.0428 | 0.0976 | −0.7986 |
| | Site hcp | C | 4 | 4 | 4 |
| | | O | −2.0566 | −2.0949 | −2.1159 |
| | | O | −2.0189 | −1.8226 | −2.7174 |
| | | CO2 | −0.0755 | 0.0825 | −0.8333 |

### Example 3—Using Alloys Surfaces

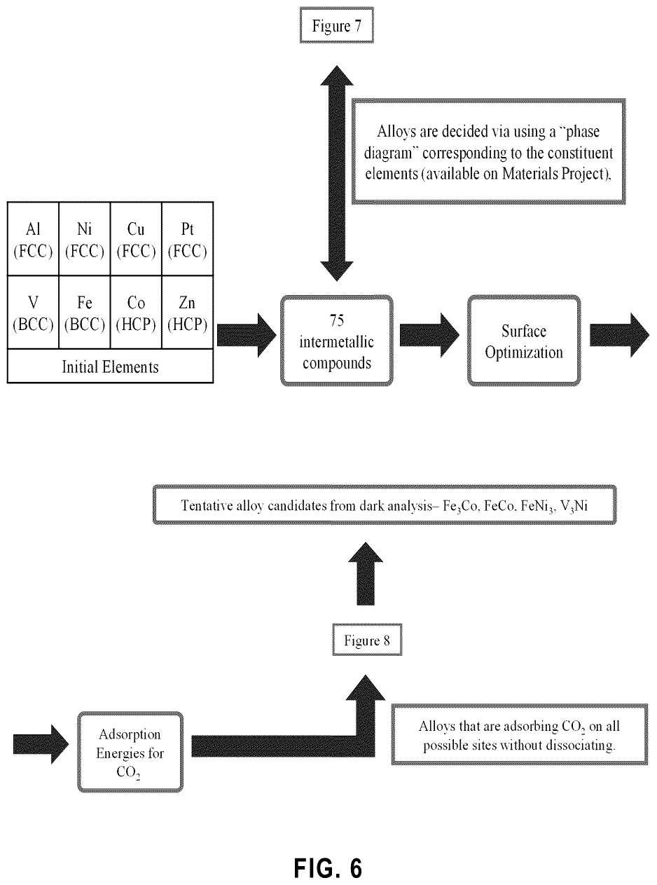

A systematic approach, shown in FIG. 6, was used for identifying promising binary alloy compositions for efficient CO₂ adsorption under dark conditions. The investigation commenced by considering all possible binary combinations of eight pure metals: Al (FCC), Ni (FCC), Cu (FCC), Pt (FCC), V (BCC), Fe (BCC), Co (HCP), and Zn (HCP).

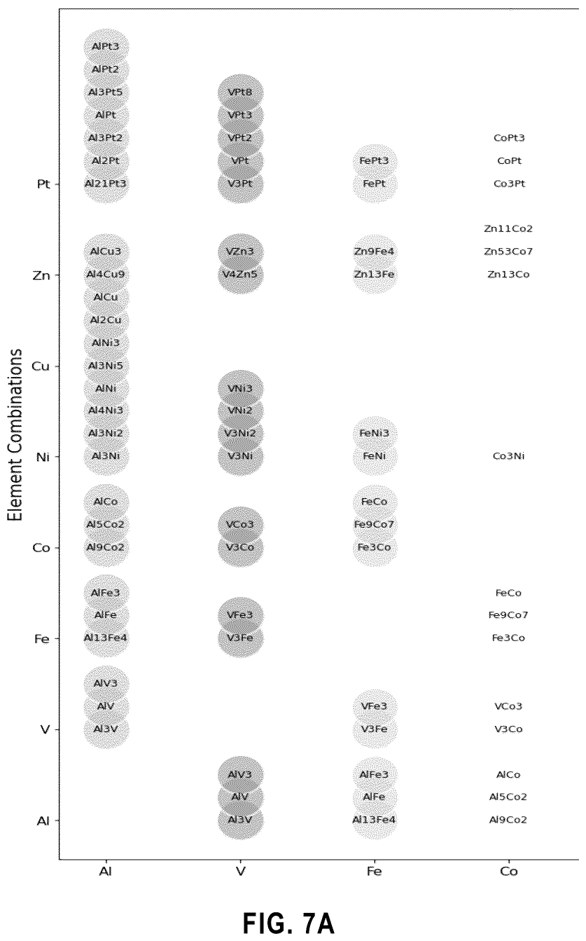

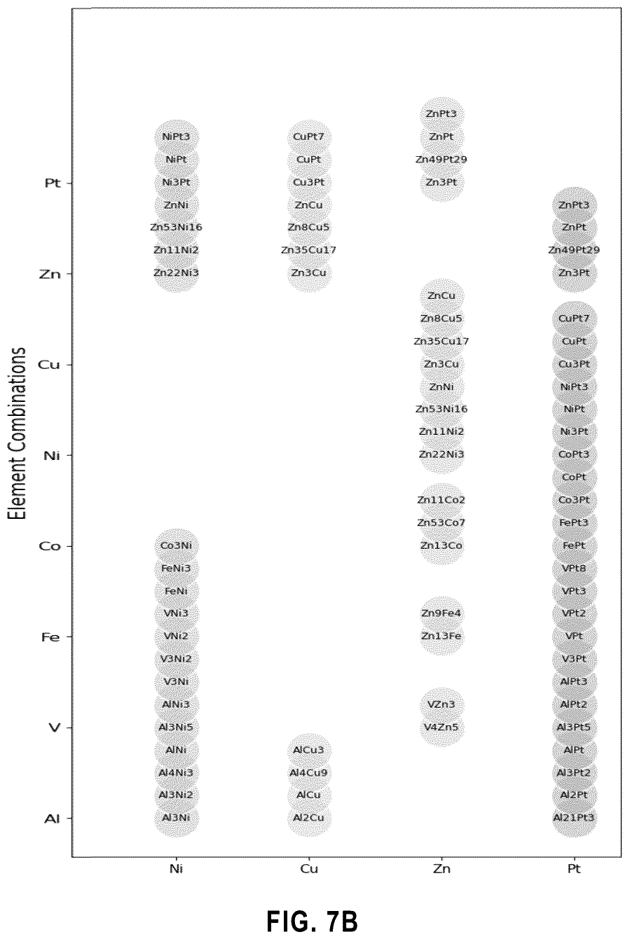

Thermodynamic screening, based on the “energy above hull” criterion (which identifies stable alloys with zero energy above hull), narrowed the selection to 75 intermetallic alloys, which were visualized in a detailed diagram (FIG. 7).

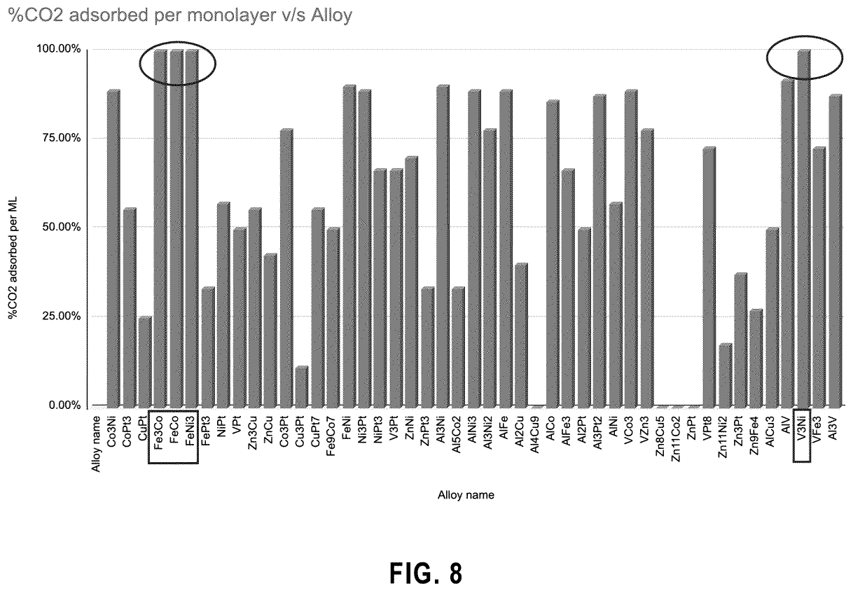

These alloy compositions were then subjected to surface optimization and subsequent evaluations of their CO₂ adsorption energies across various adsorption sites. The findings are presented in a bar graph (FIG. 8) depicting the “% CO₂ adsorbed per monolayer (ML)” for the different alloys. Alloys that demonstrated 100% CO₂ adsorption without dissociation, indicating optimal binding strength across all adsorption sites, were further shortlisted for surface charge analysis to explore their photodesorption potential.

The final selection identified four promising alloys: Fe₃Co, FeCO, FeNi₃, and V₃Ni.

### Example 4—Using a Potential Difference

Theoretical analysis revealed that voltage and surface charges can be used to capture CO₂ (adsorption and desorption) using Cu.

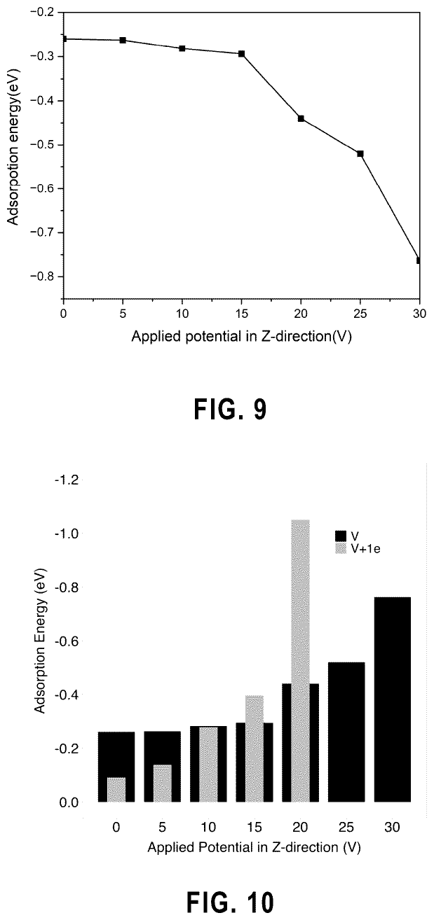

The adsorption behavior of CO₂ on the Cu(111) surface was studied under different conditions using the Dipole Sheet Method. The findings indicate that increasing the applied voltage from 0 V to 30 V makes the surface more active and favors CO₂ shifts from a weakly bound physiosorbed state to a strongly bound chemisorbed state, leading to a noticeable change in molecular geometry, including C—O bond elongation and a decrease in O—C—O bond angles at 25V. This transition highlights the key role of the electric field in facilitating chemisorption. FIG. 9 shows the adsorption energy of CO₂ on the Cu(111) surface as a function of the applied voltage (V) between dipole sheets. The plot demonstrates that increasing the potential from 0 V to 30 V improves CO₂ adsorption on the Cu surface, shifting from physisorption to chemisorption.

Further investigation into the effects of applied voltage and excess electrons demonstrates that the electrons alone have minimal impact, as they get evenly distributed on the top and bottom layer of Cu(111), however, their interaction with the electric field greatly improves CO₂ chemisorption. FIG. 10 shows the adsorption energy of CO₂ on the surface of Cu(111) implementing the combined effects of applied voltage and excess electrons. The results show that excess electrons alone have little impact on CO₂ adsorption; however, the synergistic effect of electrons and potential significantly enhances adsorption strength, facilitating improved chemisorption of CO₂.

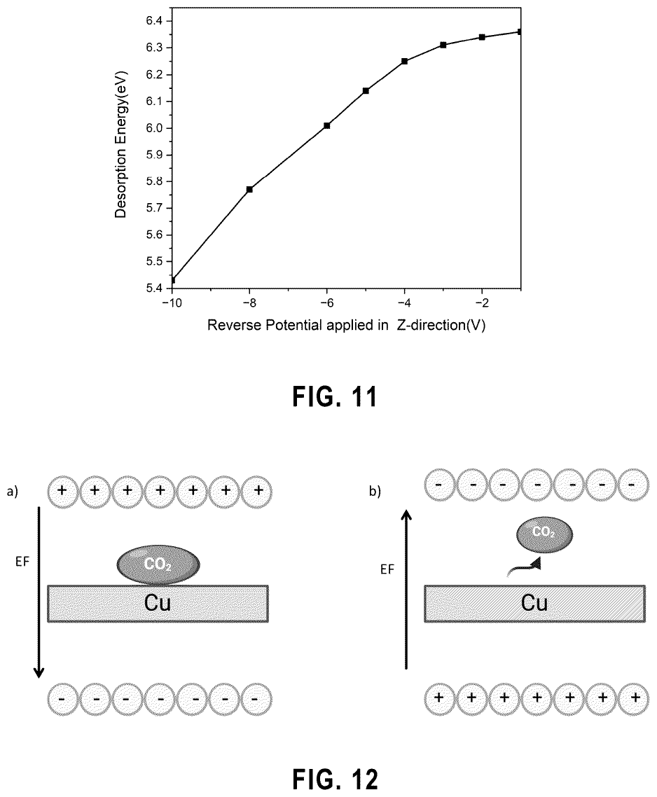

Additionally, under reverse potentials between −1 V to −10 V, the chemisorbed CO₂ molecule obtained at 30V, exhibiting a bond angle of 139.72°, experiences a significant transformation, aligning into a linear physisorbed geometry with a bond angle of 179.76°. This geometric transformation shows the desorption of CO₂ from the surface, completing the adsorption-desorption cycle. The desorbed energy of the CO₂ was calculated by using the equation ΔD=Desorbed state energy−Adsorbed state energy (eV). The desorption energy plot of CO₂ under reverse potential ranging from −1V to −10V is shown in FIG. 11.

Collectively, these findings emphasize the vital role of the electric field and excess electrons in enhancing CO₂ capture on Cu(111), offering promising directions for voltage-driven carbon capture technologies.

### Example 5—Electric Field-Controlled Pathway to Capture CO₂ Using Earth-Abundant Metals

### Abstract of Example 5

This Example explores a novel strategy that leverages external electric fields (EFs) and surface charges to modulate CO₂ adsorption and desorption on low-cost, earth-abundant metal surfaces with varying d-orbital occupancies. Using Density Functional Theory (DFT), we systematically investigated Cu (111), Fe (110) and Zn (0001) surfaces, representing moderate, high, and inert reactivity, respectively.

Without external stimuli, Fe (110) intrinsically chemisorbs CO₂, while Cu (111) and Zn (0001) surfaces exhibit only weak physisorption. Upon application of EF and excess surface charge, all three surfaces show enhanced CO₂ activation, with the effect being most pronounced on the Cu (111). Application of EF leads to a transition from physisorption to chemisorption, accompanied by significant molecular activation. Reversing the field with a modest potential (~−2 V) enables efficient CO₂ desorption, completing a low-energy capture-release cycle. In contrast, Fe binds CO₂ too strongly, rendering desorption ineffective even under a strong reverse field (−40 V), while Zn remains largely unresponsive due to filled d-orbitals, showing minimal activation for CO₂ adsorption even at high field strength (30 V).

Among the three, Cu (111) emerges as the most promising candidate for electrically tunable CO₂ capture, offering a balance between reactivity and reversibility due to its nearly filled d-band configuration. By elucidating the crucial roles of d-orbital occupancy and electric field sensitivity, this Example presents electrically modulated adsorption and desorption as an effective carbon capture mechanism that eliminates the need for chemical functionalization, surface modification, or energy-intensive thermal and pressure processes—opening new pathways for designing tunable CO₂ capture systems through targeted materials and field engineering.

### Introduction of Example 5

In the above Examples, light-induced adsorption/desorption of CO₂ on different metals was studied and revealed that external stimuli can effectively modulate gas-surface interactions. Building on this concept, in this Example, we investigated the use of an EF as an alternative stimulus. Unlike light, which requires continuous photon input and often suffers from stability and penetration limitations, EFs offer a more direct, controllable, and energy-efficient means of tuning surface charge distributions and adsorption energetics. This approach has the potential to provide a robust and scalable pathway for CO₂ capture technologies, eliminating reliance on photoactive materials while enabling reversible adsorption-desorption cycles through modest EF changes.

In this Example, the effect of EFs on CO₂ capture using pristine, low-cost metal surfaces was thus investigated. Specifically, we selected Cu (111), Fe (110) and Zn (0001) because they represent a spectrum of d-band characteristics: Cu with nearly filled configurations offering moderate reactivity and strong tunability, Fe with its partially filled d-orbitals (d⁶ configurations) exhibiting high reactivity; and Zn, with a fully filled d-band (d¹⁰ configuration), representing weakly interacting surfaces. Additionally, these metals should facilitate CO₂ adsorption through d-orbital interactions, while their high electrical conductivity enables efficient charge transfer, potentially lowering activation energy barriers for adsorption and desorption. Furthermore, their abundance and affordability should make them scalable DAC technologies. That being said, these metals also present limitations, including low adsorption capacity, suboptimal CO₂ binding strength (either too weak or too strong), and poor selectivity compared to porous materials. The application of an EF can address these limitations by modifying the surface electronic structure and improving selectivity. However, the exact mechanisms behind EF-enhanced CO₂ capture remain unclear, necessitating further investigation into surface interactions and charge transfer processes to develop more efficient metal-based DAC technologies.

In addition to the EF application, we systematically explored the interaction of CO₂ on Cu (111), Fe (110) and Zn (0001) surfaces in the presence of both surface charges and external EF. In practical applications, surface charges are inevitable due to several reasons. For example, underlying substrates such as TiO₂, Al₂O₃ or Au (111) can induce charge transfer to the metal surface due to differences in work functions or band alignments between the substrate and the metal adsorbate. Additionally, electrochemical operating conditions—such as applied potentials in electrochemical systems, electrospray depositions, and gate voltages can create or modulate surface charge density. However, the synergistic effects of EF and excess electrons on gas-surface interaction remain underexplored, both experimentally and theoretically. To date, only a few studies have examined the respective roles of EFs and excess electrons; however, their analysis have primarily focused on the application is plasma catalysis.

To regulate CO₂ adsorption and desorption, thereby enabling efficient capture, we hypothesize that external EF and surface charges can induce reversible adsorption-desorption of CO₂ simply by reversing the field direction. To test this hypothesis, we developed computational models and applied the DFT method, as detailed in the next section. Next, we systematically analyze CO₂ adsorption behavior at various surface sites in the presence of positive and negative EFs, as well as with different surface charge conditions. Particular attention was given to the effect of field polarity reversal in promoting CO₂ desorption, thereby demonstrating the mechanism of electrically tunable capture. Finally, we discuss the broader implications of our findings for the design of energy-efficient DAC technologies and suggest potential directions for future research.

### Methodology

All calculations were conducted on the Cu (111), Fe (110) and Zn (0001) surfaces utilizing DFT, as implemented within the Quickstep module of the CP2K software package. The Cu (111) and Fe (110) surfaces were modeled as slabs with four atomic layers, using a lattice constant of 3.61 Å and 2.86 Å for Cu and Fe, respectively. The Zn (0001) surface was modeled as a slab with six atomic layers. This study systematically examined adsorption at four unique sites for each of the Cu, Fe and Zn surfaces. Test calculations for adsorption energy were performed using both a 4×4×1 Monkhorst-Pack mesh for Brillouin zone sampling and with sampling restricted to the r-point only. It was found that the calculation using only the r-point were significantly faster compared to those with k-point sampling via the 4×4×1 Monkhorst-Pack mesh, while only minor differences in adsorption energies were observed, and overall trends were maintained (see Table 14). Therefore, all final calculations were performed using r-point sampling for computational efficiency. This approach is also consistent with previous studies; for example, as shown in Jafarzadeh et al. (J. Phys. Chem. C 2020), F-point sampling was employed to study the activation of CO₂ on Cu surfaces. Their work demonstrated that F-point calculations can reliably capture the essential physics and energetics of surface-adsorbate interactions on similar systems, further validating our choice of methodology.

The computational method employed an auxiliary plane wave basis set with a 400 Ry cutoff for all three metals, expanding Kohn-Sham orbitals, together with double-(valence plus polarization (MOLOPT) basis sets, which were optimized at the molecular level. Goedecker-Teter-Hutter (GTH) pseudopotentials were utilized to describe the inner shell electrons. The explicit valence electrons were set to 11, 8, 12, 4, and 6 for Cu, Fe, Zn, C, and O atoms, respectively, to ensure an accurate interpretation of electronic interactions. The exchange-correlation effects were incorporated using the Perdew-Burke-Ernzerhof (PBE) functional within the framework of the generalized gradient approximation (GGA). Additionally, Grimme's D3 correction with Becke-Johnson damping was included to account for dispersion interactions critical for adsorption analysis.

TABLE 14
Convergence test calculation for adsorption energies using
the gamma point and 4 × 4 × 1 k-points

| Metals | Gamma-point (eV) | 4 × 4 × 1 k-points (eV) |
|---|---|---|
| Cu (111) | 0.263 | 0.260 |
| Fe (110) | 0.515 | 0.512 |
| Zn (0001) | 0.102 | 0.101 |

The Broyden-Fletcher-Goldfarb-Shanno (BFGS) algorithm was utilised for geometric optimization, with a convergence threshold for the maximum force set to 1.00×10⁴ a.u (~0.005 eV/Å), ensuring thorough atomic relaxation and highly accurate structural optimization. Periodic boundary constraints were enforced in the x and y directions to ensure surface periodicity, while the z direction has been treated as non-periodic to avoid false interactions with periodic replicas. In order to calculate partial atomic charges, the Hirshfeld-I method, implemented within CP2K, was employed to provide valuable insights into the charge distribution within the system. The Hirshfeld-I method improves upon the standard Hirshfeld scheme by iteratively adjusting the reference atomic electron densities to reflect the actual charge state of each atom in the system. This self-consistent process results in partial atomic charges that better capture polarization and charge transfer effects, offering a more accurate and physically realistic representation of the charge distribution.

To examine the impact of EFs, two methodologies may be considered: the constant potential method and the charged plate (dipole sheet) method. In this work, we used dipole sheet method, as it allows us to implement both charges and EFs on the adsorbent materials. All electric-field effects were modeled via the dipole-sheet approach, incorporating changes to account for the combined impacts of EF strength and extra electrons. This method employs the Martyna Tuckerman Poisson solver to create two oppositely charged electrodes, composed of atomic cores with varying charge states. The dipole sheet, positioned at the centre of the simulation box, enables precise control of charge density and modulation of EF intensity. The applied EF was directed along the negative z-axis, perpendicular to the metal slab's surface, with positive values representing the absolute magnitude of the applied field. The EF strength is defined by the following equation:

$$E = σ / {ε}_{0} \qquad ( 1 )$$

where σ signifies the surface charge density of the dipole sheet and ε, specifies the vacuum permittivity. This equation demonstrates that field strength remains independent of slab thickness and the distance between charged plates. Nevertheless, the charged plates were strategically positioned to prevent direct contact with dummy ions. FIG. 12 illustrates the schematic representation of the previously discussed methodology.

The adsorption energies were calculated by subtracting the total energies of gas-phase CO₂ and the bare slab from the total energy of the adsorbate surface complex (surface+adsorbed molecule), which is given by the following equation:

$$E\_ads = {E}_{( surface + CO 2 )} - [ {E}_{( surface )} + {E}_{( CO 2 )} ] ( eV ) \qquad ( 2 )$$

To account for experimental conditions, CO₂ was modeled in the gas phase without an applied EF, while the energies of the bare slab and the adsorbate-surface complex energies were evaluated under the influence of the EF. Initially, the CO₂ molecule was placed outside the effect of the EF, and then, upon its arrival, it began to be impacted by the applied field. This approach is consistent with the method employed by Jafarzadeh et al., who investigated CO₂ activation on various Cu surfaces [(111), (211), (110), and (001)]. For the desorption step, an EF was applied in the positive z-direction, effectively reversing the polarity of the dipole sheet to induce CO₂ desorption.

### Results and Discussion

This section presents a detailed discussion of the impact of the various EFs and surface charges on CO₂ adsorption at different sites on the three metal surfaces studied. For the different surfaces, first we focused on the top site that are usually very active with EF ranging from 0 to 30 V. This analysis was later expanded to other sites.

### Impact of the Electric Field and Excess Charges on the Bare Cu (111), Fe (110) and Zn (0001) Surfaces

Initially, a uniform EF was applied to the bare metal surfaces, with field strengths varying from 0 V to 30 V. To generate these fields, the plate charges were systematically adjusted, thereby creating the desired field strength between the dipole sheets. The corresponding values of charge and surface charge density for each EF strength are provided in Table 15.

TABLE 15
Corresponding surface charge for different applied potentials

| Applied Potential (V) | Surface charge (\|e\|) |
|---|---|
| 5 | 0.144 |
| 10 | 0.307 |
| 15 | 0.464 |
| 20 | 0.621 |
| 25 | 0.771 |
| 30 | 0.921 |

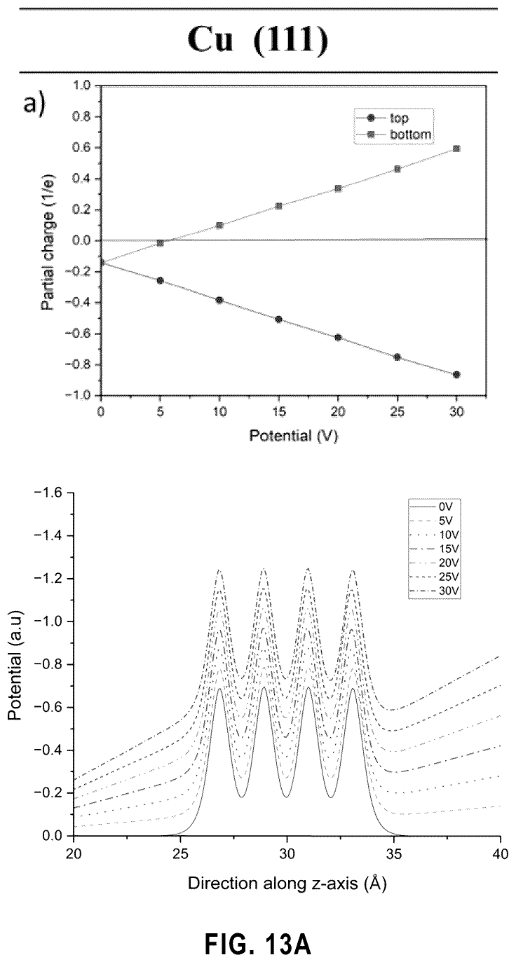

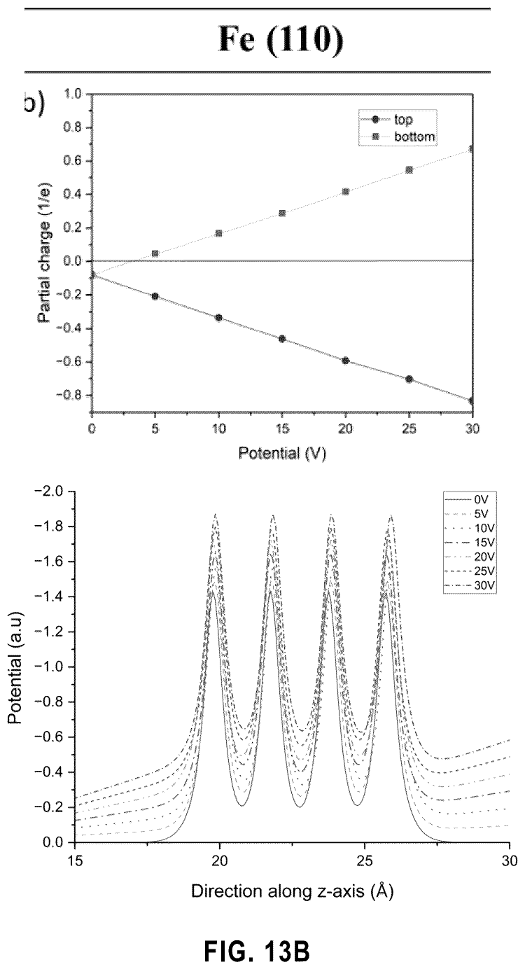

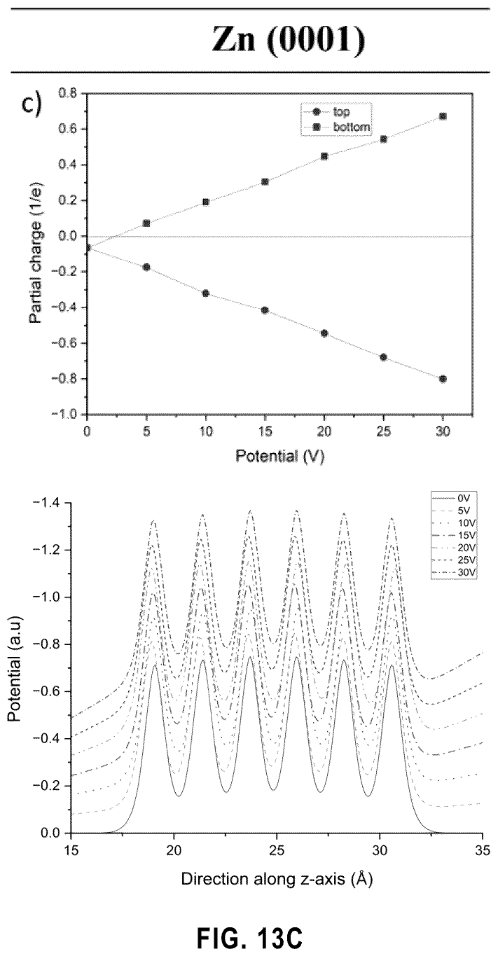

FIG. 13 illustrates the effects of the applied EF on the charge distribution and electrostatic potential across the Cu (111), Fe (110) and Zn (0001) metal slabs. In the absence of an EF, the electrostatic potential rapidly drops to zero on both sides of the metal surfaces, resulting in negligible charge accumulation on the slab. The surface charge distribution remains symmetrical, as evidenced by the negative partial surface charges detected on both the upper and lower atomic layers. However, when an external EF is applied, charge redistribution occurs within the metal, leading to the accumulation of the negative charge on the top surface. The linear relationship between the partial charge on the surfaces and EF strength is illustrated in FIG. 13. This charge redistribution induces an internal EF, which effectively counteracts the external field, thereby ensuring a zero field inside the slab. Additionally, the slope of the potential on both the upper and lower surfaces of all three metal surfaces, as shown in FIG. 13, confirms that the field strength remains consistent on both sides.

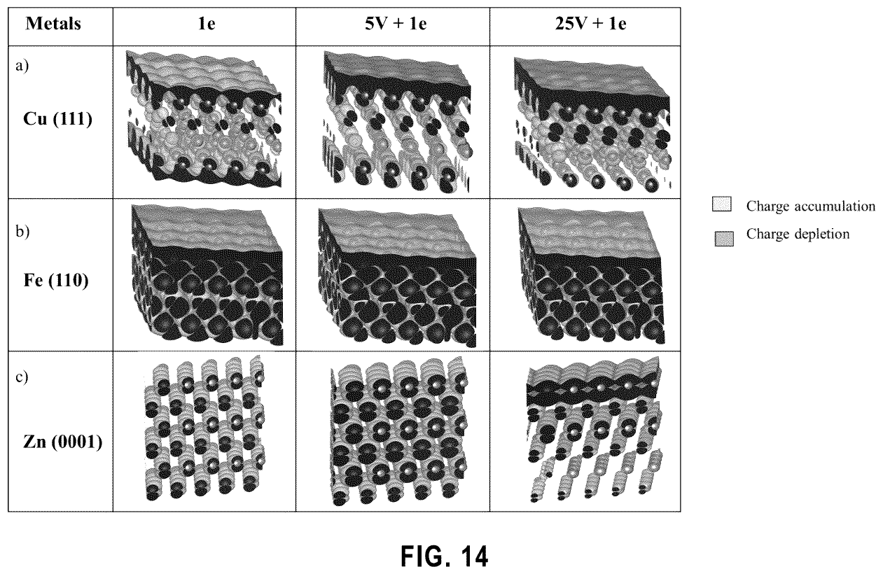

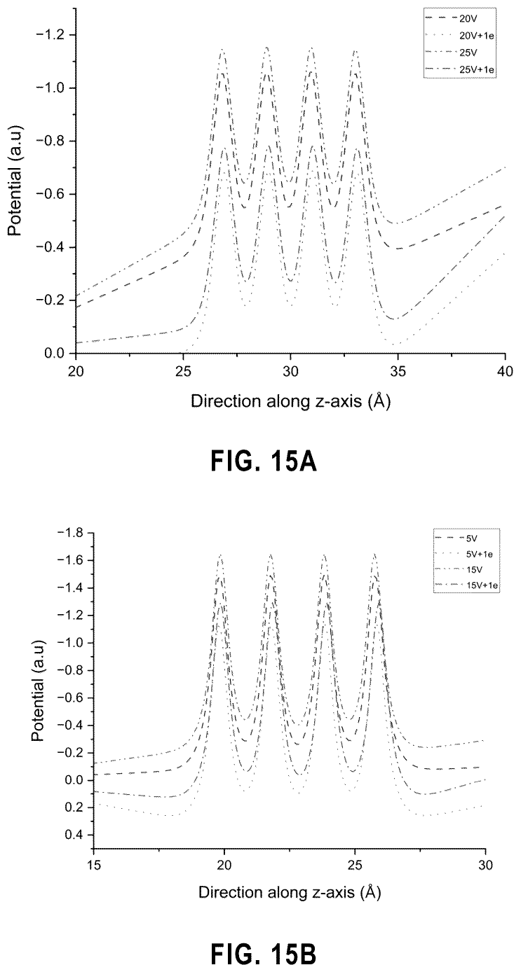

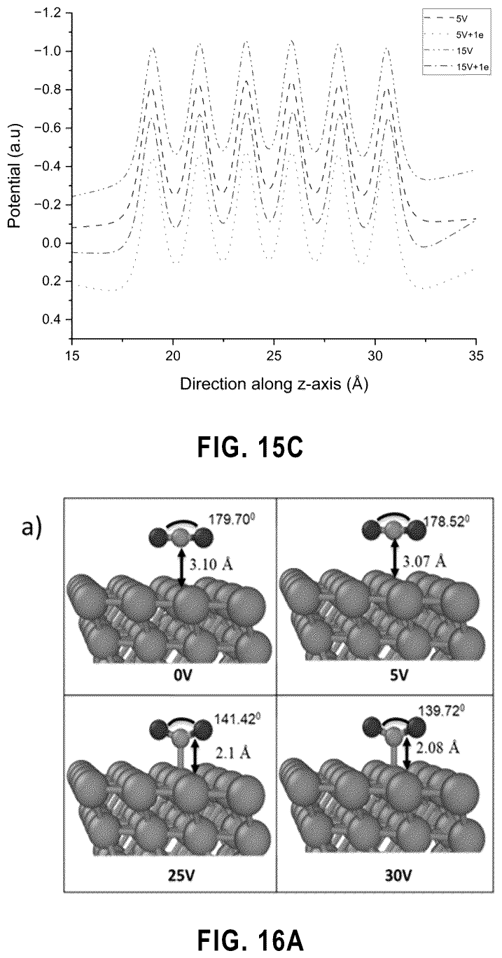

When excess electrons are introduced without an EF, the negative charge becomes evenly distributed across both the upper and lower layers of the Cu (111) surface, aligning well with the electrostatic theory. However, when an excess electron is introduced in the presence of an EF, its distribution becomes asymmetric, leading to a shift in charge accumulation across the slab's surfaces. This is reflected in the altered distribution of the local EFs above and below the metal slab (FIG. 14) as well as the shift in the slope of electrostatic potential on the upper and lower slab surfaces (FIG. 15). This analysis reveals that the interplay between excess charge and external EFs significantly modifies the surface electronic environment, which can influence adsorption behavior and catalytic activity by creating regions of enhanced or diminished charge density.

### CO₂ Capture on Cu (111) Surface

### CO₂ Adsorption

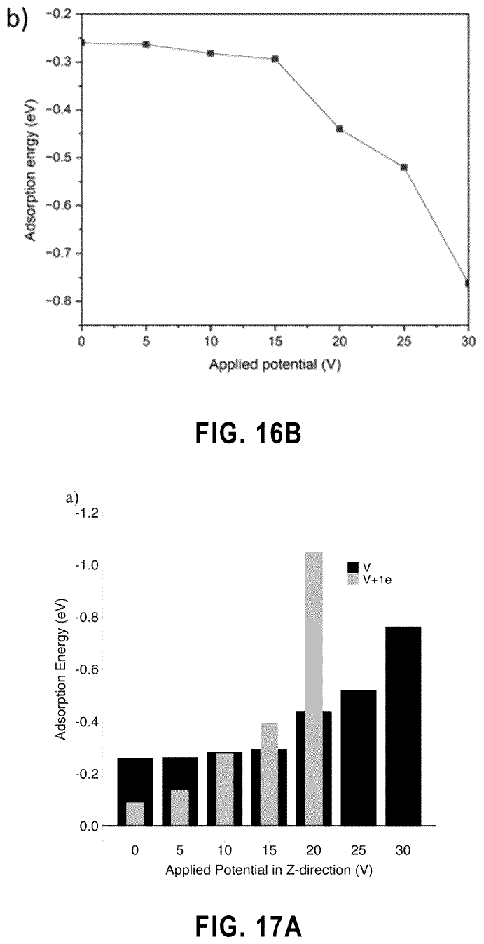

First, we examined the top site on Cu (111) surface because it has been shown to exhibit the strongest CO₂ adsorption among the four unique sites on Cu(111) under no external influences. However, even at this favorable site, CO₂ exhibited weak physisorption. The C—O bond distance remained at 1.17 Å, and the O—C—O bond angle was 179.5°, indicating that CO₂ retained its structure with no significant structural modifications. In order to improve CO₂ adsorption, we then applied EF ranging from 0 V to 30 V on the Cu (111) surface and analysed the interaction of CO₂ on Cu (111) surface. It was found that at lower applied potentials, CO₂ adsorption remained minimal. However, as the applied voltage increases (V=20-30 V), the Coulombic interactions between the C atom of the bent CO₂ and the negatively charged Cu surface intensified, leading to strong CO₂ chemisorption. This transition from physisorption to chemisorption modified the CO₂ molecular structure, reducing the O—C—O bond angle to 139.570 and elongating C—O bonds to 1.24 Å, essential for efficient capture. FIGS. 16 (a) and (b) illustrate the stable adsorption configurations and the correlation between the adsorption energy and the applied potential, respectively. These results confirm that CO₂ adsorption on Cu (111) is voltage-dependent, with strong chemisorption occurring above 20 V. This also suggests that applying a sufficient EF enhances charge redistributions, thereby strengthening CO₂ binding.

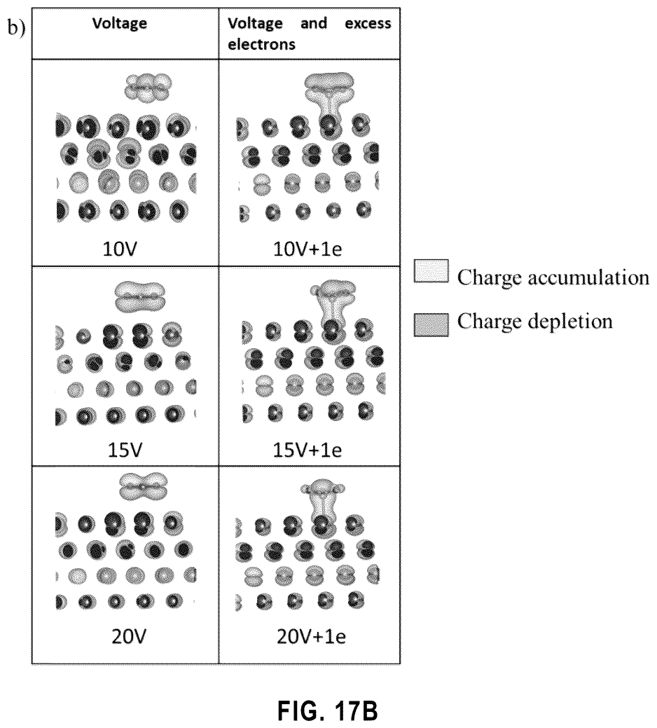

Finally, to examine the synergistic effects of an external EF and excess electrons on CO₂ adsorption, we analyzed CO₂ adsorption on the Cu (111) surface by applying a series of potentials ranging from 5 V to 25 V in combination with the addition of one excess electron. This approach allowed us to evaluate how simultaneous modulation of the surface charge and EF influences the adsorption behavior. Initial findings revealed that the 15 V field alone was insufficient to induce CO₂ chemisorption on the top site of the Cu (111) surface without extra electrons. However, a notable transformation occurred when electrons were introduced alongside the applied potential, resulting in the formation of a stable chemisorbed CO₂ phase on the Cu (111) surface, consistent with Jafarzadeh et al. (J. Phys. Chem. C 2020), which reported a chemisorbed structure under the combined influence of 15 V and additional electron. FIG. 17 (a) illustrates the adsorption energy trends for systems with and without excess electrons. The resulting adsorption configuration induces significant structural modifications in the CO₂ molecule, primarily characterized by a distortion of the O—C—O bond angle from 175.640 to 137.06° and an elongation of the C—O bonds from 1.18 Å to 1.24 Å

To further understand the underlying electronic redistribution mechanisms, Charge Density Difference (CDD) analysis was performed. The results demonstrate that, under applied voltage, the excess electrons are not uniformly distributed across the Cu surface model. Instead, they primarily accumulate on the topmost atomic layer, thereby intensifying the impact of EF. This charge accumulation on the top layer strengthens the adsorbate-adsorbent interaction, thus enhancing the chemisorption process. Moreover, a charge transfer from the Cu surface to the C atom of CO₂ was observed, which stabilized the adsorbed species. FIG. 17 (b) presents a comparative analysis of the CDD for the system with and without extra electrons at different applied potentials, highlighting the unique electronic modifications induced by additional electrons. These findings confirm that voltage and excess electrons work synergistically to transition CO₂ from weak physisorption to stable chemisorption. The observed charge transfer from Cu to the C atom of CO₂ and structural distortions reinforce this transition.

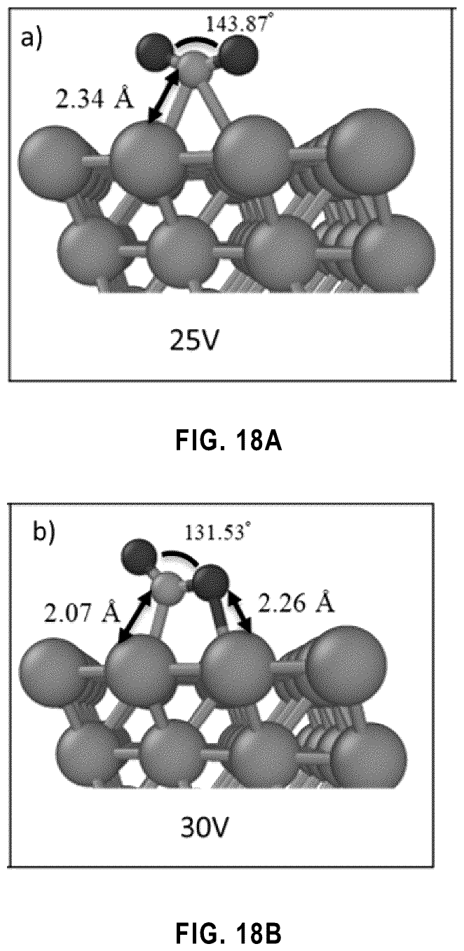

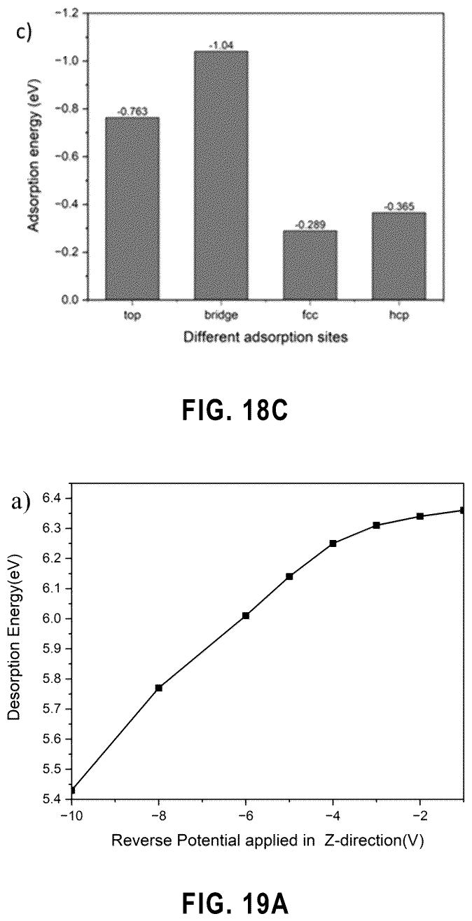

To understand the influence of EF on inactive sites, we subsequently broadened our analysis to incorporate additional adsorption sites, specifically the bridge, face-centred cubic (fcc) and hexagonal close-packed (hcp) sites, evaluating their effectiveness in CO₂ chemisorption under various conditions. At 30 V, noticeable adsorption behaviours emerged: the top and bridge sites facilitated chemisorption, whereas the fcc and hcp sites primarily supported physisorption (FIG. 18). At the bridge site, CO₂ adsorbed in a bidentate configuration via both the C and one O atom forming bond with the Cu surface, leading to bond length elongation and angle distortion, clearly indicating CO₂ chemisorption (FIG. 18).

These results indicate that the efficiency of voltage-driven CO₂ capture on Cu (111) is highly dependent on the adsorption site, as different sites exhibit varying binding strengths. The top site exhibited strong chemisorption, indicating its responsiveness to external fields. Conversely, the fcc and hcp sites promoted weak physisorption, making them ineffective for stable capture. The bridge site, where CO₂ interacts via both the C and an O atom, enables a more delocalized charge transfer between the molecule and the surface, stabilizing CO₂ more effectively while preventing excessive binding strength as in the case of top site, making desorption under reverse polarity more feasible. These findings highlight the bridge site as the optimal location for an efficient adsorption-desorption cycle, underscoring the importance of site-selective adsorption in optimizing voltage-driven DAC. The detailed information on the bond angles and bond lengths for the different adsorption sites at 30 V is given below in Table 16.

TABLE 16
Bond lengths and bond angles for the most stable CO₂ adsorption mode on
Cu (111) at applied potential of 30 V at different adsorption sites

| Adsorption site | dCu—C (Å) | dCu—O1 (Å) | dC—O1 (Å) | dC—O2 (Å) | O1—C—O2 |
|---|---|---|---|---|---|
| Top | 2.08 | 2.86 | 1.24 | 1.24 | 139.72 |
| Bridge | 2.07 | 2.26 | 1.27 | 1.24 | 131.53 |
| Hcp | 2.51 | 3.05 | 1.23 | 1.23 | 138.96 |
| Fcc | 2.52 | 2.62 | 1.23 | 1.23 | 137.56 |

### CO₂ Desorption

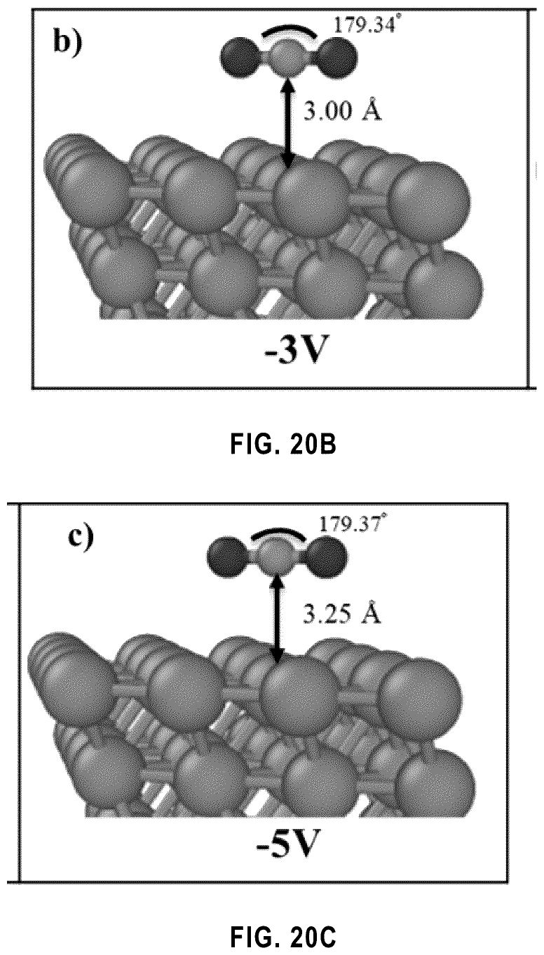

To achieve efficient CO₂ capture, it is essential to use a material that is capable of both adsorbing and desorbing CO₂ with minimal energy input. To study desorption, we used the model, represented in FIG. 20 (a), that had chemisorbed CO₂ on the top site of Cu (111) surface at 30V. To initiate desorption, we reversed the polarity by altering the charges on the dipole sheet, thereby applying an EF along the positive Z-axis. The desorption process was investigated by gradually elevating the reverse potential from −1 V to −10 V. Our findings showed that even a minimal reverse potential was sufficient to desorb the chemisorbed CO₂ from the Cu (111) surface. During desorption, the C—O bond length is shortened, and the bent geometry of CO₂ is converted into a linear configuration, explicitly indicating desorption. The same desorption process was also studied using the bridge-site chemisorbed structure obtained at 30 V, and a similar behavior was observed. The desorption energy was calculated using the equation below:

$$Δ D = ( Desorbed energy state ) - ( Adsorbed energy state ) ( eV ) \qquad ( 3 )$$

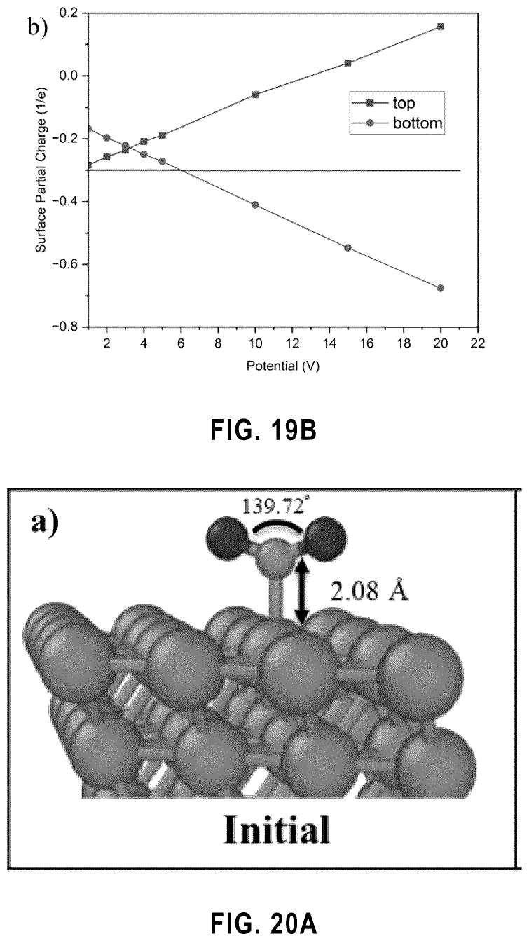

and the desorption energy trend of CO₂ under reverse polarity is illustrated in FIG. 19 (a), while FIGS. 20 (b) and 9 (c) depict the stable structures of CO₂ after desorption at −3V and −5V, respectively. Detailed information on bond distances, bond lengths, and bond angles of CO₂ is provided in the Supplementary Information (Table 17). Furthermore, the partial charge distribution on the surface (FIG. 19 (b)) indicates that the upper surface became progressively less negatively charged as the potential increases from −2V to higher potentials. This shift reduced the probability of Coulombic interactions between the C atom of CO₂ and the Cu surface, thereby promoting desorption. However, as the polarity was reversed and the potential increased beyond −10V, the surface developed a strong interaction between the partially negative O atom of CO₂ and the surface. This interaction eventually resulted in the re-adsorption of CO₂. To optimize the desorption process, the external potential was fine-tuned to −2V, which was sufficient to induce desorption while minimizing re-adsorption.

TABLE 17
Bond lengths and bond angles for the CO₂ desorption
on Cu (111) surface under reverse polarity

| Potential | | | | |
|---|---|---|---|---|
| (V) | dCu—C (Å) | dC—O1 (Å) | dC—O2 (Å) | <O1—C—O2 |
| −1 | 2.99 | 1.17 | 1.17 | 179.94 |
| −2 | 3.00 | 1.17 | 1.17 | 179.47 |
| −3 | 3.00 | 1.17 | 1.17 | 179.34 |
| −4 | 3.15 | 1.17 | 1.17 | 179.21 |
| −5 | 3.25 | 1.17 | 1.17 | 179.37 |
| −10 | 3.00 | 1.17 | 1.17 | 177.98 |

### CO₂ Capture on Fe (110) Surface

### CO₂ Adsorption

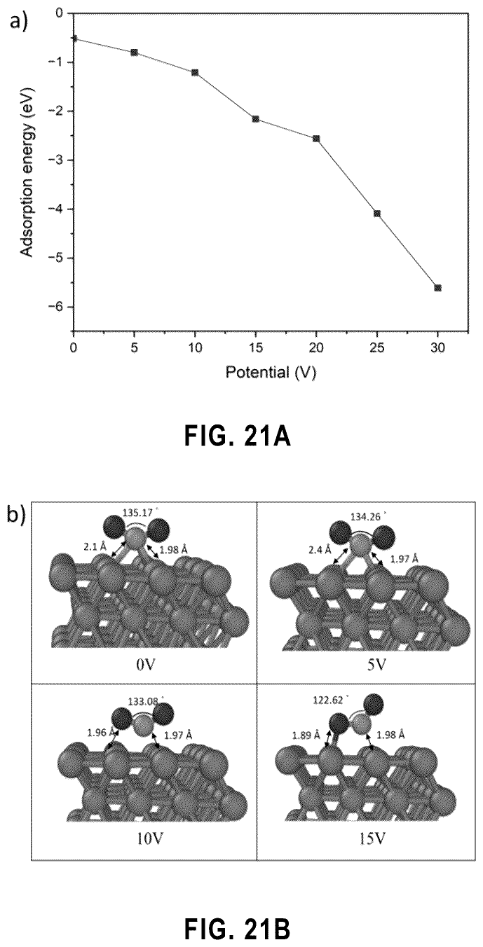

Fe is one of the most active catalysts for chemical reactions such as ammonia synthesis, CO₂ conversion, etc. To evaluate its potential for CO₂ capture, we examined the Fe (110) surface with and without an external EF and excess charges. First, we examined the interaction between the CO₂ and Fe (110) surface in the absence of an external EF. As expected, CO₂ strongly chemisorbed on the Fe (110) surface even in the absence of an external EF on the top site of Fe (110), primarily due to the intrinsic electronic properties and high surface reactivity of Fe. The Fe (110) facet features accessible d-orbitals that readily hybridize with the molecular orbitals of CO₂, thereby facilitating the formation of Fe—C bonds that stabilize the molecule on the surface. In this Example, various adsorption sites on Fe (110) were examined, and across all configurations, CO₂ exhibited strong chemisorption behavior. This was evidenced by significant structural changes in the molecule, including an elongation of the C—O bond length from 1.18 Å to 1.25 Å and a reduction in the O—C—O bond angle from 1800 to 135.17°. This transition from a linear to a bent geometry indicates molecular activation, promoted by strong Coulombic interaction between the Fe atoms and the partially positive carbon of the CO₂ molecule. To investigate and compare the efficiency of the Fe surface for CO₂ capture, a series of EFs ranging from 0 to 15 V were applied. It was observed that the surface reactivity of Fe increases significantly under the influence of the EF. Detailed information on bond length, bond distance and bond angles under different applied EF is given in the Table 18. As the EF strength increases, CO₂ interacts more strongly with the surface, initially forming a monodentate bond through the C atom and eventually transitioning to bidentate bonding involving both the C and one of the O atoms. This results in a gradual enhancement of chemisorption strength, indicating that the EF facilitates the activation and stronger binding of CO₂ on the Fe surface. The adsorption energy plot and the most stable configuration at different applied potential is given in FIGS. 21 (a) and (b) respectively.

TABLE 18
Bond lengths and bond angles for the CO₂ adsorption on
Fe (110) surface in the presence of an electric field

| Potential | | | | |
|---|---|---|---|---|
| (V) | dFe—C (Å) | dC—O1 (Å) | dC—O2 (Å) | <O1—C—O2 |
| 0 | 1.98 | 1.26 | 1.25 | 135.17 |
| 5 | 1.97 | 1.27 | 1.27 | 134.26 |
| 10 | 1.97 | 1.26 | 1.26 | 133.08 |
| 15 | 1.98 | 1.23 | 1.34 | 122.62 |

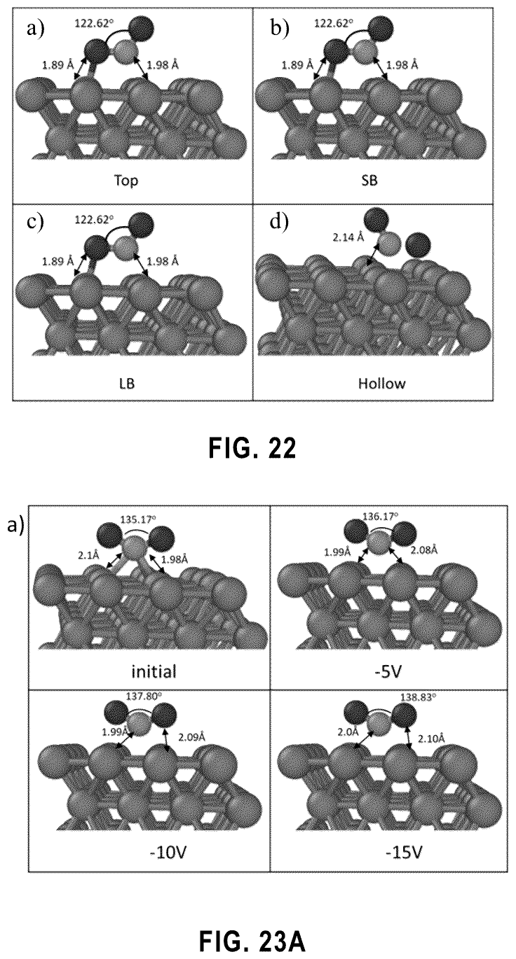

Then the analysis was subsequently extended to incorporate additional adsorption sites, specifically the long bridge (LB), short bridge (SB) and hollow sites, to evaluate their effectiveness for CO₂ chemisorption under various conditions. It was observed that upon application of an EF, the surface exhibited increased reactivity towards CO₂, and the molecule gradually began to dissociate on the Fe surface, rendering these sites less suitable sites for DAC process. The stable structures obtained for CO₂ adsorption on different sites of Fe at 15 V are provided in the FIG. 22.

### CO₂ Desorption

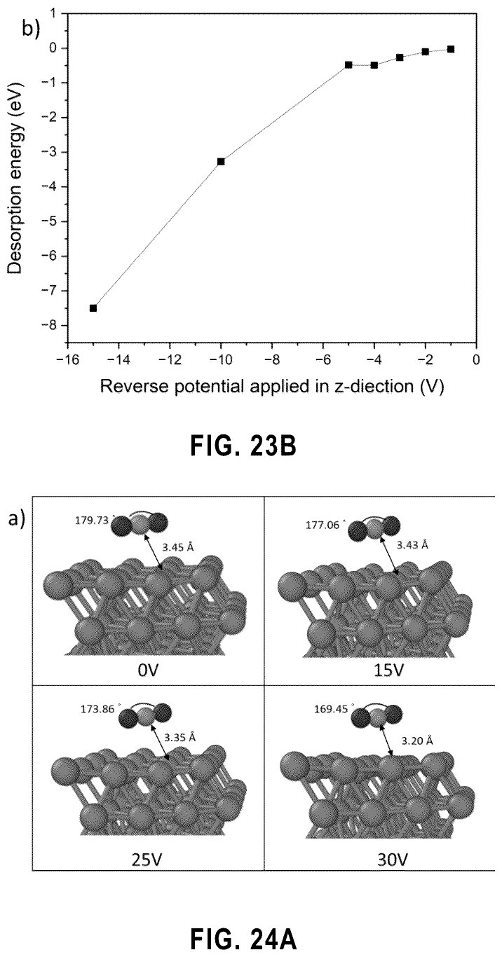

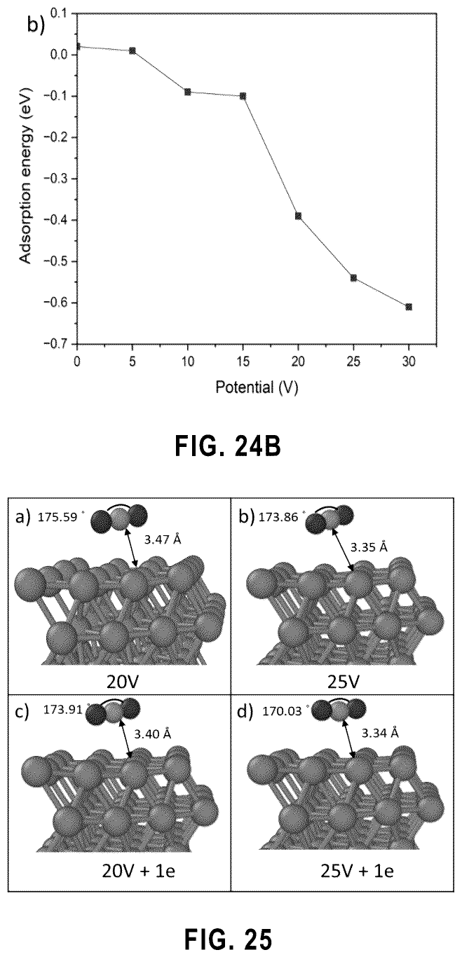

In contrast to the previously studied Cu surface, the Fe (110) surface exhibits an intrinsic capability to chemisorb CO₂ even in the absence of an external EF. In this part of the study, the most stable CO₂ chemisorbed configuration obtained at 0 V was selected to investigate its desorption behavior under reverse bias conditions. The desorption process was simulated by progressively increasing the reverse potential from −1 V to −20 V. Notably, even at a high reverse potential of −20 V, complete desorption of CO₂ from the Fe surface was not observed, indicating a strong adsorption state. Furthermore, the reverse voltage was increased up to −40 V, which is higher than values typically employed in practical systems. Despite this unusually high external field, CO₂ remained chemisorbed on the Fe surface (resulting in O—C—O bond angle of 145.34° and O—C bond length of 1.24 Å), and no complete desorption was achieved. This finding emphasizes the energy-intensive nature of the desorption process, which may pose limitations for the practical application of Fe-based systems in DAC technologies. The desorption energy was calculated using the same methodology previously applied to the Cu surface, and the resulting trend of CO₂ desorption under reverse polarity is presented in FIG. 23. Further information regarding bond distances, bond lengths, and bond angles for CO₂ in various configurations is provided in the Table 19.

TABLE 19
Bond lengths and bond angles for the CO₂ desorption
on Fe (110) surface under reverse polarity

| Potential | dFe—C | dFe—O1 | dC—O1 | dC—O2 | |
|---|---|---|---|---|---|
| (V) | (Å) | (Å) | (Å) | (Å) | <O1—C—O2 |
| 0 | 2.10 | 1.98 | 1.26 | 1.25 | 135.17 |
| −5 | 1.99 | 2.08 | 1.26 | 1.25 | 136.17 |
| −10 | 1.99 | 2.09 | 1.26 | 1.25 | 137.80 |
| −15 | 2.00 | 2.10 | 1.26 | 1.25 | 138.83 |

### CO₂ Capture on Zn (0001) Surface

### CO₂ Adsorption

Finally, we examined the interaction of CO₂ on the Zn (0001) surface. Zn (0001) possesses fully filled d-orbitals and is generally considered catalytically inactive toward CO₂, making it an ideal model for isolating and evaluating the effects of EFs on the CO₂ capture process. Studying such an inert surface enables us to directly assess the potential of EF-assisted capture without strong intrinsic interactions. It was found that, in the absence of an external EF, CO₂ physisorbs only weakly on the Zn (0001) surface. This weak physisorption can be attributed to the fully occupied d-orbitals of Zn, which render the surface chemically inert and incapable of facilitating substantial bonding with the CO₂ molecule. As a result, the CO₂ retains its molecular geometry, exhibiting a C—O bond length of 1.17 Å and an O—C—O bond angle of 179.5°, confirming that it remains in a linear, unactivated state with no notable structural distortion.

To further investigate, the adsorption behavior of CO₂ on the Zn (0001) surface was studied under an externally applied electric potentials ranging from 0 to 30 V, focusing initially on the top site. Under these conditions, CO₂ was observed to approach the Zn (0001) surface; however, it remained physisorbed. Notable molecular activation was observed only at 30 V, where the CO₂ geometry exhibited a slight bend of 169.45°, compared to the almost linear structure maintained under lower EF strengths. The observed bond angles and bond distances, supporting minimal interaction of CO₂ with Zn (0001) surface under various EF strengths, are presented in the Table 20. The corresponding optimized structures observed at different potentials, as well as the trend in adsorption energy, are shown in FIGS. 13 (a) and (b), respectively.

TABLE 20
Bond lengths, bond angles and adsorption energy for the CO₂ adsorption
on Zn (0001) surface under different applied potential

| Potential | dZn—C | dC—O1 | dC—O2 | | Adsorption |
|---|---|---|---|---|---|
| (V) | (Å) | (Å) | (Å) | <O1—C—O2 | energy (eV) |
| 0 | 3.45 | 1.18 | 1.17 | 179.73 | 0.02 |
| 5 | 3.47 | 1.18 | 1.18 | 178.89 | 0.01 |
| 10 | 3.44 | 1.18 | 1.18 | 177.92 | −0.09 |
| 15 | 3.46 | 1.18 | 1.18 | 177.06 | −0.1 |
| 20 | 3.47 | 1.18 | 1.18 | 175.48 | −0.39 |
| 25 | 3.35 | 1.18 | 1.18 | 173.86 | −0.54 |
| 30 | 3.20 | 1.18 | 1.18 | 169.45 | −0.61 |

Furthermore, to increase the interaction between CO₂ and Zn (0001) surface, higher potentials of 20 and 25 V were sequentially applied along with the excess charge of 1e. Even though the excess surface charge was introduced, the CO₂ remained in the weakly physisorbed state, indicating that Zn (0001) is less suitable for CO₂ capture FIG. 25.

Furthermore, additional adsorption sites on the Zn (0001) surface, namely bridge, hcp, and fcc sites, were examined under externally applied electric potentials ranging from 0 to 30 V. Across all these sites, CO₂ consistently exhibited only weak physisorption, with no evidence of significant charge transfer or structural distortion. The CO₂ molecule maintained a nearly linear geometry and bond distances comparable to those in gas phase CO₂, further indicating minimal interaction with the Zn (0001) surface (see Table 21).

TABLE 21
Bond lengths and bond angles for the CO₂ adsorption on different
sites of Zn (0001) surface under an applied potential of 30 V

| Adsorption | dZn—C | dZn—O1 | dC—O1 | dC—O2 | |
|---|---|---|---|---|---|
| site | (Å) | (Å) | (Å) | (Å) | O1—C—O2 |
| Top | 3.20 | 2.99 | 1.18 | 1.18 | 169.45 |
| Bridge | 3.30 | 3.00 | 1.18 | 1.18 | 169.05 |
| Hcp | 3.51 | 3.82 | 1.18 | 1.18 | 171.80 |
| Fcc | 3.21 | 3.68 | 1.18 | 1.18 | 173.41 |

This weak interaction of Zn to external EFs can be attributed to its electronic structure as discussed in the next section.

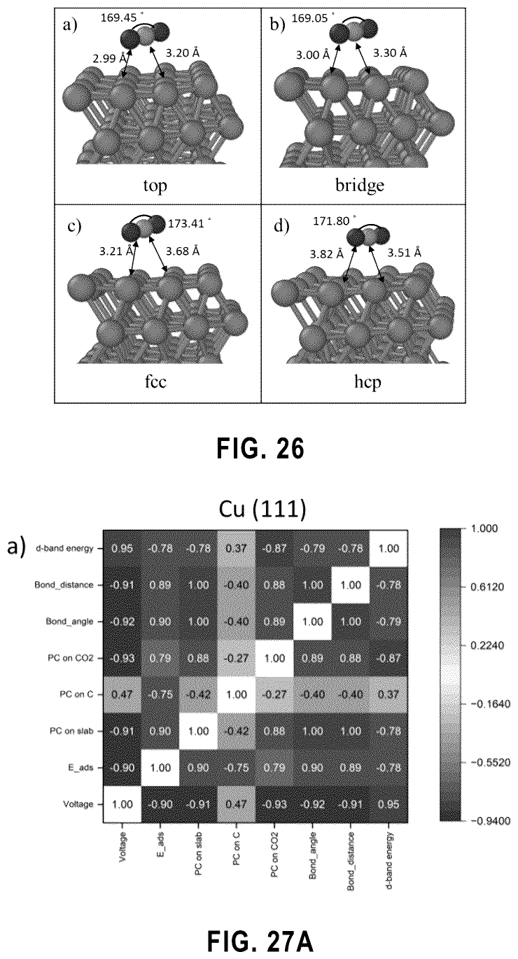

The optimized structures of CO₂ adsorbed at 30V on various adsorption sites of Zn (0001) are shown in FIG. 26. Due to the absence of chemisorption, no configuration could be identified as a favourable one for subsequent desorption processes. These findings highlight the limitations of Zn (0001) as an ineffective candidate for EF-assisted DAC approach.

### Correlation and Electronic Structure Analysis of CO₂ Adsorption Under Electric Fields

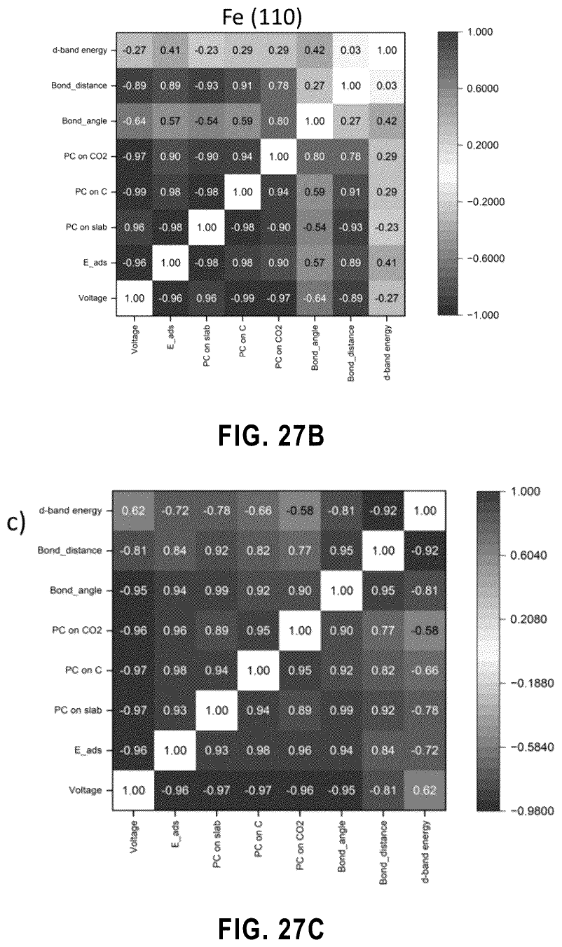

To evaluate the interdependence between structural, electronic, and adsorption-related descriptors, such as CO₂ adsorption energy (E_ads), partial charges (PC), bond-angle and bond-distance, a Pearson correlation matrix was generated for each metal surface (FIG. 27). This matrix quantifies linear relationships among descriptors and provides insight into the factors governing CO₂ adsorption under external EFs. Across all three metals, applied voltage exhibits a strong negative correlation with E_ads (Cu: −0.95, Fe: −0.96, Zn: −0.96), indicating that increasing EF enhances CO₂ binding. Similarly, voltage negatively correlates with the partial charge on CO₂ (Cu: −0.93, Fe: −0.97, Zn: −0.96), suggesting EFs facilitate charge transfer to the adsorbate, stabilizing adsorption.

The relationship between the d-band center, E_ads, and voltage, however, varies significantly across the three surfaces. For Cu, the d-band center shows a negative correlation with E_ads (−0.78) and a positive correlation with voltage (0.95), indicating EF-driven modulation of the electronic structure. Zn shows moderate correlations with both E_ads (−0.72) and voltage (0.62). In contrast, Fe shows negligible correlation (0.41 and −0.27, respectively), implying the d band center is not a reliable descriptor for adsorption behavior on Fe due to its complex, spin-polarized electronic structure.

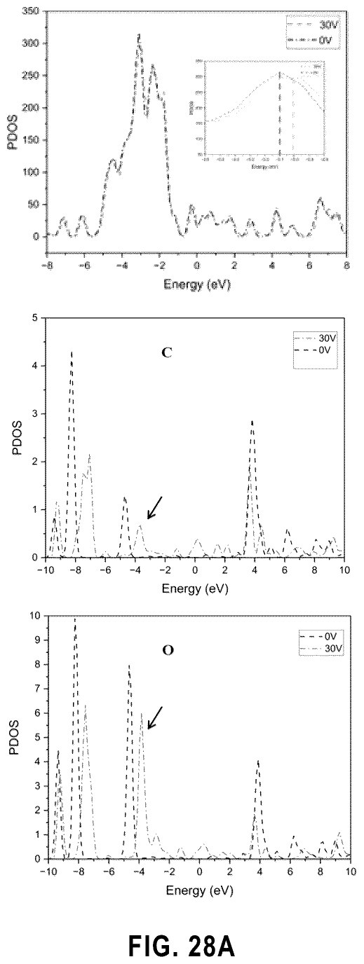

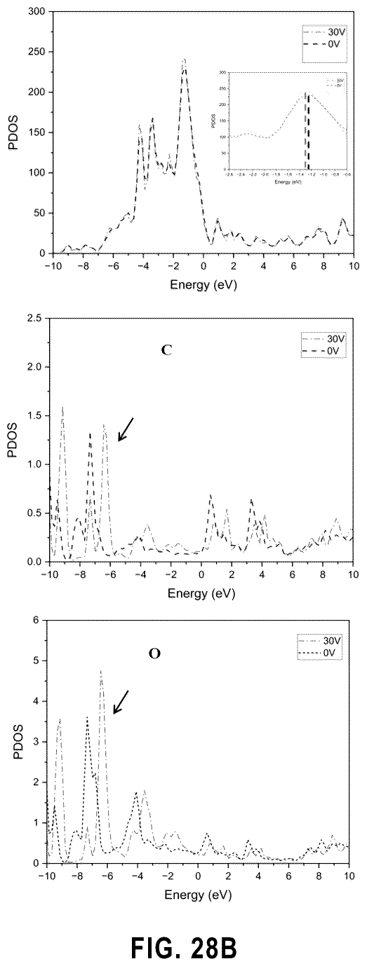

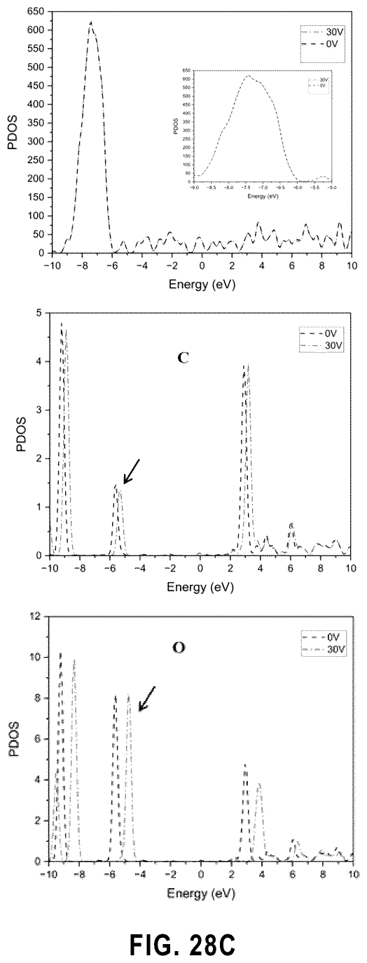

To further elucidate the electronic interactions between CO₂ and the metal surfaces under an external EF, PDOS analyses were performed for both the surface metal atoms (primarily d-states) and the C and O atoms of adsorbed CO₂ on Cu (111), Fe (110), and Zn (0001) surfaces (FIG. 28). The first row in FIG. 28 presents the PDOS of the metal surface with adsorbed CO₂ at both 0 V and 30 V, highlighting the field-induced changes in surface electronic states. The second and third rows display the PDOS for the C and O atoms of the CO₂ molecule, respectively, emphasizing changes in their s and p orbital contributions. EFs induced only a slight shift in the surface metal d-states, toward the Fermi level (specifically for Cu and Fe surfaces), whereas the impact of EF is more pronounced on CO₂ molecule, which shows significant shifts in s and p states.

Cu (111), with its nearly filled d orbital, exhibits a noticeable d-band shift toward the Fermi level under EF, as shown by the DOS between Cu (111) at 0V and Cu (111) at 30V in FIG. 28 (a). This shift enables efficient modulation of CO₂ adsorption strength, under EF i.e. Cu (111) transitions from a weak adsorbate to strong adsorbate, inducing chemisorption. Conversely, reversal of the field facilitates desorption with only modest potentials.

Fe (110), on the other hand, shows minimal shift in its d-orbitals in the presence of EF (FIG. 28 (b)). However, since it intrinsically possesses partially filled d orbitals with a high density of states near the Fermi level, it results in strong chemisorption of CO₂ with and without an applied EF.

Zn (0001), by contrast, exhibits negligible changes in its PDOS under EF (FIG. 28(c)). Owing to fully filled d orbitals and deeply buried d-bands, Zn lacks accessible empty or partially filled states near the Fermi level that could couple with CO₂ orbitals. As a result, CO₂ activation remains negligible, even in the presence of EF.

In summary, this comparative analysis highlights Cu (111) as the most promising surface for field-tunable CO₂ activation and release. Its ability to switch between adsorption and desorption under moderate field makes it ideal for DAC. In contrast, Fe (110) overbinds and Zn (0001) weakly, making them less suitable for practical DAC applications.

### Conclusions and Outlook—Example 5

In this Example, we conducted a detailed evaluation of the CO₂ capture process across different metal surfaces such as Cu (111), Fe (110) and Zn (0001) in the presence of an external EF and the excess electrons. By considering metals with different d-occupations such as Fe (partially filled), Cu (intermediate) and Zn (completely filled), we identify the fundamental aspects governing CO₂ capture and the ability of the external field to enhance adsorption on these surfaces.

The main finding is the behavior of Cu (111) surface towards the CO₂ capture in the presence of EF. Unlike Fe and Zn, the Cu shows a gradual transition from the weakly physisorbed structure to stable chemisorbed structure, facilitated by efficient charge redistribution and enhanced Columbic interactions between the C atom of the CO₂ and the negatively charged Cu surface. This transition is accompanied by the structural activation of the CO₂ molecule, including bond distance elongation and bond angle distortion leading to strong chemisorption. Fe, with its high intrinsic reactivity, strongly chemisorbs CO₂ even without a field, but its desorption is inefficient and energetically demanding, limiting its recyclability. Zn, conversely, is largely inert due to a filled d¹⁰ configuration, resisting activation even under strong EFs and excess charges. The Cu (111) surface requires only an EF in the range of 20-30V to activate the CO₂ for adsorption and a minimal reverse potential of −2V to trigger the CO₂ desorption. This makes the process technically feasible for the DAC approach, rendering it more energy-efficient and scalable compared to traditional methods such as TSA and PSA, which involve bulk heating and pressurization and are both energy-intensive and slow process compared to the EF-based modulation.

Overall, this Example indicates that the application of an external EF to moderately reactive metals with nearly filled d orbitals—such as Cu, Ag, Au, Pd, and Pt—can activate reversible CO₂ adsorption and desorption. This is due to the reason that as the application of EF can modify the electronic states of these metals, bringing d-states closer to the Fermi level. These metals, which typically exhibit limited interaction with CO₂ under ambient conditions, become highly responsive to field-induced charge redistribution, offering a controllable and energy-efficient pathway for carbon capture and release. In contrast, metals with partially filled d-orbitals (e.g., Fe, Ni, Mn, Cr, Co) exhibit overly strong chemisorption, hindering desorption, while those with fully filled d-orbitals (e.g., Zn, Cd, Ga, In) display weak physisorption, even under high EFs, limiting their ability to activate CO₂.

To our knowledge, this Example provides the first simulation-based evidence that a pristine metal surface can reversibly adsorb and desorb CO₂ under the influence of an external EF. This marks a significant advancement, introducing electrically modulated adsorption and desorption as a novel mechanism for carbon capture, one that bypasses the need for chemical functionalization, surface modification, or energy-intensive thermal and pressure-based processes. These findings lay the groundwork for future experimental and computational efforts to harness EFs in designing low-energy, scalable, and selective DAC technologies. By clarifying the key roles of d-orbital occupancy and field sensitivity, this work opens new pathways for developing tunable CO₂ capture systems through targeted material selection and field engineering.

### Example 6—Experimental Validation of Computational Predictions Methodology

### Materials and Samples

Open-cell metal foams were used to demonstrate CO₂ adsorption and photo-assisted desorption on pristine metallic frameworks possessing substantial gas-solid inter-facial areas. Nickel and copper foams were sourced from MSE Supplies as 300 mm×200 mm sheets with a nominal thickness of 1.6 mm. Manufacturer specifications indicate that the copper foam has a typical open-cell porosity of approximately 98% and a pore density of about 110 pores per inch (PPI). The nickel foam is reported to have a porosity of approximately 97% and a pore density of 110 PPI. Aluminum foam (100 mm×100 mm) was sourced from Electrode Research/Customizable Solutions, with the product page listing a porosity of 95-98% and approximately 110 PPI. For each metal (Cu, Al, Ni), the as-received sheet was sectioned into five identical strips measuring 15.2 cm×5.0 cm×1.35 mm, affording a planar area of 76 cm² per strip and a total geometric exposed area of 0.076 m² across all five strips. The aggregate geometric volume of the loaded material amounted to 51.3 cm³. The strips were installed in the fixed-bed reactor with uniform orientation and inter-strip spacing to avert channeling effects; no binders or washcoats were applied, thereby ensuring that all observed adsorption/desorption phenomena capture the intrinsic behavior of the metallic foam skeletons under dark and illuminated conditions. The total masses of Cu, Al, and Ni foam loaded into the reactor were 21.8 g, 22.4 g, and 11.9 g, respectively. It is important to distinguish between the macroscopic planar area of the cut strips (for example—Cu 0.076 m² for five strips) and the much larger ligament surface area of the Cu foam (≈0.215 m²) obtained from micro-CT analysis of the internal pore network (see the section titled “Micro-CT based estimation of the geometric area”), which is used for geometric normalization of breakthrough curves. More details about the foams are mentioned in Table 22.

TABLE 22
Geometric properties of Cu, Ni and Al foams used in
the fixed-bed reactor. In all cases, five strips
(15.2 cm × 5.0 cm × 1.35 mm) were loaded, corresponding
to a total foam volume of 51.3 cm³.

| | Mass | Foam | Solid | | | |
|---|---|---|---|---|---|---|
| | used | density | fraction | Porosity | Atotal | Sₘ |
| Foam | (g) | (g cm⁻³) | (vol. %) | (vol. %) | (m²) | (m² g⁻¹) |
| Cu | 21.813 | 0.425 | 4.75 | 95.25 | ≈0.215 | 0.00984 |
| Ni | 11.892 | 0.232 | 2.60 | 97.40 | ≈0.215 | 0.0180 |
| Al | 22.367 | 0.436 | 16.15 | 83.85 | ≈0.215 | 0.00959 |

### Breakthrough Apparatus and Instrumentation

The experiments employed the calibrated fixed-bed breakthrough apparatus. Mass-flow controllers regulated the CO₂/N₂ gas mixture and total flow rate Fₜₒₜ. A downstream gas analyzer delivered a continuous CO₂ mole-fraction signal yₒᵤₜ(t); periodic span/zero calibrations preceded each batch of runs. Bed pressure and temperature were monitored at fixed positions adjacent to the foam. For illuminated experiments, a collimated light source was directed through the optical window onto the bed; incident power at the sample plane was quantified via a calibrated meter, with the illuminated area recorded to determine irradiance “I” (W/m²). Identical configuration of foam and other experimental conditions were used across all runs to minimize hardware-related variability.

### Gas Composition and Operating Protocols

A standard adsorption/desorption cycle was used across all metals and conditions:
1. Purge/Conditioning—N₂ purge to a stable baseline and remove moisture.
2. Adsorption—Switch to a CO₂/N₂ mixture at total flow “Fₜₒₜ” (=110 SCCM); continue until the analyzer signal reached a steady outlet fraction (breakthrough).
3. Desorption (Dark)—For dark runs, switch to N₂ purge at “Fₜₒₜ” (=100 SCCM) without illumination.
4. Desorption (Illuminated)—For illuminated runs, switch to N₂ purge and apply light (irradiance I) at the bed. Temperature and optical power were logged continuously.
5. Desorption (Voltage, Cu only)—A separate experiment was performed on Cu foam in which both adsorption and desorption were done at 25° C. to isolate purely electrical effects. After an adsorption step identical to that described above (CO₂/N₂ at 110 SCCM), the system was switched to N₂ at 100 SCCM while the foam was held at 0V, +V (~61 V), or −V (~−61 V). No external heating was applied, and any change in desorbed CO₂ relative to the adsorption (at 25° C.) and desorption (at 25° C.) blank run was attributed to electrostatic modification of the surface.
6. Replication—Each metal/condition was cycled in replicates to quantify repeatability and compute mean±SD metrics.

### Micro-CT Based Estimation of the Geometric Surface Area

The complete procedure is described taking Cu foam as an example and same has been utilized for the other two foams as well.

### Samples and Bulk Porosity

Five strips of copper foam, each with dimensions 152×50×1.35 mm were cut from the as-received sheet, giving a combined foam volume of 51300 mm³ (51.3 cm³). The total mass was 21.813 g, yielding an effective bulk density ρ_{eff}=0.425 g/cm³. Using bulk copper density ρ_{Cu}=8.96 g/cm³, the solid volume fraction and porosity consistent with a highly open cellular structure.

$${φ}_{solid} = \frac{{ρ}_{eff}}{{ρ}_{Cu}} = 0.0475 ; ε = 1 - {φ}_{solid} = 0.9525$$

### Acquisition and Field of View Selection

The internal microstructure of the foam was characterized using micro-computed tomography (micro-CT) (SkyScan 1272 desktop X-ray microtomography). Reconstructed tomographic slices were 2452×2452 pixels in resolution, with a voxel size of 10.889 μm. To eliminate incomplete or noisy peripheral regions, only slices 660-780 were retained for analysis. A representative central slice underwent thresholding to delineate the bright rectangular foam structure from the dark circular scanner background, followed by morphological closing and hole-filling. The bounding box of this binary mask was then applied to crop the full slice stack to the foam-only volume.

Segmentation with Bulk-Constrained Thresholding

In the cropped volume, the grayscale image stack was subjected to smoothing (using 3D Gaussian filter, σ=1 voxel). To avoid biases in solid fraction estimation inherent to purely image-based thresholding, the intensity threshold was calibrated using the independently measured bulk solid fraction. Voxel intensities within the foam were equalized through histogram flattening, with the brightest 4.75% designated as copper ligaments and the remainder as pores. Small isolated copper artifacts were subsequently removed. The CT-derived solid and pore fractions (φ_{solid}=0.0473, ε=0.9527) aligned closely with bulk measurements, validating the segmentation approach.

### Surface Reconstruction and A/V

Multiple internal volumes of interest were delineated by cropping approximately 10-20% from each boundary (x, y, z) to alleviate edge artifacts. For each VOI, the binarized copper phase was rendered as a triangulated isosurface. Vertex coordinates were rescaled to millimeters according to the voxel resolution; the total surface area A was determined by summing the areas of triangular facets, while the VOI volume V was obtained from the voxel count. Across three representative VOIs (“center”, “upper”, “lower”), the surface-to-volume ratio was (A/V)=4.15, 4.42, 3.98 mm⁻¹, with an average (A/V)_{avg}=4.18±0.18 mm⁻¹.

### Scaling to the Tested Load and Specific Area

Using the total loaded foam volume V_{foam}=51, 300 mm³, the geometric copper surface area is:

$${A}_{geom} = {( A / V )}_{avg} ⨯ {V}_{foam} = 4.18 {mm}^{- 1} ⨯ 51 , 300 {mm}^{3} \approx 0.2 \; 15 {m}^{2} .$$

The corresponding mass-specific geometric surface area is

### Usage and Limitations

This CT-resolved geometric area was employed to normalize CO₂ uptake values and enable configuration-level performance comparisons for foams. Given that the voxel resolution cannot resolve sub-voxel roughness or micro-texture, A_{geom} provides a lower bound on the true microscopic surface area; BET-scale features would elevate the actual area. In the absence of micro-CT data, results are reported per unit mass, confining area-normalized analyses to foam.

### Results

### Temperature—CO₂ Time-Series Overview

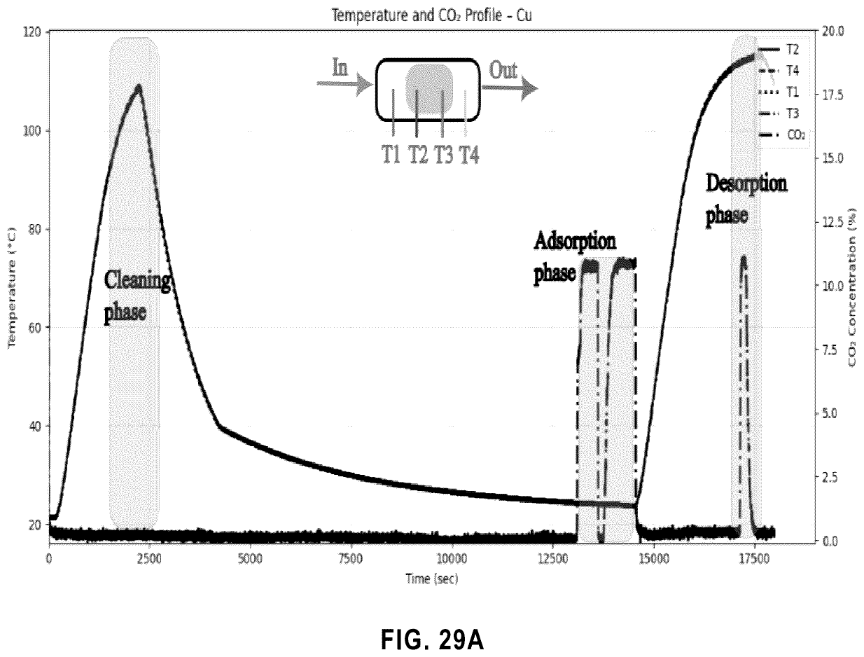

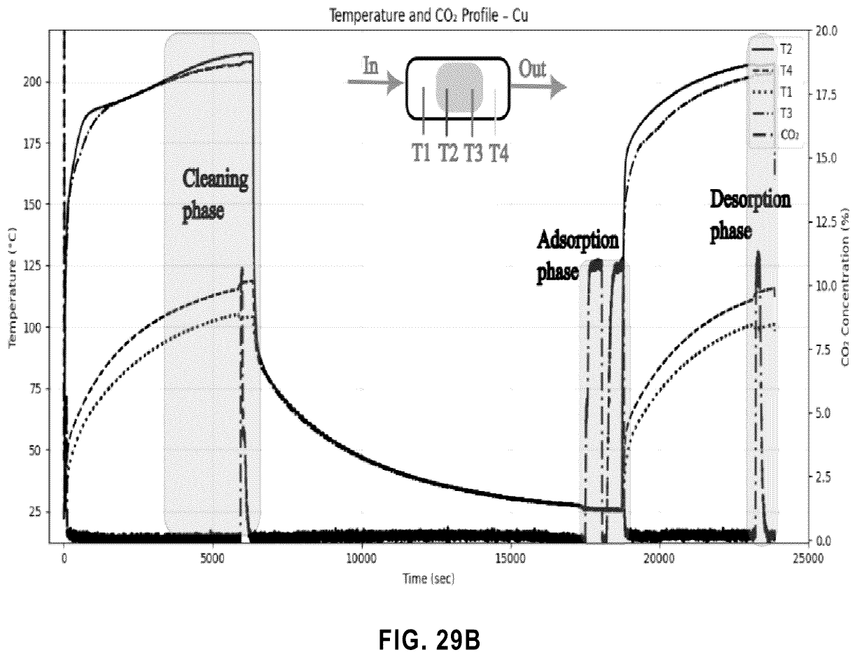

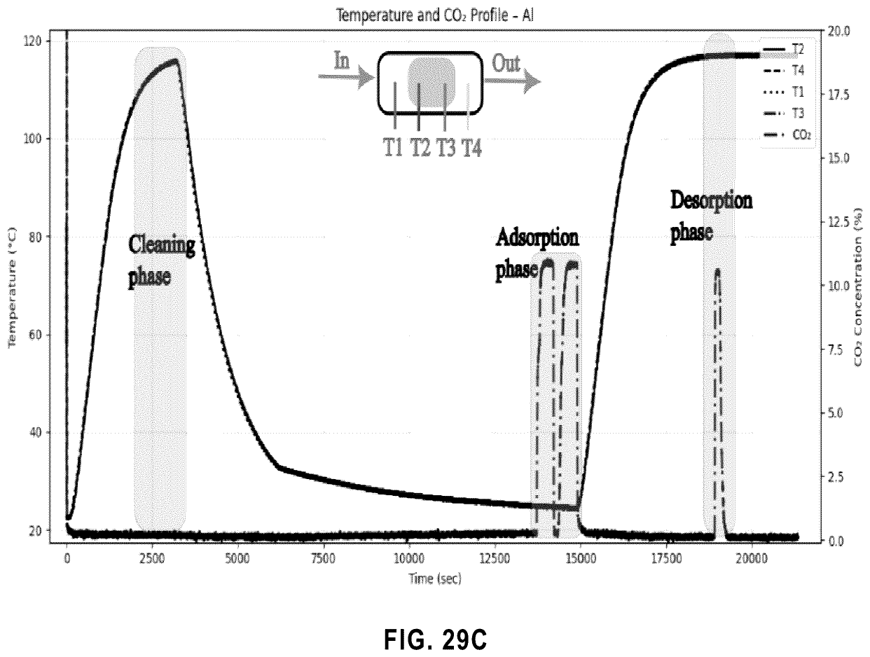

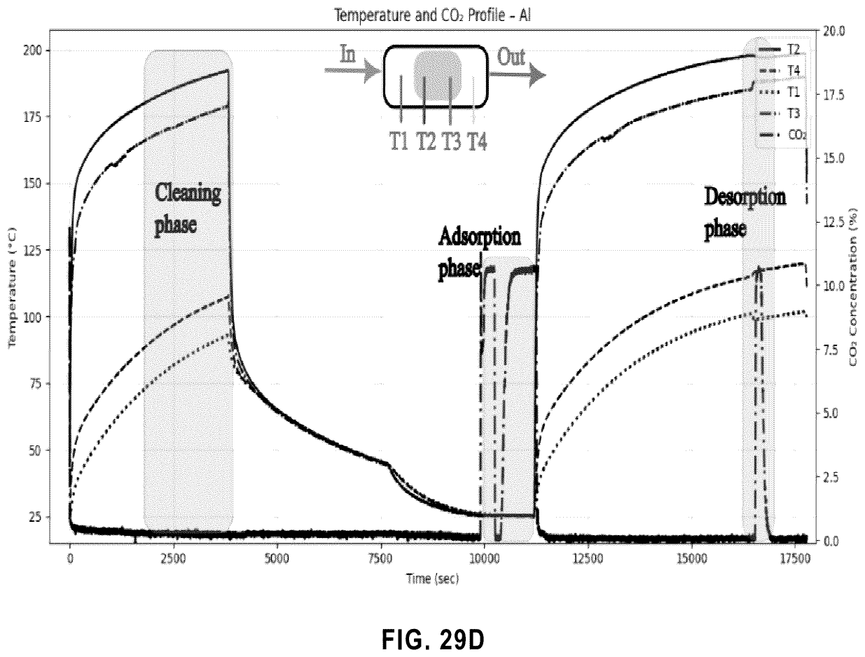

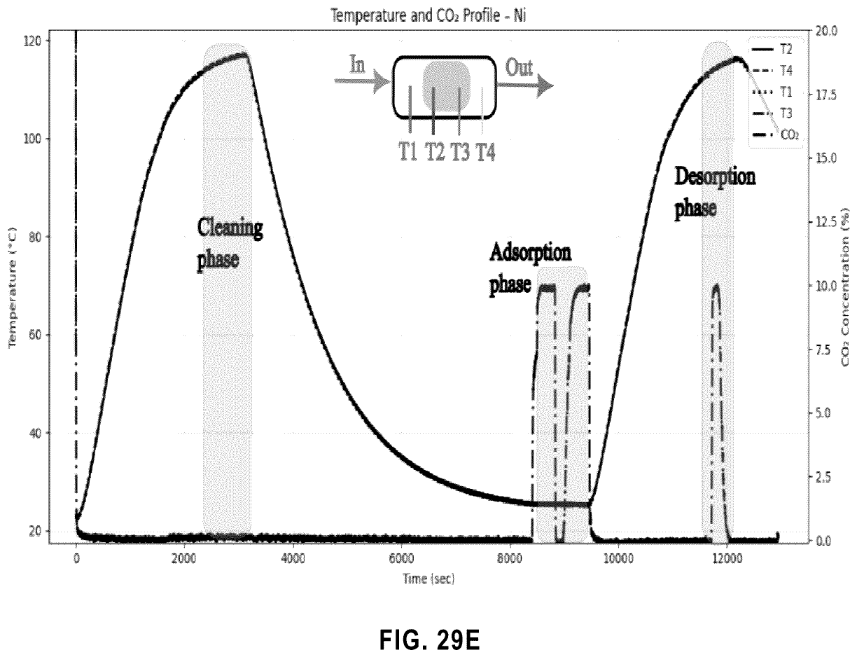

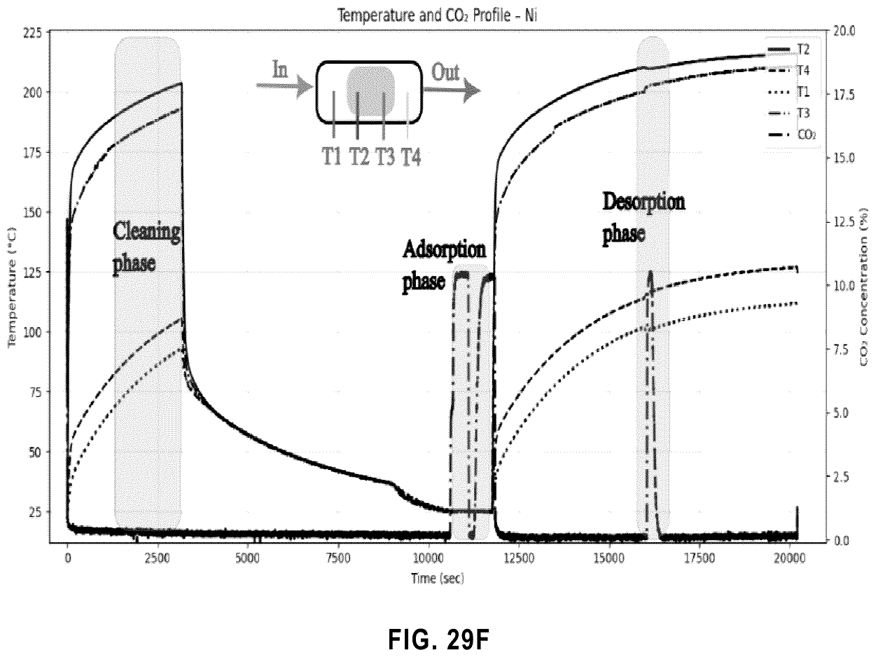

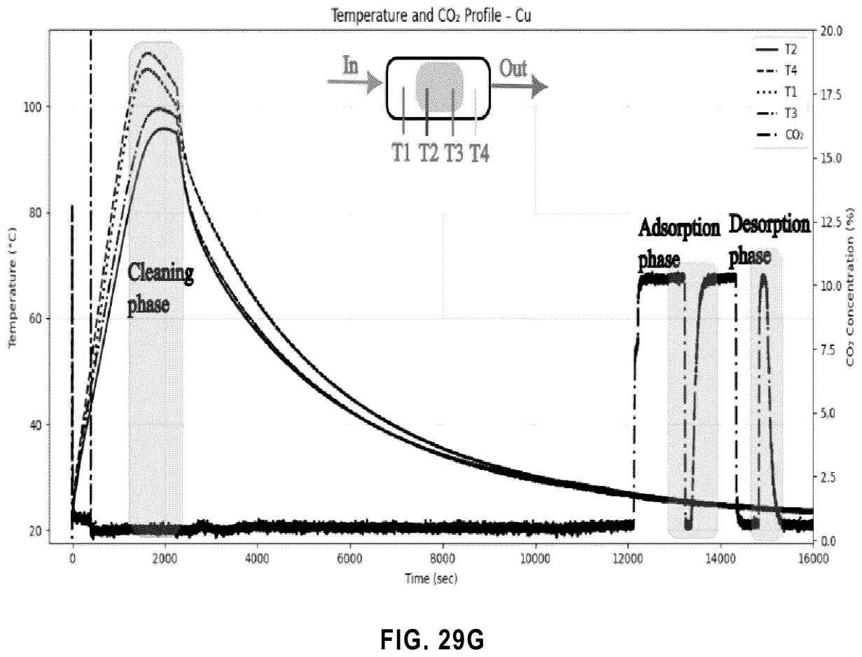

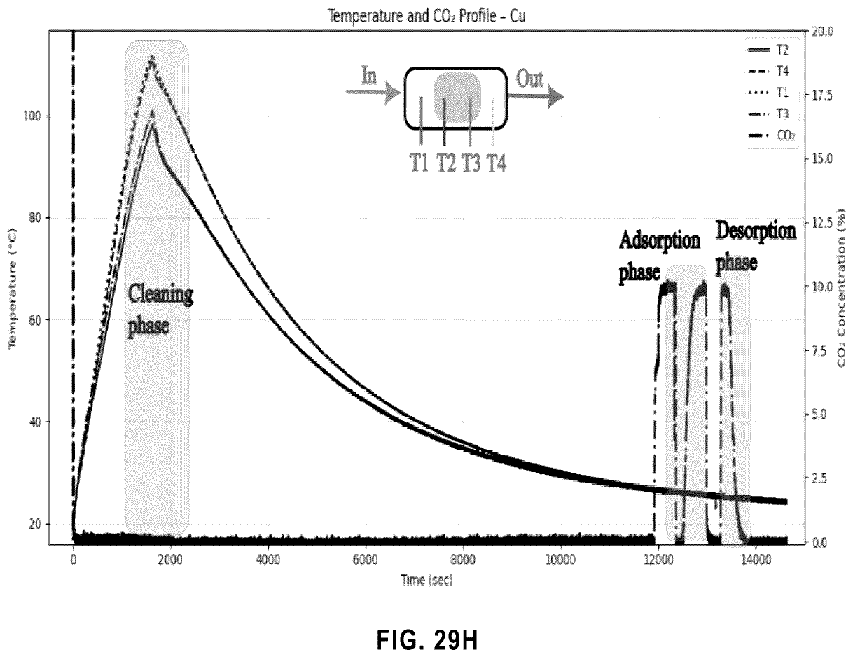

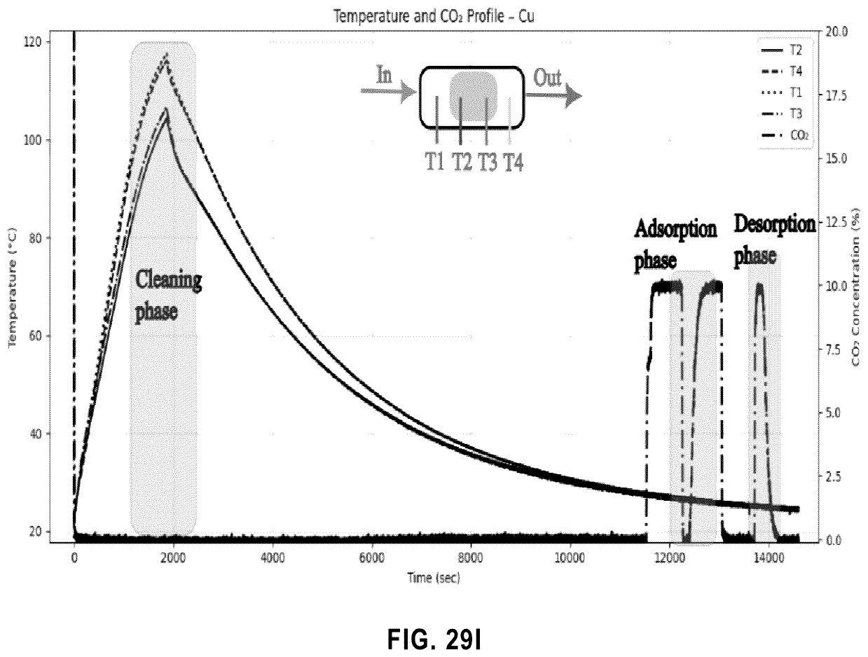

FIG. 29 summarizes representative time series of bed temperature at four axial thermocouples (T1-T4) and the outlet CO₂ signal for Cu, Al, and Ni foams. FIG. 29a), 29c), and 29e) show conventional thermal operation in which desorption is driven by 25→110° C. dark heating, while FIG. 29b), 29d), and 29f) show the corresponding light-assisted runs with illumination through the glass lid; FIGS. 29g), 29h), and 29i) present the Cu runs operated at 25° C./25° C. for the voltage-cycling experiments (0V, +V, and —V, respectively). Shaded bands mark the cleaning phase (high-temperature N₂ purge), the adsorption phase (CO₂/N₂ feed at ≈25° C.), and the desorption phase under thermal, light-assisted, or voltage-assisted conditions. In all cases, the CO₂ trace remains near baseline during cleaning, drops toward zero during adsorption, and exhibits sharp peaks when the bed is heated or when the stimulus (light or voltage) is applied during desorption. In the light-assisted 25→110° C. runs, the thermocouples directly beneath the illuminated region reached peak temperatures on the order of 200° C., whereas the inlet and outlet positions stayed closer to ≈110° C.; the quoted “110° C.” desorption temperature should therefore be interpreted as an average over a non-uniform axial temperature profile. These profiles verify the operating protocol and define the time windows used for computing uptake, working capacity, desorption yield, and voltage-induced release in the subsections that follow.

### CO₂ Adsorption/Desorption Capacities

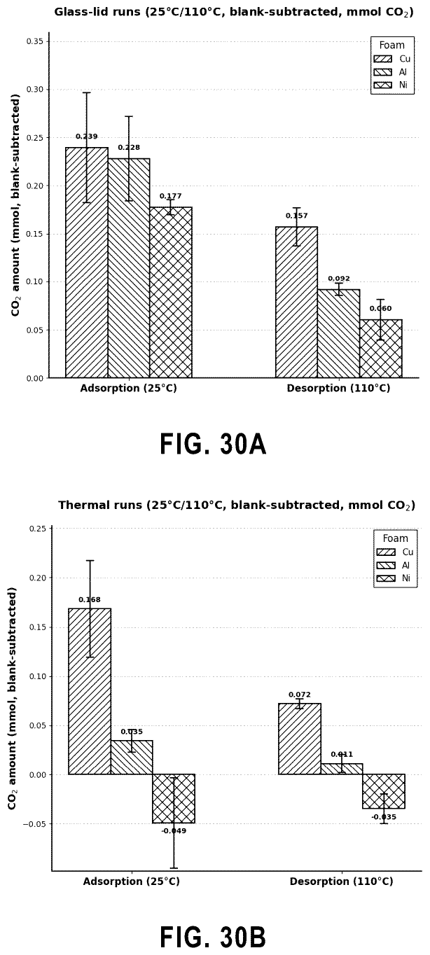

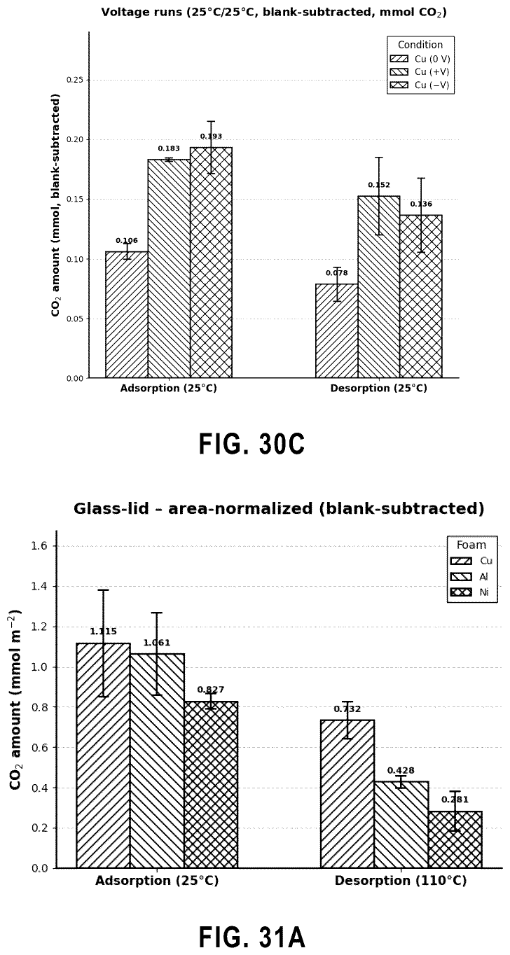

FIG. 30 displays the mean values±1σ from replicate measurements of CO₂ adsorption and desorption for Cu, Al, and Ni foams under three operating modes. For the glass lid and thermal 25° C./110° C. cycles, the net foam signal is obtained by subtracting the blank-bed response from the integrated breakthrough volumes and converting the resulting volumes to moles via the ideal-gas law at the appropriate adsorption (25° C.) or desorption (110° C.) temperature. For the 25° C./25° C. voltage runs, an analogous correction is applied using a dedicated 25° C./25° C. blank run. The plotted quantities therefore represent the net contributions attributable to the foam in each configuration; unless otherwise indicated, values correspond to the plotted means and the error bars denote the inter-run standard deviation.

Under photo-assisted 25° C./110° C. operation, the blank-subtracted adsorption capacities are 0.239±0.057 mmol for Cu, 0.228±0.044 mmol for Al, and 0.177±0.008 mmol for Ni foams. The corresponding desorption amounts are 0.157±0.020 mmol, 0.092±0.007 mmol, and 0.060±0.021 mmol, respectively. Illumination therefore yields net cyclic uptakes on the order of 0.1-0.25 mmol per cycle, with Cu exhibiting the largest absolute capacity and Al and Ni delivering smaller but reproducible responses.

In thermal-only 25° C./110° C. cycles, the net foam contribution is markedly reduced, and Ni becomes indistinguishable from zero within experimental uncertainty. The blank-subtracted adsorption capacities are 0.168±0.049 mmol (Cu), 0.035±0.011 mmol (Al), and −0.049±0.046 mmol (Ni), while the corresponding desorption capacities are 0.072±0.005 mmol (Cu), 0.011±0.009 mmol (Al), and −0.035±0.015 mmol (Ni). The small negative values for Ni simply reflect post-subtraction noise around zero rather than genuine CO₂ release or uptake by the foam.

The right-hand panel of FIG. 30 adds isothermal 25° C./25° C. runs on Cu foam with an applied DC potential. After subtraction of the dedicated 25° C./25° C. blank, the adsorption capacity at 0 V is ≈0.11 mmol, increasing to ≈0.18-0.19 mmol under positive and negative bias. The corresponding desorbed amounts grow from ≈0.08 mmol at 0 V to ≈0.15-0.16 mmol under biased conditions. Thus, at constant temperature, electrical bias alone roughly doubles the net CO₂ released per cycle relative to the unbiased 25° C./25° C. case and brings the isothermal desorption yield close to that achieved in 25° C./110° C. thermal operation.

Taken together, these blank-subtracted measurements show that (i) illumination is essential for eliciting robust positive net adsorption and desorption across all three foams in 25° C./110° C. cycles, (ii) in the absence of light only Cu retains a modest but quantifiable thermal capacity, and (iii) on Cu foam, an applied potential at 25° C./25° C. provides a second, independent control parameter that significantly enhances desorption without the need for a macroscopic temperature swing. The absence of any beneficial illumination effect on the blank bed further confirms that these improvements arise from the intrinsic photo and electro-responsive properties of the metallic frameworks rather than nonspecific chamber heating or instrumental artefacts.

### Area and Mass Normalized CO₂ Uptakes

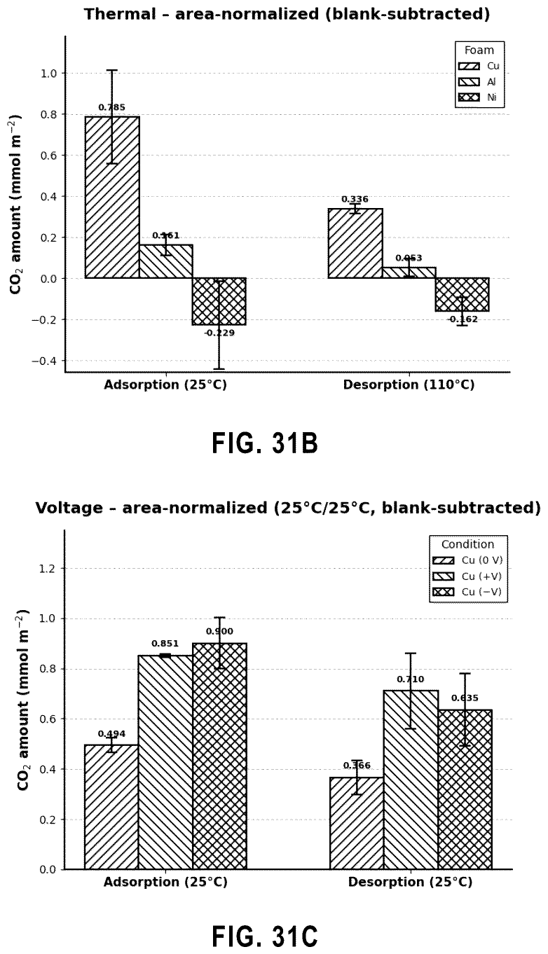

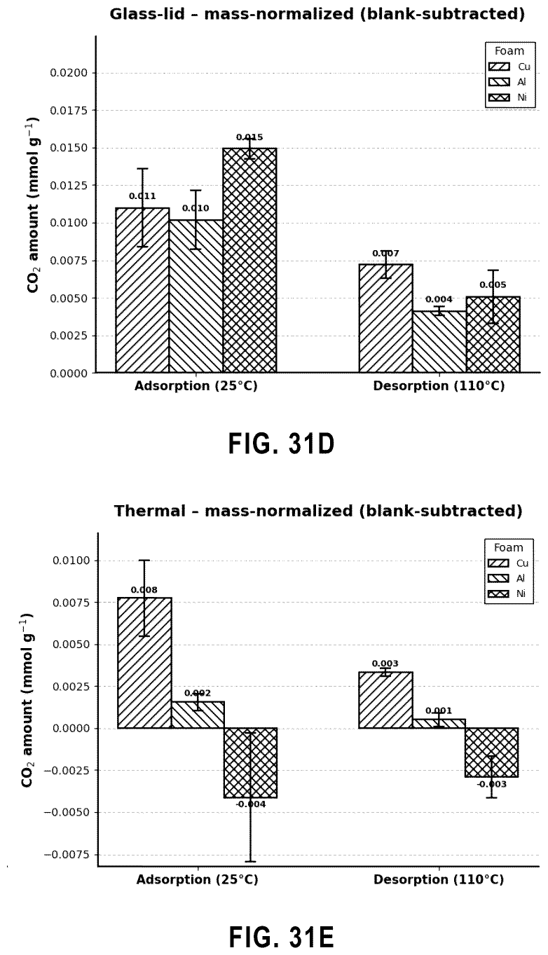

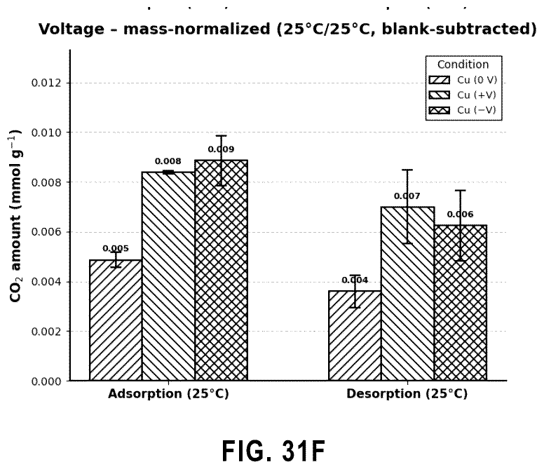

FIG. 31 summarizes the CO₂ uptake capacities normalized by geometric surface area and by foam mass. FIG. 31 (a)-(c) report, respectively, the area-normalized adsorption/desorption amounts for glass-lid (photo-assisted) 25° C./110° C. runs, dark thermal 25° C./110° C. runs, and isothermal 25° C./25° C. voltage runs on Cu foam. FIG. 31 (d)-(f) present the corresponding mass-normalized quantities. Only the metallic foams are shown, after blank-bed correction, expressed in mmolm⁻² and mmolg⁻¹.

Under photo-assisted conditions, the area-normalized adsorption capacities amount to approximately 1.11, 1.06, and 0.82 mmol·m⁻² for Cu, Al, and Ni foams, respectively, with corresponding desorption capacities of 0.73, 0.43, and 0.28 mmol·m⁻². In thermal-only 25° C./110° C. operation (FIG. 31), these decrease to ≈0.78 mmol·m⁻² (Cu), ≈0.16 mmol·m⁻² (Al), and a value statistically indistinguishable from zero for Ni (−0.23 mmol·m⁻² within uncertainty), accompanied by desorption capacities of ≈0.33 mmol·m⁻²(Cu), ≈0.05 mmol·m⁻²(Al), and ≈0 mmol·m⁻²(Ni). For a fixed reactor volume packed with 110-PPI foam, illumination therefore elevates the net CO₂ throughput per square meter of metallic surface into the ≈0.3-1.1 mmol·m⁻² range, substantially exceeding the area-normalized capacities under thermal-only operation.

The 25° C./25° C. voltage runs on Cu foam [FIG. 31(c)] lie in between these two regimes. At 0 V, the area-normalized adsorption and desorption capacities are ≈0.49 and ≈0.36 mmol·m⁻², respectively. Applying either a positive or negative bias increases these to ≈0.85-0.90 mmol·m⁻² for adsorption and ≈0.63-0.71 mmol m⁻² for desorption. Thus, electrical bias recovers much of the areal working capacity of a 25° C./110° C. thermal cycle while keeping the bed at 25° C., suggesting that a combined photo and electro-stimulated mode could further amplify desorption at modest temperature swings.

Mass-normalized capacities [FIGS. 31(d)-(f)] underscore the influence of foam density. Under photo-assisted 25° C./110° C. operation, adsorption capacities reach approximately 1.10×10⁻² mmol·g⁻¹ (Cu), 1.02×10⁻² mmol·g⁻¹ (Al), and 1.49×10⁻² mmol·g⁻¹ (Ni), accompanied by desorption capacities of ≈7.2×10⁻³, 4.1×10⁻³, and 5.0×10⁻³ mmol·g⁻¹, respectively. Thermal operation diminishes these to ≈7.7×10⁻³ mmol·g⁻¹ (Cu) and 1.6×10⁻³ mmol·g⁻¹ (Al) for adsorption, and ≈3.3×10⁻³ (Cu) and ≈5×10⁻⁴ mmol·g⁻¹ (Al) for desorption, with Ni values fluctuating near zero.

For the 25° C./25° C. voltage runs on Cu [FIG. 31(f)], the blank-subtracted adsorption capacity at 0 V is ≈4.9×10⁻³ mmol·g⁻¹, increasing to ≈8-9×10⁻³ mmol·g⁻¹ under biased conditions. The corresponding desorption capacities rise from ≈3.6×10⁻³ mmol·g⁻¹ at 0 V to ≈6-7×10⁻³ mmol·g⁻¹ at finite bias. Although these gravimetric values remain modest compared to high-surface-area sorbents, they mirror the areal trends: illumination and/or electrical bias consistently enhance working capacity, and Ni retains the highest mass-specific response among the three metals because of its lower density and higher porosity.

Comparison with Porous Sorbents

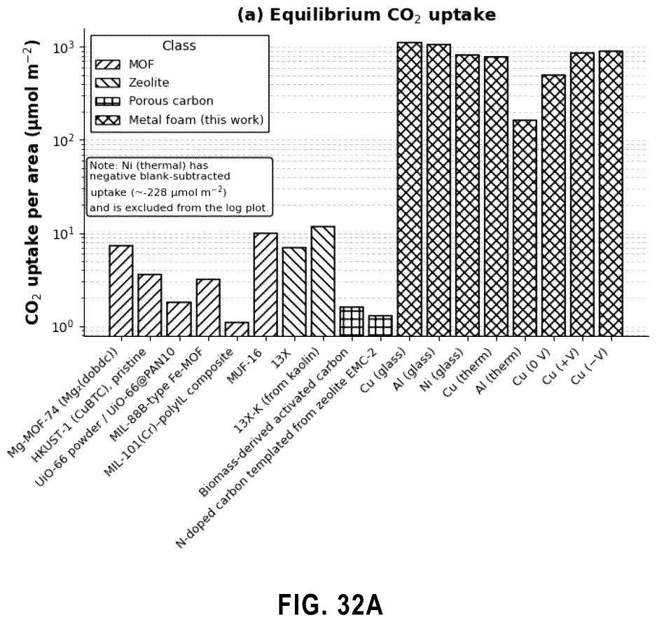

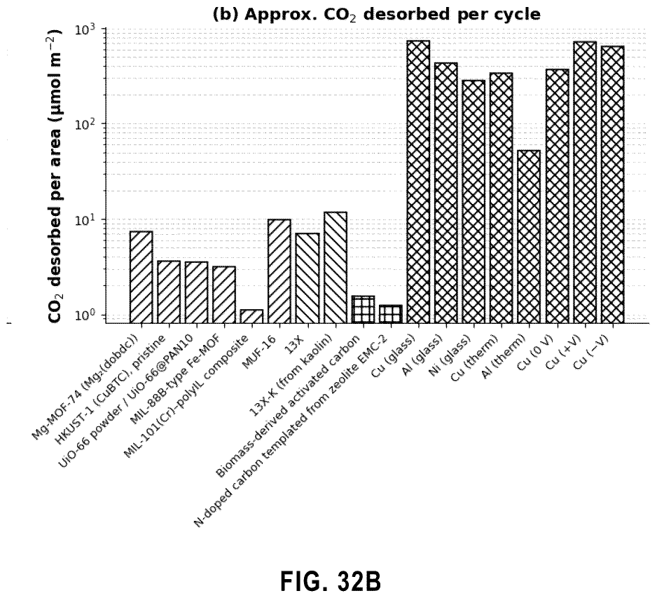

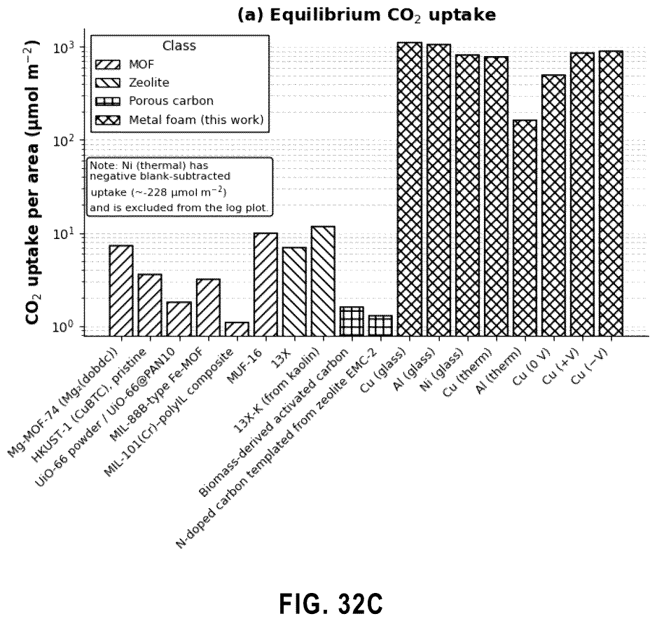

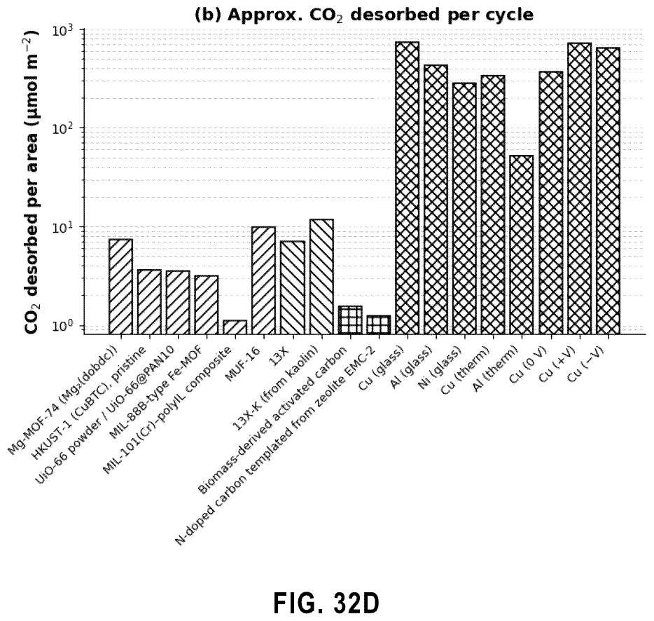

To place these capacities in context, FIG. 32 compares the metallic foams with representative metal-organic frameworks, zeolites, and porous carbons drawn from the literature. For each sorbent, the equilibrium CO₂ uptake at ≈25° C. and standard pressure, together with the approximate CO₂ released across a temperature swing, is reported on both a surface-area basis (μmol·m⁻², using BET area for porous materials and micro-CT-derived geometric area for foams) and a mass basis (mmol·g⁻¹). In addition to the 25° C./110° C. thermal and glass-lid runs, the plots include the isothermal 25° C./25° C. voltage runs on Cu foam at 0 V, +V, and −V.

On a surface-area-normalized basis, conventional porous adsorbents display equilibrium CO₂ uptakes spanning approximately ≈1-12 μmol·m⁻², with desorbed quantities per thermal cycle of comparable magnitude. By contrast, the Cu, Al, and Ni foams examined here exhibit area-normalized capacities that are two to three orders of magnitude larger: under photo-assisted 25° C./110° C. conditions, equilibrium uptakes reach ≈8×10²-1.1×10³ μmol·m⁻² with desorbed amounts of ≈2.8×10²-7.3×10² mol·m⁻². Even in dark 25° C./110° C. operation, Cu and Al foams achieve ≈1.6×10²-8×10² mol·m⁻², whereas Ni's net response remains effectively zero after blank subtraction. The 25° C./25° C. voltage runs on Cu foam fall within the same overall band, with equilibrium capacities of 5×10²—9×10² μmol·m⁻² and desorbed amounts of ≈3.6×10²-7.1×10² μmol·m⁻², achieved without any macroscopic temperature swing. These disparities largely reflect the different surface-area definitions: BET surface area captures the extensive internal pore networks of MOFs and carbons, while micro-CT quantifies only the macroscopic metal ligaments of the foams.

This trend reverses on a mass-normalized basis. Established MOFs, zeolites, and porous carbons typically exhibit equilibrium CO₂ capacities of 2-9 mmol·g⁻¹ with per-cycle desorption of similar magnitude, whereas the present metallic foams attain only ~10⁻² mmol·g⁻¹ even under photo-assisted 25° C./110° C. conditions. The 25° C./25° C. voltage-biased Cu runs likewise remain in the 10⁻³-10⁻² mmol·g⁻¹ range. Accordingly, while metallic foams exploit their restricted geometric surface area very efficiently, and can do so under either photothermal or isothermal voltage-driven operation, they remain intrinsically low-capacity sorbents on a gravimetric basis. This perspective reinforces their role as mechanistic platforms and conductive substrates for high-capacity coatings rather than as stand-alone bulk sorbents.

### CONCLUSION

Employing geometric surface areas derived from micro-CT analysis and blank-subtracted breakthrough-curve integrals, this chapter quantifies the CO₂ uptake capacities of Cu, Al, and Ni foams under dark thermal, photo-assisted, and preliminary voltage-biased conditions, expressed on both area- and mass-normalized bases. For 25° C./110° C. cycles, photo-illumination enhances the net foam contribution from levels often indistinguishable from experimental noise to consistent uptakes of ≈0.2 mmol per cycle. When normalized by the ≈0.215 m² foam surface area and the measured foam masses, these correspond to area-specific capacities of ≈0.3-1.1 mmol·m⁻² and mass-specific capacities on the order of 10⁻² mmol·g⁻¹.

Preliminary 25° C./25° C. runs on Cu foam demonstrate that electrical bias provides an additional lever for manipulating working capacity. After subtraction of a dedicated isothermal blank, the unbiased Cu foam exhibits ≈0.11 mmol of net CO₂ adsorption and ≈0.08 mmol of desorption per cycle, which increase to ≈0.18-0.19 mmol and ≈0.15-0.16 mmol, respectively, under positive or negative bias. In areal terms, this corresponds to ≈0.5 mmol·m⁻² at 0 V and ≈0.85-0.9 mmol·m⁻² under bias, approaching the area-normalized desorption obtained in 25° C./110° C. thermal operation despite the absence of a macroscopic temperature swing.

Area-normalized capacities reveal that, for an adsorbent bed volume packed with 110-PPI foam, the illuminated 25° C./110° C. cycles and biased 25° C./25° C. cycles deliver broadly comparable CO₂ throughput per square meter of metallic surface across Cu, Al, and Ni foams, with minor differences arising from density and porosity. Mass-normalized capacities, by contrast, emphasize Ni's superiority as the lightest and most porous variant, providing roughly 1.5-fold higher photo-assisted adsorption per gram relative to Cu and Al despite their similar area-specific performance.

When benchmarked against metal-organic frameworks, zeolites, and porous carbons, the metallic foams display exceptionally high capacities per unit geometric surface area but markedly low gravimetric capacities. Notably, the foams may be used as adsorbents and/or supports for other adsorbents.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
Abd, A. A., Naji, S. Z., Hashim, A. S. & Othman, M. R. Carbon dioxide removal through physical adsorption using carbonaceous and non-carbonaceous adsorbents: a review. Journal of Environmental Chemical Engineering 8, 104142 (2020). https://doi.org/10.1016/j.jece.2020.104142
Aghel, B., Janati, S., Alobaid, F., Almoslh, A. & Epple, B. Application of nanofluids in CO2 absorption: a review. Applied Sciences 12, 3200 (2022). https://doi.org/10.3390/app12063200
Alvarez, A. et al. Cover Feature: CO2 Activation over Catalytic Surfaces (ChemPhysChem 22/2017). ChemPhysChem 18, 3087-3087 (2017). https://doi.org/10.1002/cphc.201701165
An, K., Li, K., Yang, C.-M., Brechtl, J., and Nawaz, K. (2023). A comprehensive review on regeneration strategies for direct air capture. Journal of CO2 Utilization, 76:102587.
Andrade, M. F. C., Li, S., Pham, T. A., Akhade, S. A., and Pang, S. H. (2024). Machine learning demonstrates the impact of proton transfer and solvent dynamics on co 2 capture in liquid ammonia. Chemical Science, 15(33):13173-13180.
Association, W. N. et al. (2018). Clean coal'technologies, carbon capture & sequestration.
Bader, R. (1990). Atoms in moleculars: a quantum theory.
Bao, Z., Yu, L., Ren, Q., Lu, X., and Deng, S. (2011). Adsorption of co2 and ch4 on a magnesium-based metal organic framework. Journal of colloid and interface science, 353(2):549-556.
Bartok, A. P., Kondor, R., and Csanyi, G. (2013). On representing chemical environments.
Bauer, N. (2006). Carbon capture and sequestration: an option to buy time?PhD thesis.
Bhattacharya, S. (2021). Kinetic study of CO2 absorption in aqueous amine solutions of MEA-AMP: experiment and numerical modeling. The University of Regina (Canada).
Binninger, T., Schmidt, T. J. & Kramer, D. Capacitive electronic metal-support interactions: Outer surface charging of supported catalyst particles. 165405, 1-11 (2017).
Blöchl, P. E. (1994). Projector augmented-wave method. Physical review B, 50(24):17953.
Boer, D. G., Langerak, J., and Pescarmona, P. P. (2023). Zeolites as selective adsorbents for co2 separation. ACS Applied Energy Materials, 6(5):2634-2656.
Bonenfant, D., Kharoune, M., Niquette, P., Mimeault, M., and Hausler, R. (2008). Advances in principal factors influencing carbon dioxide adsorption on zeolites. Science and technology of advanced materials, 9(1):013007.
Brandbyge, M., Hedeg® ard, P., Heinz, T., Misewich, J. & Newns, D. Electronically driven adsorbate excitation mechanism in femtosecond-pulse laser desorption. Physical Review B 52, 6042 (1995). https://doi.org/10.1103/PhysRevB.52.6042
Bright, M. and Lockwood, T. (2022). What does the latest ipcc report say about carbon capture. Clean Air Task Force, available at https://www.catf.us/2022/04/what-does-latest-ipcc-report-say-about-carbon-capture.
Budget, G. C. (2023). Global carbon budget 2023.
Bultinck, P., Van Alsenoy, C., Ayers, P. W. & Carbo-Dorca, R. Critical analysis and extension of the Hirshfeld atoms in molecules. J. Chem. Phys. 126, 144111 (2007).
CaptureMap-endrava by Eric (2024). Strong growth: 1000 carbon capture projects and counting. [Online; accessed 3 Jul. 2025].
Carrascal-Hernandez, D. C., Grande-Tovar, C. D., Mendez-Lopez, M., Insuasty, D., Garcia-Freites, S.,
Sanjuan, M., and Marquez, E. (2025). Co2 capture: A comprehensive review and bibliometric analysis of scalable materials and sustainable solutions. Molecules, 30(3):563.
Chai, Y. H., Rashidi, N. A., Mohamed, M., Chin, B. L. F. & Yusup, S. Chapter 2—Basic principles of CO2 capture and conversion technologies. in Nanomaterials for Carbon Dioxide Capture and Conversion Technologies (eds. Mazari, S. A., Mubarak, N. M. & Tripathi, M.) 25-61 (Elsevier, 2023). doi:https://doi.org/10.1016/B978-0-323-89851-5.00006-8.
Chen, Y. et al. Current advancements towards the use of nanofluids in the reduction of CO2 emission to the atmosphere. Journal of Molecular Liquids 371, 121077 (2023). https://doi.org/10.1016/j.molliq.2022.121077
Christopher, P., Xin, H. & Linic, S. Visible-light-enhanced catalytic oxidation reactions on plasmonic silver nanostructures. Nature chemistry 3, 467-472 (2011). https://doi.org/10.1038/nchem.1032
Climate Watch (2024).—with major processing by our world in data. “buildings” [dataset]. climate watch, “greenhouse gas emissions by sector” [original data]. [online] https://ourworldindata.org/grapher/co-emissions-by-sector.
CO2 removal (2025). Energy use in co2 removal: Key metrics. [online] https://www.oilpriceapi.com/blog/energy-use-in-co2-removal-key-metrics.
Collacique, M. N., Ocampo-Restrepo, V. K. & Da Silva, J. L. F. Ab initio investigation of the role of the d-states on the adsorption and activation properties of CO2 on 3d, 4d, and 5d transition-metal clusters. J. Chem. Phys. 156, (2022).
Controller P. (2025). Operation manual. advanced materials corporation. [Online; accessed 22 May 2024].
Cook, P. J. (2009). Demonstration and deployment of carbon dioxide capture and storage in australia. Energy Procedia, 1(1):3859-3866.
Dang, L.-L., Zong, D.-X., Lu, X.-Y., Zhang, T.-T., Chen, T., Sun, J.-L., Zhao, J.-Z., Liu,
Das, A. et al. Advancements in adsorption based carbon dioxide capture technologies—A comprehensive review. Heliyon 9, e22341 (2023).
Dechamps, P. (2023). The iea world energy outlook 2022—a brief analysis and implica-tions. European Energy & Climate Journal, 11(3):100-103.
Dietz, L., Piccinin, S. & Maestri, M. Mechanistic Insights into CO2 activation via reverse water-gas shift on metal surfaces. The Journal of Physical Chemistry C 119, 4959-4966 (2015). https://doi.org/10.1021/jp512962c
Do, H. H., Rabani, I., and Truong, H. B. (2023). Metal-organic framework-based nanomaterials for co2 storage: A review. Beilstein Journal of Nanotechnology, 14(1):964-970.
Dziejarski, B., Krzyz'yn'ska, R., and Andersson, K. (2023). Current status of carbon capture, utilization, and storage technologies in the global economy: A survey of technical assessment. Fuel, 342:127776.
Ehhalt, D., Prather, M., Dentener, F., Derwent, R., Dlugokencky, E., Holland, E., Isaksen, I., Katima, J.,
Kirchhoff, V., Matson, P., et al. (2001). Atmospheric chemistry and greenhouse gases. Climate change 2001: the scientific basis, Intergovernmental panel on climate change.
ENDESA, C., Revision, F. W., and Ibérica, B. (2014). Oxycfb300 compostilla ccs project: Knowledge sharing feed report.
Etim, U. J., Zhang, C. & Zhong, Z. Impacts of the catalyst structures on CO2 activation on catalyst surfaces. Nanomaterials 11, 3265 (2021). https://doi.org/10.3390/nano11123265
Falconer, J. L., Bischke, S. D. & Hanna, G. J. Electron-enhanced CO2 adsorption and stabilization on aluminum films. Surface science 131, 455-462 (1983). https://doi.org/10.1016/0039-6028(83)90290-X
Falconer, J. L., Bischke, S. D., and Hanna, G. J. (1983). Electron-enhanced co2 adsorption and stabilization on aluminum films. Surface science, 131(2-3):455-462.
Fragkos, P. Assessing the role of carbon capture and storage in mitigation pathways of developing economies. Energies 14, 1879 (2021). https://doi.org/10.3390/en14071879
Fragkos, P. Assessing the role of carbon capture and storage in mitigation pathways of developing economies. Energies 14, (2021).
Fu, L. et al. Research progress on CO2 capture and utilization technology. J. CO2 Util. 66, 102260 (2022).
G. Henkelman (2023). G. henkelman's bader charge analysis software. [Online; accessed 3 Jul. 2025]
Gale, J., Sankovski, A., and Crook, L. (2001). Abatement of emissions of other greenhouse gases nitrous oxide.
Gargiulo, V., Policicchio, A., Lisi, L., and Alfe, M. (2023). Co2 capture and gas storage capacities enhancement of hkust-1 by hybridization with functionalized graphene-like materials. Energy & Fuels, 37(7):5291-5302.
Gheytanzadeh, M., Baghban, A., Habibzadeh, S., Esmaeili, A., Abida, O., Mohad-despour, A., and Munir, M. T. (2021). Towards estimation of co2 adsorption on highly porous mof-based adsorbents using gaussian process regression approach. Scientific Reports, 11(1):15710.
Gheytanzadeh, M., Baghban, A., Habibzadeh, S., Jabbour, K., Esmaeili, A., Mash-hadzadeh, A. H., and Mohaddespour, A. (2022). Intelligent route to design efficient co2 reduction electrocatalysts using anfis optimized by ga and pso. Scientific Reports, 12(1):20859.
Giannozzi, P. et al. QUANTUM ESPRESSO: a modular and open-source software project for quantum simulations of materials. Journal of physics: Condensed matter 21, 395502 (2009). https://doi.org/10.1063/5.0005082
Giannozzi, P., Baseggio, O., Bonfa, P., Brunato, D., Car, R., Carnimeo, I., Cavazzoni, C., De Gironcoli, S., Delugas, P., Ferrari Ruffino, F., et al. (2020). Quantum espresso toward the exascale. The Journal of chemical physics, 152(15).
Giri, R. et al. Mechanism of the Ullmann Biaryl Ether Synthesis Catalyzed by Complexes of Anionic Ligands: Evidence for the Reaction of lodoarenes with Ligated Anionic CuI Intermediates. J. Am. Chem. Soc. 140, 793-806 (2018).
Global Carbon Budget (2024). Fossil fuel co2 emissions increase again in 2024. [Online; accessed 3 Jul. 2025].
Goedecker, S. & Teter, M. Separable dual-space Gaussian pseudopotentials. Phys. Rev. B—Condens. Matter Mater. Phys. 54, 1703-1710 (1996).
Goswami, R. & Qadri, S. B. Evidence of Delta Phase of Fe in MBE-Grown Thin Epitaxial Films on GaAs. (2022).
Gouedard, C., Picq, D., Launay, F. & Carrette, P.-L. Amine degradation in CO2 capture. I. A review. International journal of greenhouse gas control 10, 244-270 (2012). https://doi.org/10.1016/j.ijggc.2012.06.015
Govindasamy, B. and Caldeira, K. (2000). Geoengineering earth's radiation balance to mitigate co2-induced climate change. Geophysical Research Letters, 27(14):2141-2144.
Grimme, S., Antony, J., Ehrlich, S. & Krieg, H. A consistent and accurate ab initio parametrization of density functional dispersion correction (DFT-D) for the 94 elements H-Pu. J. Chem. Phys. 132, (2010).
Grimme, S., Ehrlich, S. & Goerigk, L. Effect of the damping function in dispersion corrected density functional theory. J. Comput. Chem. 32, 1456-1465 (2011).
Grubler, A., Jefferson, M., and Nakic'enovic', N. (1996). Global energy perspectives: A summary of the joint study by the international institute for applied systems analysis and world energy council. Technological Forecasting and Social Change, 51(3):237-264.
Haigh, J. D. (2002). Radiative forcing of climate change. Weather, 57(8):278-283.
Hamdy, L. B., Gougsa, A., Chow, W. Y., Russell, J. E., Garcia-Diez, E., Kulakova, V., Garcia, S., Barron, A. R., Taddei, M., and Andreoli, E. (2022). Overcoming mass transfer limitations in cross-linked polyethyleneimine-based adsorbents to enable selective co 2 capture at ambient temperature. Materials Advances, 3(7):3174-3191.
Harnisch, J., Hendriks, C., and Jager, D. (2001). Evaluation of reduction options of emissions of hfcs, pfcs and sf6. In 5th International Conference on Greenhouse Gas Control Technologies, pages 685-690.
Hatami, H., Khani, M., Rad, S. A. R., and Shokri, B. (2024). Co2 conversion in a dielectric barrier discharge plasma by argon dilution over mgo/hkust-1 catalyst using response surface methodology. Heliyon, 10(4).
Hausler, J., Pasel, J., Woltmann, F., Everwand, A., Meledina, M., Valencia, H., Lipin'ska-Chwatek, M., Mayer, J., and Peters, R. (2021). Elucidating the influence of the d-band center on the synthesis of isobutanol. Catalysts, 11(3):406.
Hazra, B., Vishal, V., Sethi, C., and Chandra, D. (2022). Impact of supercritical co2 on shale reservoirs and its implication for co2 sequestration. Energy & Fuels, 36(17):9882-9903.
Henkelman, G., Arnaldsson, A., and Jonsson, H. (2006). A fast and robust algorithm for bader decomposition of charge density. Computational Materials Science, 36(3):354-360.
Heuberger, C. F., Staffell, I., Shah, N. & Mac Dowell, N. Quantifying the value of CCS for the future electricity system. Energy Environ. Sci. 9, 2497-2510 (2016).
Heydari-Gorji, A. and Sayari, A. (2012). Thermal, oxidative, and co2-induced degra-dation of supported polyethylenimine adsorbents. Industrial & Engineering Chemistry Research, 51(19):6887-6894.
Hoffert, M. I., Caldeira, K., Benford, G., Criswell, D. R., Green, C., Herzog, H., Jain,
Hohenberg, P. and Kohn, W. (1964). Inhomogeneous electron gas. Physical review, 136(3B):B864.
Hsing, C., Chang, C., Cheng, C. & Wei, C. Quantum Monte Carlo Studies of CO Adsorption on Transition Metal Surfaces. (2019) doi:10.1021/acs.jpcc.9b03780.
Humphreys, J., Lan, R. & Tao, S. Development and Recent Progress on Ammonia Synthesis Catalysts for Haber-Bosch Process. Adv. Energy Sustain. Res. 2, (2021).
IEA (2021). About ccus, iea, paris. [online] https://www.iea.org/reports/about-ccus.
IEA (2024). Carbon capture utilization and storage. [online] https://www.iea.org/energy-system/carbon-capture-utilisation-and-storage.
IEA (2025). Ccus projects around the world are reaching new milestones, iea, paris. [online] https://www.iea.org/commentaries/ccus-projects-around-the-world-are-reaching-new-milestones.
IEA, I. Energy technology perspectives 2020. International Energy Agency (2020).
Inderwildi, O. R. & Jenkins, S. J. In-silico investigations in heterogeneous catalysis-Combustion and synthesis of small alkanes. Chemical Society Reviews 37, 2274-2309 (2008). DOI https://doi.org/10.1039/B719149A
Jackson, S. and Brodal, E. (2019). Optimization of the energy consumption of a carbon capture and sequestration related carbon dioxide compression processes. Energies, 12(9):1603.
Jafarzadeh, A., Bal, K. M., Bogaerts, A. & Neyts, E. C. Activation of CO2 on Copper Surfaces: The Synergy between Electric Field, Surface Morphology, and Excess Electrons. J. Phys. Chem. C 124, 6747-6755 (2020).
Jafarzadeh, A., Bal, K. M., Bogaerts, A. & Neyts, E. C. CO2 Activation on TiO 2—Supported Cu 5 and Ni 5 Nanoclusters: Effect of Plasma-Induced Surface Charging. (2019) doi:10.1021/acs.jpcc.8b11816.
Jedli, H., Bouzgarrou, S. M., Hassani, R., Sabi, E., and Slimi, K. (2024). Adsorption of co2, ch4 and h2 onto zeolite 13 x: Kinetic and equilibrium studies. Heliyon, 10(23).
Jiang, L. et al. Sorption direct air capture with CO2 utilization. Prog. Energy Combust. Sci. 95, 101069 (2023).
Kale, M. J., Avanesian, T., Xin, H., Yan, J. & Christopher, P. Controlling catalytic selectivity on metal nanoparticles by direct photoexcitation of adsorbate-metal bonds. Nano letters 14, 5405-5412 (2014). https://doi.org/10.1021/nl502571b
Kanai, Y., Khalap, V. R., Collins, P. G. & Grossman, J. C. Atomistic Oxidation Mechanism of a Carbon Nanotube in Nitric Acid. 066401, 1-4 (2010).
Kanitpanyacharoen, W. et al. Significance of mechanical twinning in hexagonal metals at high pressure. Acta materialia 60, 430-442 (2012). https://doi.org/10.1016/j.actamat.2011.07.055
Kazlou, T., Cherp, A., and Jewell, J. (2024). Feasible deployment of carbon capture and storage and the requirements of climate targets. Nature Climate Change, 14(10):1047-1055.
Kenichi, T. (1995). Zn under pressure: A singularity in the hcp structure at c/a=3. Physical review letters, 75(9):1807.
Kheshgi, A. K., et al. (2002). Advanced technology paths to global climate stability: energy for a greenhouse planet. science, 298(5595):981-987.
Kim, C., Suh, B. L., Yun, H., Kim, J. & Lee, H. Surface plasmon aided ethanol dehydrogenation using Ag—Ni binary nanoparticles. ACS Catalysis 7, 2294-2302 (2017). https://doi.org/10.1021/acscatal.7b00411
Kim, Y., Dumett Torres, D. & Jain, P. K. Activation energies of plasmonic catalysts. Nano letters 16, 3399-3407 (2016). https://doi.org/10.1021/acs.nanolett.6b01373
Kingsmill Bond (2021). The sky's the limit: Solar and wind energy potential is 100 times as much as global energy demand. [Online; accessed 3 Jul. 2025].
Ko, J., Kim, B.-K. & Han, J. W. Density functional theory study for catalytic activation and dissociation of CO2 on bimetallic alloy surfaces. The Journal of Physical Chemistry C 120, 3438-3447 (2016). https://doi.org/10.1021/acs.jpcc.6b00221
Kohn, W. and Sham, L. J. (1965). Self-consistent equations including exchange and correlation effects. Physical review, 140(4 Å):A1133.
Kokalj, A. (1999). Xcrysden—a new program for displaying crystalline structures and electron densities. Journal of Molecular Graphics and Modelling, 17(3-4):176-179.
KR20230018770
Kraskov, A., Stogbauer, H. & Grassberger, P. Erratum: estimating mutual information [Phys. Rev. E 69, 066138 (2004)]. Physical Review E 83, 019903 (2011). https://doi.org/10.1103/PhysRevE.69.066138
Kresse, G. and Joubert, D. (1999). From ultrasoft pseudopotentials to the projector augmented-wave method. Physical review b, 59(3):1758.
Krupski, K., Moors, M., Jozwik, P., Kobiela, T. & Krupski, A. Structure determination of Au on Pt (111) surface: LEED, STM and DFT study. Materials 8, 2935-2952 (2015). https://doi.org/10.3390/ma8062935
Kuo, D.-Y. et al. Measurements of oxygen electroadsorption energies and oxygen evolution reaction on RuO2 (110): a discussion of the sabatier principle and its role in electrocatalysis. Journal of the American Chemical Society 140, 17597-17605 (2018). https://doi.org/10.1021/jacs.8b09657
Kwawu, C. R., Tia, R., Adei, E., Dzade, N. Y., Catlow, C. R. A., and De Leeuw, N. H. (2017). Co 2 activation and dissociation on the low miller index surfaces of pure and ni-coated iron metal: a dft study. Physical Chemistry Chemical Physics, 19(29):19478-19486.
Lau, H. C., Ramakrishna, S., Zhang, K., and Radhamani, A. V. (2021). The role of carbon capture and storage in the energy transition. Energy & Fuels, 35(9):7364-7386.
Lee, J. G. (2016). Computational materials science: an introduction. CRC press.
Leick, N., Halingstad, S., Crawford, J., Carroll, M., Yung, M., Cortright, R., and Braunecker, W. (2024). Photo-swing co2 capture using aminopolymers as sorbents and tin light absorber.
Li, H., Martinez, M. R., Perry, Z., Zhou, H.-C., Falcaro, P., Doblin, C., Lim, S., Hill, A. J., Halstead, B., and Hill, M. R. (2016). A robust metal-organic framework for dynamic light-induced swing adsorption of carbon dioxide. Chemistry—A European Journal, 22(32):11176-11179.
Li, R. et al. d-band center engineering of single Cu atom and atomic Ni clusters for enhancing electrochemical CO2 reduction to CO. J. Colloid Interface Sci. 674, 326-335 (2024).
Li, S., Chen, R., Wang, J., Deng, S., Zhou, H., Fang, M., Zhang, H., and Yuan, X. (2024). Solar thermal energy-assisted direct capture of co2 from ambient air for methanol synthesis. npj Materials Sustainability, 2(1):11.
Liu, C., Cundari, T. R. & Wilson, A. K. CO2 reduction on transition metal (Fe, Co, Ni, and Cu) surfaces: In comparison with homogeneous catalysis. The Journal of Physical Chemistry C 116, 5681-5688 (2012). https://doi.org/10.1021/jp210480c
Liu, C., Cundari, T. R. & Wilson, A. K. CO2 Reduction on Transition Metal (Fe, Co, Ni, and Cu) Surfaces: In Comparison with Homogeneous Catalysis. J. Phys. Chem. C 116, 5681-5688 (2012).
Liu, G., Wang, J., and Shen, Y. (2018). Density functional theory study of {101 n} twin boundaries of zn under high pressure. Computational Materials Science, 151:106-116.
Liu, Q., Ning, L., Zheng, S., Tao, M., Shi, Y., and He, Y. (2013). Adsorption of carbon dioxide by mil-101 (cr): regeneration conditions and influence of flue gas contaminants. Scientific reports, 3(1):2916.
Liu, T. & Li, D. Convergence of the BFGS-SQP method for degenerate problems. Numer. Funct. Anal. Optim. 28, 927-944 (2007).
Liu, X., Sun, L. & Deng, W.-Q. Theoretical investigation of CO2 adsorption and dissociation on low index surfaces of transition metals. The Journal of Physical Chemistry C 122, 8306-8314 (2018). https://doi.org/10.1021/acs.jpcc.7b12660
M.-Y., and Liu, S.-R. (2022). The selective co2 adsorption and photothermal conversion study of an azo-based cobalt-mof material. Molecules, 27(20):6873.
Maaza, M. et al. A novel approach for engineering efficient nanofluids by radiolysis. Scientific Reports 12, 10767 (2022). https://doi.org/10.1038/s41598-022-14540-z
Martyna, G. J. & Tuckerman, M. E. A reciprocal space based method for treating long range interactions in ab initio and force-field-based calculations in clusters. J. Chem. Phys. 110, 2810-2821 (1999).
Martynov, S., Zheng, W., Brown, S., and Mahgerefteh, H. (2016). Numerical simulation of co2 flows in pipes with phase transition across the triple point.
Masson-Delmotte, V. et al. Global Warming of 1.5 C: IPCC special report on impacts of global warming of 1.5 C above pre-industrial levels in context of strengthening response to climate change, sustainable development, and efforts to eradicate poverty (Cambridge University Press, 2022). https://doi.org/10.1017/9781009157940
Mbambo, M. et al. Remarkable thermal conductivity enhancement in Ag-decorated graphene nanocomposite based nanofluid by laser liquid solid interaction in ethylene glycol. Scientific Reports 10, 10982 (2020). https://doi.org/10.1038/s41598-020-67418-3
Mbambo, M. et al. Thermal conductivity enhancement in gold decorated graphene nanosheets in ethylene glycol based nanofluid. Scientific Reports 10, 14730 (2020). https://doi.org/10.1038/s41598-020-71740-1
McQueen, N. et al. A review of direct air capture (DAC): Scaling up commercial technologies and innovating for the future. Prog. Energy 3, 0-22 (2021).
Mehra, J. (1988). Erwin schrödinger and the rise of wave mechanics. iii. early response and applications. Foundations of physics, 18(2):107-184.
Methfessel, M. & Paxton, A. High-precision sampling for Brillouin-zone integration in metals. physical review B 40, 3616 (1989). https://doi.org/10.1103/PhysRevB.40.3616
Metz, B., Davidson, O., De Coninck, H., Loos, M., and Meyer, L. (2005). IPCC special report on carbon dioxide capture and storage. Cambridge: Cambridge University Press.
Miehlich, B., Savin, A., Stoll, H., and Preuss, H. (1989). Results obtained with the correlation energy density functionals of becke and lee, yang and parr. Chemical Physics Letters, 157(3):200-206.
Mohamed, H. et al. Room temperature bio-engineered multifunctional carbonates for CO2 sequestration and valorization. Scientific Reports 13, 16783 (2023). https://doi.org/10.1038/s41598-023-42905-5
Monkhorst, H. J. and Pack, J. D. (1976). Special points for brillouin-zone integrations. Physical review B, 13(12):5188.
Monne, J., Jammes, L., Gaucher, E., Labat, N., Urbancyk, C., Thibeau, S., Prinet, C., Payre, X., Schuhler, T., Pourtoy, D., et al. (2015). Carbon capture and storage: The lacq pilot. project and injection period 2006-2013. Total: Paris, France, page 276.
Mutschler, R., Moioli, E., Luo, W., Gallandat, N. & Zuttel, A. CO2 hydrogenation reaction over pristine Fe, Co, Ni, Cu and Al₂O₃ supported Ru: Comparison and determination of the activation energies. J. Catal. (2018) doi:10.1016/J.JCAT.2018.08.002.
Ngo, H. M., Pal, U., Kang, Y. S., and Ok, K. M. (2023). Dft-based study for the enhancement of co2 adsorption on metal-doped nitrogen-enriched polytriazines. ACS omega, 8(9):8876-8884.
Nguyen, D., Stolaroff, J., and Esser-Kahn, A. (2015). Solvent effects on the photother-mal regeneration of co2 in monoethanolamine nanofluids. ACS Applied Materials & Interfaces, 7(46):25851-25856.
Nilsson, A., Pettersson, L. G. & Norskov, J. Chemical bonding at surfaces and interfaces (Elsevier, 2011).
Nocedal, J. Updating Quasi-Newton Matrices with Limited Storage. Math. Comput. 35, 773 (1980).
Novoselov, K. S. et al. Two-dimensional gas of massless Dirac fermions in graphene. 438, 197-200 (2005).
Ocampo-Restrepo, V. K., Zibordi-Besse, L. & Da Silva, J. L. F. Ab initio investigation of the atomistic descriptors in the activation of small molecules on 3 d transition-metal 13-atom clusters: The example of H2, CO, H2O, and CO2. J. Chem. Phys. 151, (2019).
of Standards, N. I. and Technology (2025). Nist chemistry web book, srd 69. Technical Report Federal Information Processing Standards Publications (FIPS) 140-2, Change Notice 2 Dec. 3, 2002, U.S. Department of Commerce, Washington, D.C.
Ong, S. P. et al. Python Materials Genomics (pymatgen): A robust, open-source python library for materials analysis. Computational Materials Science 68, 314-319 (2013). https://doi.org/10.1016/j.commatsci.2012.10.028
Oschatz, M. and Antonietti, M. (2018). A search for selectivity to enable co 2 capture with porous adsorbents. Energy & Environmental Science, 11(1):57-70.
Otani, M. & Sugino, O. First-principles calculations of charged surfaces and interfaces: A plane-wave nonrepeated slab approach. Physical Review B 73, 115407 (2006). https://doi.org/10.1103/PhysRevB.73.115407
Page, B., Turan, G., Zapantis, A., Burrows, J., Consoli, C., Erikson, J., Havercroft, I., Kearns, D., Liu, H., Rassool, D., et al. (2023). The global status of ccs 2023: vital to achieve net zero.
Parisio, F. and Vilarrasa, V. (2020). Sinking co2 in supercritical reservoirs. Geophysical Research Letters, 47(23):e2020GL090456.
Paschke, B. and Kather, A. (2012). Corrosion of pipeline and compressor materials due to impurities in separated co2 from fossil-fueled power plants. Energy Procedia, 23:207-215.
Perdew, J. P., Burke, K. & Ernzerhof, M. Generalized Gradient Approximation Made Simple. Phys. Rev. Lett. 77, 3865-3868 (1996).
Perdew, J. P., Burke, K., and Wang, Y. (1996). Generalized gradient approxima-tion for the exchange-correlation hole of a many-electron system. Physical Review B, 54(23):16533.
Physical Review B—Condensed Matter and Materials Physics, 87(18):184115.
Plaza, M., Garcia, S., Rubiera, F., Pis, J. & Pevida, C. Post-combustion CO2 capture with a commercial activated carbon: comparison of different regeneration strategies. Chemical Engineering Journal 163, 41-47 (2010). https://doi.org/10.1016/j.cej.2010.07.030
Porosoff, M. D., Yan, B. & Chen, J. G. Catalytic reduction of CO2 by H2 for synthesis of CO, methanol and hydrocarbons: challenges and opportunities. Energy & Environmental Science 9, 62-73 (2016). DOI: 10.1039/C5EE02657 Å
Prasetya, N. and Ladewig, B. P. (2017). Dynamic photo-switching in light-responsive juc-62 for co 2 capture. Scientific Reports, 7(1):13355.
Purity for transport (2025). Ccs: what co2 purity for trans-port and disposal? [online] https://thundersaidenergy.com/downloads/ccs-what-co2-purity-for-transport-and-disposal/#:−:text=CCS%3A%20what%20CO2%20purity%20for,for%20CO2%20shipping%2Ftrucking.
Qazvini, O. T. and Telfer, S. G. (2019). A universal porous adsorbent for the selective capture of carbon dioxide.
Qazvini, O. T., Babarao, R., and Telfer, S. G. (2021). Selective capture of carbon dioxide from hydrocarbons using a metal-organic framework. Nature communications, 12(1):197.
Qiao, Y., Bailey, J. J., Huang, Q., Ke, X., and Wu, C. (2022). Potential photo-switching sorbents for co2 capture—a review. Renewable and Sustainable Energy Reviews, 158:112079.
Raimi, D., Zhu, Y., Newell, R. G., and Prest, B. C. (2024). Global energy outlook 2024: Peaks or plateaus. Resources for the future.
Rajendran, A., Kariwala, V., and Farooq, S. (2008). Correction procedures for extra-column effects in dynamic column breakthrough experiments. Chemical engineering science, 63(10):2696-2706.
Rayne, S. (2008). Thermal carbon dioxide splitting: A summary of the peer-reviewed scientific literature. Nature Precedings, pages 1-1.
Reddy, M. S. B., Ponnamma, D., Sadasivuni, K. K., Kumar, B., and Abdullah, A. M. (2021). Carbon dioxide adsorption based on porous materials. RSC advances, 11(21):12658-12681.
Ribeiro, R. P. P. L., Grande, C. A. & Rodrigues, A. E. Electric Swing Adsorption for Gas Separation and Purification: A Review. Sep. Sci. Technol. 49, 1985-2002 (2014).
Robatjazi, H. et al. Plasmon-induced selective carbon dioxide conversion on earth-abundant aluminum-cuprous oxide antenna-reactor nanoparticles. Nature communications 8, 27 (2017). https://doi.org/10.1038/s41467- 017-00055-z
Ross, B. C. Mutual information between discrete and continuous data sets. PloS one 9, e87357 (2014). https://doi.org/10.1371/journal.pone.0087357
Rusu, P. C., Giovannetti, G., Weijtens, C., Coehoorn, R. & Brocks, G. First-principles study of the dipole layer formation at metal-organic interfaces. 1-18 (2018).
Sahu, T., Eke, V., Ghuman, K. K., et al. (2025). Solar-driven photothermal desorption of co2 from pei-infused silica gel. Applied Thermal Engineering, page 129459.
Sahu, T., Ghuman, K. K. & 0 Brien, P. G. A review of materials used for carbon dioxide capture. Progress in Sustainable Development, 205-232 (2023). https://doi.org/10.1016/B978-0-323-99207-7.00003-8
Sahu, T., O'Brien, P. G. & Ghuman, K. K. Harvesting surface charges on metals for energy-efficient CO2 capture: A first-principles investigation. Sustain. Mater. Technol. 39, e00843 (2024).
Saini, S., Halldin Stenlid, J., and Abild-Pedersen, F. (2022). Electronic structure factors and the importance of adsorbate effects in chemisorption on surface alloys. npj Computational Materials, 8(1):163.
Sandhu, N. K., Pudasainee, D., Sarkar, P., and Gupta, R. (2016). Steam regenera-tion of polyethylenimine-impregnated silica sorbent for postcombustion co2 capture: a multicyclic study. Industrial & Engineering Chemistry Research, 55(7):2210-2220.
Sanville, E., Kenny, S. D., Smith, R., and Henkelman, G. (2007). Improved grid-based algorithm for bader charge allocation. Journal of computational chemistry, 28(5):899-908.
Sanz, R., Calleja, G., Arencibia, A., and Sanz-Pérez, E. (2010). Co2 adsorption on branched polyethyleneimine-impregnated mesoporous silica sba-15. Applied Surface Science, 256(17):5323-5328.
Sanz-Pérez, E., Murdock, C., Didas, S. & Jones, C. Direct Capture of CO2 from Ambient Air. Chem. Rev. 116 19, 11840-11876 (2016).
Sarofim, M. C., Smith, C. J., Malek, P., McDuffie, E. E., Hartin, C. A., Lay, C. R., and McGrath, S. (2024). High radiative forcing climate scenario relevance analyzed with a ten-million-member ensemble. Nature communications, 15(1):8185.
Sattler, J. J., Ruiz-Martinez, J., Santillan-Jimenez, E. & Weckhuysen, B. M. Catalytic dehydrogenation of light alkanes on metals and metal oxides. Chemical reviews 114, 10613-10653 (2014). https://doi.org/10.1021/cr5002436
Sema, T., Naami, A., Liang, Z., Shi, H., Rayer, A. V., Sumon, K. Z., Wattanaphan, P., Henni, A., Idem, R., Saiwan, C., et al. (2012). Part 5b: Solvent chemistry: reaction kinetics of co2 absorption into reactive amine solutions. Carbon Management, 3(2):201-220.
Sigma-Aldrich (2025). Milliporesigma. (n.d.). silica gel 60, 70-230 mesh, for column chromatography, retrieved from. [Online; accessed May 27, 2025].
Singh, B. and Polshettiwar, V. (2016). Design of co2 sorbents using functionalized fibrous nanosilica (kcc-1): insights into the effect of the silica morphology (kcc-1 vs. mcm-41). Journal of materials chemistry A, 4(18):7005-7019.
Singh, P. and Liburdy, J. (1993). A solar concentrator design for uniform flux on a flat receiver. Energy conversion and management, 34(7):533-543.
Smidstrup, S. et al. QuantumATK: An integrated platform of electronic and atomic-scale modelling tools. Journal of Physics: Condensed Matter 32, 015901 (2019). DOI 10.1088/1361-648X/ab4007
Soli, A. L. and Byrne, R. H. (2002). Co2 system hydration and dehydration kinetics and the equilibrium co2/h2co3 ratio in aqueous nacl solution. Marine chemistry, 78(2-3):65-73.
Solymosi, F. The bonding, structure and reactions of CO2 adsorbed on clean and promoted metal surfaces. Journal of Molecular Catalysis 65, 337-358 (1991). https://doi.org/10.1016/0304-5102(91)85070-1
Srikanth, C. S. and Chuang, S. S. (2012). Spectroscopic investigation into oxidative degradation of silica-supported amine sorbents for co2 capture. ChemSusChem, 5(8):1435-1442.
Strasser, P. & Ogasawara, H. in Chemical Bonding at Surfaces and Interfaces 397-455 (Elsevier, 2008).
Strömberg, L., Lindgren, G., Jacoby, J., Giering, R., Anheden, M., Burchhardt, U., Altmann, H., Kluger, F., and Stamatelopoulos, G.-N. (2009). Update on vattenfall's 30 mwth oxyfuel pilot plant in schwarze pumpe. Energy Procedia, 1(1):581-589.
Suri, M., Betak, J., Rosina, K., Chrkavy, D., Suriova, N., Cebecauer, T., Caltik, M., and Erdelyi, B. (2020). Global photovoltaic power potential by country.
Sze, S. M., Li, Y. & Ng, K. K. Physics of semiconductor devices (John wiley & sons, 2021).
Tana, T. et al. Non-plasmonic metal nanoparticles as visible light photocatalysts for the selective oxidation of aliphatic alcohols with molecular oxygen at near ambient conditions. Chemical Communications 52, 11567-11570 (2016). https://doi.org/10.1039/C6CC05186C
Tanay Sahu, Victor Eke, Kubir K Ghuman, P. G. O. Solar-driven photothermal desorption of CO2 from PEI-infused silica gel. Appl. Therm. Eng. (2025). (Submitted)
Tang, W., Sanville, E. & Henkelman, G. A grid-based Bader analysis algorithm without lattice bias. Journal of Physics: Condensed Matter 21, 084204 (2009). DOI 10.1088/0953-8984/21/8/084204
Teller, E., Wood, L., and Hyde, R. (1997). Global warming and ice ages: 1. Prospects for Physics Based Modulation of Global Change, page 20.
Thakkar, H. V., Ruba, A. J., Matteson, J. A., Dugas, M. P., and Singh, R. P. (2024). Accelerated testing of pei-silica sorbent pellets for direct air capture. ACS omega, 9(46):45970-45982.
The Editors of Encyclopaedia Britannica (2025). Solar power. encyclopedia britannica. [Online; accessed 3 Jul. 2025].
U.S. department of energy (2020). Carbon dioxide capture approaches. [Online; accessed 3 Jul. 2025].
U.S. Energy Information Administration—Cara Marcy (2018). Changes in coal sector led to less so2 and nox emissions from electric power industry. [Online; accessed 3 Jul. 2025].
U.S. Energy Information Administration (2024). How much carbon dioxide is produced per kilowatt hour of u.s. electricity generation?[Online; accessed 3 Jul. 2025].
U.S. Pat. No. 11,738,307
US2023415088
US20240091698
U.S. Pat. No. 7,919,064
U.S. Pat. No. 9,248,395
Usman, M., Rehman, A., Saleem, F., Abbas, A., Eze, V. C., and Harvey, A. (2023). Synthesis of cyclic carbonates from co 2 cycloaddition to bio-based epoxides and glycerol: an overview of recent development. RSC advances, 13(33):22717-22743.
van der Meer, L. B., Hofstee, C., and Orlic, B. (2009). The fluid flow consequences of co2 migration from 1000 to 600 metres upon passing the critical conditions of co2. Energy Procedia, 1(1):3213-3220.
VandeVondele, J. & Hutter, J. Gaussian basis sets for accurate calculations on molecular systems in gas and condensed phases. J. Chem. Phys. 127, 114105 (2007).
Vega, F., Sanna, A., Navarrete, B., Maroto-Valer, M. M. & Cortes, V. J. Degradation of amine-based solvents in CO2 capture process by chemical absorption. Greenhouse Gases: Science and Technology 4, 707-733 (2014). https://doi.org/10.1002/ghg.1446
Vosko, S. H., Wilk, L., and Nusair, M. (1980). Accurate spin-dependent electron liquid correlation energies for local spin density calculations: a critical analysis. Canadian Journal of physics, 58(8):1200-1211.
Wang, K., Shang, H., Li, L., Yan, X., Yan, Z., Liu, C., and Zha, Q. (2012). Efficient co2 capture on low-cost silica gel modified by polyethyleneimine. Journal of Natural Gas Chemistry, 21(3):319-323.
Wang, S.-G. et al. Factors controlling the interaction of CO2 with transition metal surfaces. The Journal of Physical Chemistry C 111, 16934-16940 (2007). https://doi.org/10.1021/jp074570y
Wang, S.-G., Cao, D.-B., Li, Y.-W., Wang, J., and Jiao, H. (2005). Chemisorption of co2 on nickel surfaces. The Journal of Physical Chemistry B, 109(40):18956-18963.
Wang, Y., Yu, M., Zhang, X., Gao, Y., Liu, J., Zhang, X., Gong, C., Cao, X., Ju, Z., and Peng, Y. (2023). Density functional theory study of co2 hydrogenation on transition-metal-doped cu (211) surfaces. Molecules, 28(6):2852.
Wayne, G. (2014). Representative concentration pathways. Skeptical science, 24.
Weiss, W. and Rommel, M. (2008). Process heat collectors. State of the Art within Task, 33.
Wikipedia contributors (2025b). Carbon dioxide—Wikipedia, the free encyclopedia. [Online; accessed 3 Jul. 2025].
Willauer, H. D. et al. Modeling and kinetic analysis of CO2 hydrogenation using a Mn and K-promoted Fe catalyst in a fixed-bed reactor. Journal of CO2 Utilization 3, 56-64 (2013). https://doi.org/10.1016/j.jcou.2013.10.003
Xia, Y., Mokaya, R., Walker, G. S., and Zhu, Y. (2011). Superior co2 adsorption capacity on n-doped, high-surface-area, microporous carbons templated from zeolite. Advanced Energy Materials, 1(4):678-683.
Xie, B., Dong, J., Zhao, J. & Liu, L. Radiative properties of hedgehog-like ZnO—Au composite particles with applications to photocatalysis. Journal of Quantitative Spectroscopy and Radiative Transfer 217, 1-12 (2018). https://doi.org/10.1016/j.jqsrt.2018.04.036
Xiong, H., Zhang, H. & Gan, L. CO2 capture and separation on the penta-BN2 monolayer with the assistance of charge/electric field. J. Mater. Sci. 56, 4341-4355 (2021).
Yan, C. and Sayari, A. (2024). Spectroscopic investigation into the oxidation of polyethylenimine for co2 capture: Mitigation strategies and mechanism. Chemical Engineering Journal, 479:147498.
Yang, C. & Zhao, Z. Interfacial properties and band alignment of noble-metal/anatase. Comput. Mater. Sci. 151, 160-173 (2018).
Yang, D.-A., Cho, H.-Y., Kim, J., Yang, S.-T., and Ahn, W.-S. (2012). Co 2 capture and conversion using mg-mof-74 prepared by a sonochemical method. Energy & Environmental Science, 5(4):6465-6473.
Yang, Z., Chen, B., Chen, H., and Li, H. (2023). A critical review on machine-learning-assisted screening and design of effective sorbents for carbon dioxide (co2) capture. Frontiers in Energy Research, 10:1043064.
Yin, M. and Cohen, M. L. (1982). Theory of ab initio pseudopotential calculations. Physical review B, 25(12):7403.
Yuan, J., Yinxi, W., Long, Q., Cao, Q., Deng, G., Wang, Z., and Gao, J. (2024). Solar triggered co2 regeneration and conversion using amine-based materials. Journal of Environmental Chemical Engineering, page 114169.
Yurdusen, A. and Yurum, Y. (2019). A controlled synthesis strategy to enhance the co2 adsorption capacity of mil-88b type mof crystallites by the crucial role of narrow micropores. Industrial & Engineering Chemistry Research, 58(31):14058-14072.
Zeng, J. & Xuan, Y. Analysis on interaction between solar light and suspended nanoparticles in nanofluids. Journal of Quantitative Spectroscopy and Radiative Transfer 269, 107692 (2021). https://doi.org/10.1016/j.jqsrt.2021.107692
Zhang, H., Goeppert, A., Prakash, G. S., and Olah, G. (2015). Applicability of linear polyethylenimine supported on nano-silica for the adsorption of co 2 from various sources including dry air. RSC Advances, 5(65):52550-52562.
Zhang, W., Sun, C., Snape, C. E., Sun, X., and Liu, H. (2020). Cyclic performance evaluation of a polyethylenimine/silica adsorbent with steam regeneration using simulated ngcc flue gas and actual flue gas of a gas-fired boiler in a bubbling fluidized bed reactor. International Journal of Greenhouse Gas Control, 95:102975.
Zhang, Z. et al. Progress in enhancement of CO2 absorption by nanofluids: A mini review of mechanisms and current status. Renewable energy 118, 527-535 (2018). https://doi.org/10.1016/j.renene.2017.11.031
Zhou, L. P. et al. Structure characteristic and its evolution of Cu—W films prepared by dual-target magnetron sputtering deposition. Trans. Nonferrous Met. Soc. China 22, 2700-2706 (2012).

1. A method for capturing CO₂ from a fluid, the method comprising the steps of:
a) providing a metal-based surface,
b) adjusting the surface charge of the metal-based surface to a first state, wherein said first state allows adsorption of CO₂ on the metal-based surface, and
c) contacting the metal-based surface with the surface charge in said first state to a fluid containing CO₂ to be captured, and allowing said CO₂ to become adsorbed on the metal-based surface,
wherein the adjusting of the surface charge at step b) is carried out by (A) exposing or refraining from exposing the metal-based surface to radiation or (B) applying or refraining from applying a potential difference on the metal-based surface, and
wherein said first state is one of the following (i) to (iii):
(i) a positive surface charge,
(ii) a negative surface charge, and
(iii) a neutral surface charge.

2. The method of claim 1, further comprising the step of:
d) adjusting the surface charge of the metal-based surface to a second state, wherein said second state allows desorption of CO₂ from the metal-based surface, and
e) allowing the CO₂ to desorb from the metal-based surface with the surface charge in said second state,
wherein the adjusting of the surface charge at step d) is carried out by (A) exposing or refraining from exposing the metal-based surface to radiation or (B) applying or refraining from applying a potential difference on the metal-based surface, and
wherein said second state is another of said (i) to (iii).

3. The method of claim 1, wherein the radiation is UV, visible, or IR radiation.

4. (canceled)

5. (canceled)

6. The method of claim 1, wherein the radiation creates a charge on the metal-based surface via the photovoltaic effect, by photogeneration, and/or via the photogalvanic effect

7. (canceled)

8. The method of claim 1, wherein said adjusting of the surface charge at step b) or step d) or both steps b) and d) is carried out by (A) exposing or refraining from exposing the metal-based surface to radiation.

9. The method of claim 1, wherein the adjusting of the surface charge at step b) or step d) or both steps b) and d) is carried out (B) applying or refraining from applying a potential difference on the metal-based surface.

10. The method of claim 1, wherein, when at step b), the adjusting of the surface charge is carried out by (A) exposing the metal-based surface to radiation or (B) applying a potential difference on the metal-based surface, said exposing or said applying is continued throughout step c).

11. The method of claim 1, wherein, when at step b), the adjusting of the surface charge is carried out by (A) refraining from exposing the metal-based surface to radiation or (B) refraining from applying a potential difference on the metal-based surface, said refraining is continued throughout step c).

12. The method of claim 1, wherein, when at step d), the adjusting of the surface charge is carried out by (A) exposing the metal-based surface to radiation or (B) applying a potential difference on the metal-based surface, said exposing or said applying is continued throughout step e).

13. The method of claim 1, wherein, when at step b), the adjusting of the surface charge is carried out by (A) refraining from exposing the metal-based surface to radiation or (B) refraining from applying a potential difference on the metal-based surface, said refraining is continued throughout step e).

14. (canceled)

15. (canceled)

16. (canceled)

17. (canceled)

18. The method of claim 1, wherein step e), and preferably step d), are carried out so the CO₂ is released and contained.

19. The method of claim 1, wherein the CO₂ is desorbed into a container or pipe so the CO₂ can be transported or stored until is used, disposed of, or stored permanently.

20. (canceled)

21. The method of claim 1, wherein the metal-based surface is the surface of the metal, preferably a Zn (0001) metal surface, Pt (111) metal surface, Fe-gamma (110) metal surface, Al-alpha (110) metal surface, Al-beta (0001) metal surface, Co-alpha (111) metal surface, Co-epsilon (0001) metal surface, or Cu (111) metal surface.

22. (canceled)

23. The method of claim 1, wherein the metal-based surface is a Cu (111) metal surface and wherein the first state is a negative surface charge, and the second state is a positive surface charge.

24. (canceled)

25. The method of claim 1, wherein the metal-based surface is a Zn (0001) metal surface and wherein the first state is neutral, and the second state is a positive surface charge.

26. (canceled)

27. The method of claim 1, wherein the metal-based surface is a Co-alpha (111) metal surface and wherein the first state is a neutral surface charge, and the second state is negative surface charge.

28. (canceled)

29. The method of claim 1, wherein the metal-based surface is an Al-beta (0001) metal surface and wherein the first state is neutral, and the second state is negative surface charge.

30. (canceled)

31. (canceled)

32. (canceled)

33. The method of claim 1, wherein the metal-based surface is a Fe₃Co, FeCo, FeNi₃, or V₃Ni surface.

34. The method of claim 1, wherein the metal-based surface is a planar surface, an irregular surface, or a surface of a particles, preferably a surface of a nanoparticle.

35. The method of claim 34, wherein, when using nanoparticles, the adjusting at steps b) and d) is carried by (A) exposing or refraining from exposing the metal-based surface to radiation.
